(19) United States
(12) Patent Application Publication
(10) Pub. No.: US 2025/0353942 A1
(43) Pub. Date: Nov. 20, 2025

(54) Modified Pyridine-2,6-Bis(Phenylenephenolate) Complexes with Enhanced Solubility that are Useful as Catalyst Components for Olefin Polymerization

(71) Applicants: EXXONMOBIL CHEMICAL PATENTS INC., Baytown, TX (US); ExxonMobil Technology and Engineering Company, Baytown, TX (US)

(72) Inventors: Jo Ann M. Canich, Houston, TX (US); Gregory J. Smith-Karahalis, Houston, TX (US); Irene C. Cai, Webster, TX (US); John R. Hagadorn, Houston, TX (US); Catherine A. Faler, Houston, TX (US); Michelle E. Titone, Houston, TX (US); Margaret T. Whalley, Houston, TX (US); Hua Zhou, Missouri City, TX (US)

(21) Appl. No.: 18/862,794

(22) PCT Filed: Apr. 27, 2023
(86) PCT No.: PCT/US2023/066311

§ 371 Date: Nov. 4, 2024

Related U.S. Application Data
(60) Provisional application No. 63/338,173, filed on May 4, 2022.

(51) Int. Cl. C08F 110/06; C08F 4/64; C08F 4/659

(52) U.S. Cl. CPC C08F 110/06; C08F 4/64158; C08F 4/659

(57) ABSTRACT

Exemplary embodiments of the present technological advancement include pyridine-2,6-bis(phenylenephenolate) complexes that are useful as catalyst components for olefin polymerization and have enhanced solubility in non-aromatic hydrocarbons (e.g., isohexane). The improved solubility of these complexes was accomplished by the modification of the leaving group which generally leads to improved solubility, without adversely affecting the performance of the complex when used as a catalyst for olefin polymerizations.

### CROSS REFERENCE TO RELATED APPLICATIONS

This application claims the benefit of and priority to U.S. Provisional Application No. 63/338,173 filed May 4, 2022, the disclosure of which is incorporated herein by reference.

### FIELD

The present disclosure relates to bis(aryl phenolate) Lewis base transition metal complexes, catalyst systems including bis(aryl phenolate) Lewis base transition metal complexes, and polymerization processes to produce polyolefin polymers such as polyethylene based polymers and polypropylene based polymers.

### BACKGROUND

Polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those using a Ziegler-Natta catalyst, a chromium based catalyst, or a metallocene catalyst.

Additionally, pre-catalysts (neutral, unactivated complexes) should be thermally stable at and above ambient temperature, as they are often stored for weeks before being used. The performance of a given catalyst is closely influenced by the reaction conditions, such as the monomer concentrations and temperature. For instance, the solution process, which benefits from being run at temperatures above 120° C., is particularly challenging for catalyst development. At such high reactor temperatures, it is often difficult to maintain high catalyst activity and high molecular weight capability as both attributes quite consistently decline with an increase of reactor temperature. With a wide range of polyolefin products desired, from high density polyethylene (HDPE) to elastomers (e.g., thermoplastic elastomers (TPE); ethylene-propylene-diene (EPDM)), many different catalyst systems may be needed, as it is unlikely that a single catalyst will be able to address all the needs for the production of these various polyolefin products. The strict set of requirements needed for the development and production of new polyolefin products makes the identification of suitable catalysts for a given product and production process a highly challenging endeavor.

Aromatic solvents are typically used to dissolve catalyst components in industrial olefin polymerization processes. However, typically it is challenging to replace aromatic solvents with non-aromatic solvents, such as isohexane, due to poor solubility of catalyst components in non-aromatic solvents.

Further information regarding the general state of the art for non-metallocene olefin polymerization catalysts can be found in Baier, M. C. (2014) “Post-Metallocenes in the Industrial Production of Poly-olefins,” Angew. Chem. Int. Ed., v. 53, pp. 9722-9744, the entire contents of which are hereby incorporated by reference.

Further information regarding complexes can be found in: Goryunov, G. P. et al. (2021) “Rigid Postmetallocene Catalysts for Propylene Polymerization: Ligand Design Prevents the Temperature-Dependent Loss of Stereo- and Regioselectivities,” ACS Catalysis, v. 11 (13), pp. 8079-8086; US2020/0255556; US2020/0255555; US2020/0254431; and US2020/0255553, the entirety of each of which is hereby incorporated by reference.

### SUMMARY

A catalyst compound represented by Formula (I):

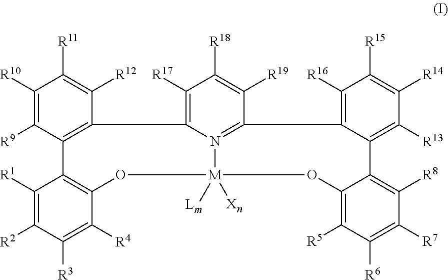

wherein:
M is a group 3, 4, or 5 metal;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, R¹², R¹³, R¹⁴, R¹⁵, and R¹⁶ is independently hydrogen, C₁-C₄₀ hydrocarbyl, C₁-C₄₀ substituted hydrocarbyl, a heteroatom or a heteroatom-containing group, or any two or more adjacent R⁹, R¹⁰, R¹¹, R¹², R¹³, R¹⁴, R¹⁵, and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
L is a Lewis base;
each X is independently a hydrocarbyl ligand or a substituted hydrocarbyl ligand wherein at least one X is a non-aromatic hydrocarbyl ligand having nine carbon atoms or more, or is a substituted hydrocarbyl ligand having at least five carbon atoms or more, or when n is 2, both X together may be hydrocarbyl or substituted hydrocarbyl that comprise four carbon atoms or more and form a 5-membered cyclic ring structure with M;
n is 1, 2, or 3;
m is 0, 1, or 2;
n+m is not greater than 4;
any two L groups may be joined together to form a bidentate Lewis base; and
an X group may be joined to an L group to form a monoanionic bidentate group.

A homogeneous solution, comprising: an aliphatic hydrocarbon solvent; and at least one complex of Formula (I), with a concentration of the complex being 0.20 wt % or greater (alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater).

A process for the production of a propylene based polymer comprising: polymerizing propylene by contacting the propylene with a catalyst system made from Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

A process for the production of an ethylene based polymer comprising: polymerizing ethylene by contacting the ethylene with the catalyst system made from Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

### DETAILED DESCRIPTION

Exemplary embodiments of the present technological advancement include pyridine-2,6-bis(phenylenephenolate) complexes that are useful as catalyst components for olefin polymerization and have enhanced solubility in non-aromatic hydrocarbons (e.g. isohexane). The improved solubility of these complexes was accomplished by the modification of the leaving group which generally leads to improved solubility, without adversely affecting the performance of the complex when used as a catalyst for olefin polymerizations.

For the purposes of the present disclosure, the numbering scheme for the Periodic Table Groups is used as described in Chemical and Engineering News, v. 63(5), pg. 27 (1985). Therefore, a “group 4 metal” is an element from group 4 of the Periodic Table, e.g., Hf, Ti, or Zr.

The following abbreviations may be used herein: Me is methyl, Et is ethyl, Ph is phenyl, tBu is tertiary butyl, Tf is triflate (—SO₂CF₃), Ad is adamantanyl, MAO is methylalumoxane, NMR is nuclear magnetic resonance, t is time, s is second, h is hour, psi is pounds per square inch, psig is pounds per square inch gauge, equiv. is equivalent, RPM is rotation per minute.

The specification describes transition metal complexes. The term complex is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization or oligomerization function using an activator which, without being bound by theory, is believed to create a cation as a result of the removal of an anionic group, often referred to as a leaving group, from the transition metal.

The terms “substituent,” “radical,” “group,” and “moiety” may be used interchangeably.

“Conversion” is the amount of monomer that is converted to polymer product, and is reported as mol % and is calculated based on the polymer yield and the amount of monomer fed into the reactor.

“Catalyst activity” is a measure of how active the catalyst is and is reported as the grams of product polymer (P) produced per millimole of catalyst (cat) used per hour (gP·mmolcat⁻¹·h⁻¹).

The term “heteroatom” refers to any group 13-17 element, excluding carbon. A heteroatom may include B, Si, Ge, Sn, N, P, As, O, S, Se, Te, F, Cl, Br, and I. The term “heteroatom” may include the aforementioned elements with hydrogens attached, such as BH, BH₂, SiH₂, OH, NH, NH₂, etc. The term “substituted heteroatom” describes a heteroatom that has one or more of these hydrogen atoms replaced by a hydrocarbyl or substituted hydrocarbyl group(s).

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

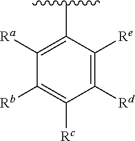

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is not H), or two or more of R^{a}, R^{b}, R^{c}, R^{d}, and R^{e} can be joined together to form a C₄-C₆₂ cyclic or polycyclic hydrocarbyl ring structure, or a combination thereof.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The term “substituted carbazole,” means a carbazolyl group having 1 or more hydrogen groups replaced by a hydrocarbyl, substituted hydrocarbyl, heteroatom or heteroatom containing group.

The term “substituted naphthyl,” means a naphthyl group having 1 or more hydrogen groups replaced by a hydrocarbyl, substituted hydrocarbyl, heteroatom or heteroatom containing group.

The term “substituted anthracenyl,” means an anthracenyl group having 1 or more hydrogen groups replaced by a hydrocarbyl, substituted hydrocarbyl, heteroatom or heteroatom containing group.

The term “substituted fluorenyl” means a fluorenyl group having 1 or more hydrogen groups replaced by a hydrocarbyl, substituted hydrocarbyl, heteroatom or heteroatom containing group.

The terms trihydrocarbylsilyl and trihydrocarbylgermyl means a silyl or germyl group bound to three hydrocarbyl groups. Examples of suitable trihydrocarbylsilyl and trihydrocarbylgermyl groups can include trimethylsilyl, trimethylgermyl, triethylsilyl, triethylgermyl, and all isomers of tripropylsilyl, tripropylgermyl, tributylsilyl, tributylgermyl, tripentylsilyl, tripentylgermyl, butyldimethylsilyl, butyldimethygermyl, dimethyloctylsilyl, dimethyloctylgermyl, and the like.

The terms dihydrocarbylamino and dihydrocarbylphosphino mean a nitrogen or phosphorus group bonded to two hydrocarbyl groups. Examples of suitable dihydrocarbylamino groups can include dimethylamino, dimethylphosphino, and dihydrocarbylphosphino diethylamino, diethylphosphino, and all isomers of dipropylamino, dipropylphosphino, dibutylamino, dibutylphosphino, and the like.

The term “substituted adamantanyl” means an adamantanyl group having 1 or more hydrogen groups replaced by a hydrocarbyl, substituted hydrocarbyl, heteroatom or heteroatom containing group.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl (also referred to as a hydrocarbyloxy group). The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxy.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

The terms “hydrocarbyl radical,” “hydrocarbyl group,” or “hydrocarbyl” may be used interchangeably and are defined to mean a group consisting of hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl) hexyl (such as cyclohexyl), octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and aryl groups, such as phenyl, benzyl, and naphthyl.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

Unless otherwise indicated, as used herein, “high molecular weight” is defined as a number average molecular weight (Mn) value of 100,000 g/mol or more. “Low molecular weight” is defined as an Mn value of less than 100,000 g/mol.

Unless otherwise noted all melting points (Tm) are differential scanning calorimetry (DSC) second melt.

A “catalyst system” is a combination of at least one catalyst compound, at least one activator, an optional coactivator, and an optional support material. The terms “catalyst compound”, “catalyst complex”, “transition metal complex”, “transition metal compound”, “precatalyst compound”, and “precatalyst complex” are used interchangeably. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The transition metal compound may be neutral as in a precatalyst, or a charged species with a counter ion as in an activated catalyst system. For the purposes of the present disclosure and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. A “Lewis base” is a neutrally charged ligand which donates one or more pairs of electrons to a metal ion. Examples of Lewis bases include diethylether, trimethylamine, pyridine, tetrahydrofuran, dimethylsulfide, and triphenylphosphine. The term “heterocyclic Lewis base” refers to Lewis bases that are also heterocycles. Examples of heterocyclic Lewis bases include pyridine, imidazole, thiazole, and furan. The bis(aryl phenolate) Lewis base ligands are tridentate ligands that bind to the metal via two anionic donors (phenolates) and one heterocyclic Lewis base donor (e.g., pyridinyl group). The bis(aryl phenolate) heterocycle ligands are tridentate ligands that bind to the metal via two anionic donors (phenolates) and one heterocyclic Lewis base donor.

The term “continuous” means a system that operates without interruption or cessation. For example a continuous process to produce a polymer would be one where the reactants are continually introduced into one or more reactors and polymer product is continually withdrawn.

### Transition Metal Complexes

In at least one embodiment, the catalyst compound represented by Formula (I) is as follows.

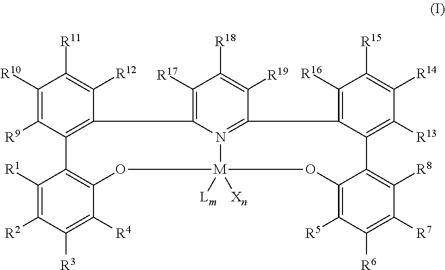

wherein:
M is a group 3, 4, or 5 metal;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, R¹², R¹³, R¹⁴, R¹⁵, and R¹⁶ is independently hydrogen, C₁-C₄₀ hydrocarbyl, C₁-C₄₀ substituted hydrocarbyl, a heteroatom or a heteroatom-containing group, or any two or more adjacent R⁹, R¹⁰, R¹¹, R¹², R¹³, R¹⁴, R¹⁵, and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
L is a Lewis base;
each X is independently a hydrocarbyl ligand or a substituted hydrocarbyl ligand wherein at least one X is a non-aromatic hydrocarbyl ligand having nine carbon atoms or more, or is a substituted hydrocarbyl ligand having at least five carbon atoms or more, or when n is 2, both X together may be hydrocarbyl or substituted hydrocarbyl that comprise four carbon atoms or more and form a 5-membered cyclic ring structure with M;
n is 1, 2, or 3;
m is 0, 1, or 2;
n+m is not greater than 4;
any two L groups may be joined together to form a bidentate Lewis base; and
an X group may be joined to an L group to form a monoanionic bidentate group.

When n is 2, both X together may be represented by Formula Ia, Ib, Ic, or Id below wherein R²⁰, R^{20′}, R²¹, R^{21′}, R²², R^{22′}, R²³, R^{23′} are independently hydrogen or C₁-C₂₀ hydrocarbyl, where the dashed lines represent bonds to the metal atom, M.

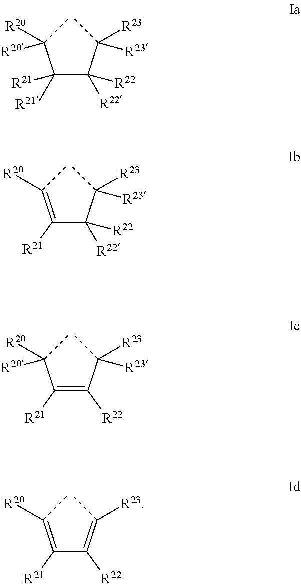

For example, M of Formula (I) can be a group 3, 4 or 5 metal, such as M can be a group 4 metal. Group 4 metals may include zirconium, titanium, and hafnium. In at least one embodiment, M is zirconium or hafnium.

Each L of Formula (I) can be independently selected from ethers, amines, phosphines, thioethers, esters, such as, for example Et₂O, MeOtBu, Et₃N, PhNMe₂, MePh₂N, tetrahydrofuran, methylacetate, and dimethylsulfide.

Each of R¹, R², R³, R⁴, R⁵, R⁶, R⁷, R⁸ of Formula (I) can be independently selected from hydrogen, C₁-C₄₀ hydrocarbyl, C₁-C₄₀ substituted hydrocarbyl, hydrocarbyloxy, trihydrocarbylsilyl, trihydrocarbylgermyl, dihydrocarbylamino, dihydrocarbylphosphino, or halogen, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms.

In at least one embodiment, one or more of R¹, R², R³, R⁴, R⁵, R⁶, R⁷, R⁸ of Formula (I) is independently selected from methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including trimethylsilylpropyl, trimethylsilylmethyl, trimethylsilylethyl, phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl, heteroatom-containing groups including trimethylsilyl, triethylsilyl, methoxy, ethoxy, cyclohexyloxy, trifluoromethyl, dimethylamino, diethylamino, dicyclohexylamino and all isomers of tripropylsilyl, tributylsilyl, tripentylsilyl, trihexylsilyl, triheptylsilyl, trioctylsilyl, dimethyoctylsilyl, butyldimethylsilyl (such as t-butyldimethylsilyl), propoxy, butoxy, pentoxy, hexoxy, heptoxy, octoxy and the like.

For example, R⁴ and R⁵ of Formula (I) can be independently C₁-C₂₀ alkyl, such as R⁴ and R⁵ can be tert-butyl, or adamantanyl. In at least one embodiment, R⁴ and R⁵ are independently selected from unsubstituted phenyl, substituted phenyl, unsubstituted carbazole, substituted carbazole, unsubstituted naphthyl, substituted naphthyl, unsubstituted anthracenyl, substituted anthracenyl, unsubstituted fluorenyl, or substituted fluorenyl, a heteroatom or a heteroatom-containing group, such as R⁴ and R⁵ can be independently unsubstituted phenyl or 3,5-di-tert-butylbenzyl. Furthermore, either (1) R⁴ can be C₁-C₂₀ alkyl (e.g., R⁴ can be tert-butyl) and R⁵ can be an aryl, or (2) R⁵ can be C₁-C₂₀ alkyl (e.g., R⁵ can be tert-butyl) and R⁴ can be an aryl. Alternately, R⁴ and/or R⁵ can be independently a heteroatom, such as R⁴ and R⁵ can be a halogen atom (such as Br, Cl, F, or I). Alternately, R⁴ and/or R⁵ can be independently a silyl group, such as R⁴ and R⁵ can be a trialkylsilyl or triarylsilyl group, where the alkyl is a C₁ to C₃₀ alkyl (such methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl), hexyl (such as cyclohexyl), octyl (such as cyclooctyl), nonyl, decyl (such as adamantanyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and the aryl is a C₆ to C₃₀ aryl (such as phenyl, benzyl, and naphthyl). Usefully R⁴ and R⁵ can be triethylsilyl.

In some embodiments, R⁴ and R⁵ is independently a C₁-C₄₀ hydrocarbyl, a C₁-C₄₀ substituted hydrocarbyl, more preferably, each R⁴ and R⁵ is independently selected from a tertiary hydrocarbyl groups (such as tert-butyl, tert-pentyl, tert-hexyl, tert-heptyl, tert-octyl, tert-nonyl, tert-decyl, tert-undecyl, tert-dodecyl) and cyclic tertiary hydrocarbyl groups (such as such as 1-methylcyclohexyl, 1-norbornyl, 1-adamantanyl, or substituted 1-adamantanyl).

In some embodiments, R⁴ and R⁵ is independently a C₁-C₄₀ hydrocarbyl, a C₁-C₄₀ substituted hydrocarbyl, more preferably, each of R⁴ and R⁵ is independently a non-aromatic cyclic alkyl group (such as cyclohexyl, cyclooctyl, cyclodecyl, cyclododecyl, adamantanyl, norbornyl, or 1-methylcyclohexyl, or substituted adamantanyl), most preferably a non-aromatic cyclic tertiary alkyl group (such as 1-methylcyclohexyl, 1-adamantanyl, substituted 1-adamantanyl, or 1-norbornyl).

In some embodiments, R⁴ and R⁵ is independently a C₃-C₃₀ heteroatom-containing group including trimethylsilyl, triethylsilyl, and all isomers of tripropylsilyl, tributylsilyl, tripentylsilyl, trihexylsilyl, triheptylsilyl, trioctylsilyl, dimethyoctylsilyl, butyldimethylsilyl, and the like.

The identity of R⁴ and R⁵ can be used to control the molecular weight of the polymer products. For example, when one or both of R⁴ and R⁵ are tert-butyl, the catalyst compound may provide high molecular weight polymers. In contrast, when R⁴, R⁵, or R⁴ and R⁵ are phenyl, the catalyst compound may provide low molecular weight polymers.

In at least one embodiment, each R₂ and R⁷ of Formula (I) is independently C₁-C₁₀ alkyl, such as R² and R⁷ are independently methyl, ethyl, propyl, butyl, pentyl, hexyl, heptyl, octyl, nonyl, decyl, dimethyl-pentyl, tert-butyl, isopropyl, or isomers thereof.

In at least one embodiment, each R₂ and R⁷ of Formula (I) is independently a C₃-C₃₀ substituted hydrocarbyl or a C₃-C₃₀ heteroatom-containing group, such as R² and R⁷ are independently trimethylsilyl, triethylsilyl, tripropylsilyl, tributylsilyl, trihexylsilyl, trioctylsilyl, dimethyoctylsilyl, butyldimethylsilyl (including t-butyldimethylsilyl), methyltrimethylsilyl, or isomers thereof.

Each of R¹, R³, R⁶, R⁸, R⁹, R¹⁰, R¹¹, R¹², R¹³, R¹⁴, R¹⁵, R¹⁶, R¹⁷, R¹⁸, and R¹⁹ of Formula (I) can be independently hydrogen or C₁-C₁₀ alkyl, such as R¹, R³, R⁶, R⁸, R⁹, R¹¹, R¹², R¹³, R¹⁵, R¹⁶, R¹⁷, R¹⁸, and R¹⁹ can be independently hydrogen, methyl, ethyl, propyl, or isopropyl. In at least one embodiment, R¹, R³, R⁶, R⁸, R⁹, R¹⁰, R¹¹, R¹², R¹³, R¹⁴, R¹⁵, R¹⁶, R¹⁷, R¹⁸, and R¹⁹ are hydrogen. Alternately, each of R¹, R³, R⁶, R⁸, R⁹, R¹⁰, R¹¹, R¹², R¹³, R¹⁴, R¹⁵, R¹⁶, R¹⁷, R¹⁸, and R¹⁹ of Formula (I) can be independently hydrogen, phenyl, cyclohexyl, fluoro, chloro, methoxy, ethoxy, phenoxy, or trimethylsilyl.

Each X can be independently a hydrocarbyl ligand or substituted hydrocarbyl ligand wherein at least one X is a C₉-C₄₀ non-aromatic hydrocarbyl ligand, alternatively a C₉-C₂₀ non-aromatic hydrocarbyl ligand, alternatively a C₁₀-C₂₀ non-aromatic hydrocarbyl ligand, alternatively a C₁₂-C₂₀ non-aromatic hydrocarbyl ligand.

Each X can be independently a hydrocarbyl ligand or substituted hydrocarbyl ligand wherein at least one X is a C₉-C₄₀ non-aromatic hydrocarbyl ligand, alternatively a C₉-C₂₀ non-aromatic hydrocarbyl ligand, alternatively a C₁₀-C₂₀ non-aromatic hydrocarbyl ligand, alternatively a C₁₂-C₂₀ non-aromatic hydrocarbyl ligand, and the other X is C₁-C₄₀ hydrocarbyl ligand or substituted hydrocarbyl ligand, alternatively a C₁-C₂₀ hydrocarbyl ligand or substituted hydrocarbyl ligand.

Each X can be independently a hydrocarbyl ligand or substituted hydrocarbyl ligand wherein at least one X is a C₉-C₄₀ non-aromatic hydrocarbyl ligand and the other X is C₁-C₄₀ hydrocarbyl ligand.

Each X can be independently a hydrocarbyl ligand wherein at least one X is a C₉-C₄₀ non-aromatic hydrocarbyl ligand and the other X is C₁-C₄₀ non-aromatic hydrocarbyl ligand.

Each X can be independently a hydrocarbyl ligand wherein at least one X is a C₉-C₂₀ non-aromatic hydrocarbyl ligand and the other X is C₁-C₂₀ non-aromatic hydrocarbyl ligand.

Preferred C₉-C₂₀ non-aromatic hydrocarbyl ligands for X include all isomers of nonyl, decyl, undecyl, dodecyl, tridecyl, tetradecyl, pentadecyl, hexadecyl, heptadecyl, octadecyl, nonadecyl and icosanyl, such as, for example n-nonyl, n-decyl, n-undecyl, n-dodecyl, n-tridecyl, n-tetradecyl, n-pentadecyl, n-hexadecyl, n-heptadecyl n-octadecyl, n-nonadecyl, n-icosnyl, 2,2-dimethylhept-1-yl, 2,2-dimethyloct-1-yl, 2,2-dimethylnon-1-yl, 2,2-dimethyldec-1-yl, 3,7-dimethyloct-1-yl, 2-ethyldec-1-yl, 9-methylundec-1-yl, 2-hexyldec-1-yl, 3,7,11-trimethyldodec-1-yl, and the like.

Preferred C₁-C₂₀ non-aromatic hydrocarbyl ligands for X include methyl, ethyl, and all isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl and icosanyl, such as, for example methyl, ethyl, n-propyl, n-butyl, n-pentyl, n-hexyl, n-octyl, n-nonyl, n-decyl, n-undecyl, n-dodecyl, n-tridecyl, n-tetradecyl, n-pentadecyl, n-hexadecyl, n-heptadecyl n-octadecyl, n-nonadecyl, n-icosnyl, 2,2-dimethylhept-1-yl, 2,2-dimethyloct-1-yl, 2,2-dimethylnon-1-yl, 2,2-dimethyldec-1-yl, 3,7-dimethyloct-1-yl, 2-ethyldec-1-yl, 9-methylundec-1-yl, 2-hexyldec-1-yl, 3,7,11-trimethyldodec-1-yl, and the like.

Each X can be independently a hydrocarbyl ligand wherein at least one X is a C₁₀-C₂₀ non-aromatic hydrocarbyl ligand and the other X is non-aromatic C₁-C₂₀ hydrocarbyl ligand.

Each X can be independently a hydrocarbyl ligand wherein at least one X is a C₁₂-C₂₀ non-aromatic hydrocarbyl ligand and the other X is non-aromatic C₁-C₂₀ hydrocarbyl ligand.

Each X can be independently a hydrocarbyl ligand or substituted hydrocarbyl ligand wherein at least one X is a C₅-C₄₀ substituted hydrocarbyl ligand, alternatively a C₅-C₃₀ substituted hydrocarbyl ligand, alternatively a C₇-C₃₀ substituted hydrocarbyl ligand, alternatively a C₁₀-C₃₀ substituted hydrocarbyl ligand, alternatively a C₁₂-C₃₀ substituted hydrocarbyl ligand.

Each X can be independently a hydrocarbyl ligand or substituted hydrocarbyl ligand wherein at least one X is a C₅-C₃₀ substituted hydrocarbyl ligand.

Preferred C₅-C₃₀ substituted hydrocarbyl ligands for X include those containing heteroatom-containing groups selected from SiR³⁰₃, GeR³⁰₃, OR³⁰, SR³⁰, NR³⁰₂ where each R³⁰ is independently a C₁-C₁₀ hydrocarbyl, preferably selected from C₁-C₁₀ alkyl, C₇-C₁₀ alkylaryl, or C₇-C₁₀ arylalkyl, such as, for example (1,1-dimethylethoxy)oct-8-yl, [(trimethysilyl)oxy]dec-10-yl, [tert-butyldimethylsilyl)oxy]hex-6-yl, [tert-butyldimethylsilyl)oxy]oct-8-yl, 4-(cyclohexylthio)benzyl, trimethylsilyleth-2-yl, trimethylsilylprop-3-yl, (triethylsilyl)methyl, and the like.

Preferred C₇-C₃₀ substituted hydrocarbyl ligands for X include those containing heteroatom-containing groups selected from SiR³⁰₃, GeR³⁰₃, OR³⁰, SR³⁰, NR³⁰₂ where each R³⁰ is independently a C₁-C₁₀ hydrocarbyl, preferably selected from C₁-C₁₀ alkyl, C₇-C₁₀ alkylaryl, or C₇-C₁₀ arylalkyl, such as, for example (1,1-dimethylethoxy)oct-8-yl, [(trimethysilyl)oxy]dec-10-yl, [tert-butyldimethylsilyl)oxy]hex-6-yl, [tert-butyldimethylsilyl)oxy]oct-8-yl, 4-(cyclohexylthio)benzyl, 4-(cyclopentylthio)benzyl, 4-(cycloheptylthio)benzyl, 4-(cyclopentyloxy)benzyl, 4-(cyclohexyloxy)benzyl, 4-(cycloheptyloxy)benzyl, triethylsilyleth-2-yl, trimethylsilylbut-4-yl, (triethylsilyl)methyl, and the like.

Each X can be independently a hydrocarbyl ligand or substituted hydrocarbyl ligand wherein at least one X is a C₁₀-C₃₀ substituted hydrocarbyl ligand.

Preferred C₁₀-C₃₀ substituted hydrocarbyl ligands for X include those containing heteroatom-containing groups selected from SiR³⁰₃, GeR³⁰₃, OR³⁰, SR³⁰, NR³⁰₂ where each R³⁰ is independently a C₁-C₁₀ hydrocarbyl, preferably selected from C₁-C₁₀ alkyl, C₇-C₁₀ alkylaryl, or C₇-C₁₀ arylalkyl, such as, for example (1,1-dimethylethoxy)oct-8-yl, [(trimethysilyl)oxy]dec-10-yl, [tert-butyldimethylsilyl)oxy]hex-6-yl, [tert-butyldimethylsilyl)oxy]oct-8-yl, 4-(cyclohexylthio)benzyl, 4-(cyclopentylthio)benzyl, 4-(cycloheptylthio)benzyl, 4-(cyclopentyloxy)benzyl, 4-(cyclohexyloxy)benzyl, 4-(cycloheptyloxy)benzyl, tripropylsilyleth-2-yl, trimethylsilyloct-8-yl, (tripropylsilyl)methyl, and the like.

m can be 0, n can be 2, and both X together can be a C₄-C₄₀ hydrocarbyl or substituted hydrocarbyl that forms a 5-membered cyclic ring structure with M.

m can be 0, n can be 2, and both X can be represented by Formula Ic, wherein R²⁰, R^{20′}, R²¹, R²², R²³, R^{23′} can be independently hydrogen or C₁-C₂₀ hydrocarbyl.

m can be 0, n can be 2, and both X can be represented by Formula Ic, wherein R²⁰, R^{20′}, R²³, R^{23′} can be hydrogen, and each R²¹ and R²² can independently be hydrogen or hydrocarbyl.

m can be 0, n can be 2, and both X can be represented by Formula Ic, wherein R²⁰, R^{20′}, R²³, R^{23′} can be hydrogen, and one of R²¹ and R²² can be hydrogen with the other being hydrogen or hydrocarbyl, alternatively hydrogen or a C₁-C₂₀ hydrocarbyl, alternatively hydrogen or C₁-C₁₀ hydrocarbyl.

Preferred hydrocarbyls for R²¹ or R²² include methyl, ethyl, and all isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl and icosanyl, such as, for example methyl, ethyl, n-propyl, n-butyl, isobutyl, sec-butyl, tert-butyl, n-pentyl, isopentyl, neopentyl, 3-methylbut-2-yl, cyclopentyl, n-hexyl, isohexyl, 1-methylpent-1-yl, cyclohexyl, n-heptyl, 4-methylpent-3-en-1-yl, 1-methylhex-1-yl, n-octyl, 1-methylhept-1-yl, n-nonyl, n-decyl, n-undecyl, n-dodecyl, 4,8-dimethylnona-3,7-dien-1-yl, n-tridecyl, n-tetradecyl, n-pentadecyl, n-hexadecyl, n-heptadecyl, n-octadecyl, n-nonadecyl, n-icosanyl and the like.

m can be 0, n can be 2, and both X can be represented by Formula Ic, wherein R²⁰, R^{20′}, R²³, R^{23′} can be hydrogen, and one of R²¹ and R²² can be hydrogen with the other being a C₁-C₁₀ hydrocarbyl.

m can be 0, n can be 2, and both X can be represented by Formula Ic, wherein R²⁰, R^{20′}, R²³, R^{23′} can be hydrogen, and one of R²¹ and R²² can be hydrogen with the other being selected from hydrogen, methyl, ethyl, and all isomers of propyl, butyl, pentyl, hexyl, heptyl, octyl, nonyl and decyl.

m can be 0, n can be 2, and both X can be represented by Formula Ic, wherein R²⁰, R^{20′}, R²³, R^{23′} can be hydrogen, and one of R²¹ and R²² can be hydrogen with the other being selected from hydrogen, methyl, or 4-methylpent-3-en-1-yl.

In Formula (I), with R⁴ and R⁵ can be adamantanyl, R² and R⁷ can be C₄-C₄₀ hydrocarbyl or a C₆-C₃₀ heteroatom-containing group, m can be 0, n can be 2, and both X can be represented by Formula Ic.

In Formula (I), R⁴ and R⁵ can be adamantanyl, R² and R⁷ can be C₄-C₈ hydrocarbyl or a C₆-C₂₀ heteroatom-containing group, m can be 0, n can be 2, and both X can be represented by Formula Ic.

In Formula (I), R⁴ and R⁵ can be adamantanyl, R² and R⁷ can be tert-butyl, 1,1-dimethylpropyl, n-octyl, or tert-butyldimethylsilyl, m can be 0, n can be 2, both X can be represented by Formula Ic.

In Formula (I), R⁴ and R⁵ can be adamantanyl, R² and R⁷ can be C₄-C₄₀ hydrocarbyl or a C₆-C₃₀ heteroatom-containing group, m can be 0, n can be 2, both X can be represented by Formula Ic, and R²⁰, R^{20′}, R²³, R^{23′} can be hydrogen, and each R²¹ and R²² can be hydrogen or hydrocarbyl.

In Formula (I), R⁴ and R⁵ can be adamantanyl, R² and R⁷ can be C₄-C₈ hydrocarbyl or a C₆-C₂₀ heteroatom-containing group, m can be 0, n can be 2, both X can be represented by Formula Ic, and R²⁰, R^{20′}, R²³, R^{23′} can be hydrogen, and each R²¹ and R²² can be hydrogen or hydrocarbyl.

In Formula (I), R⁴ and R⁵ can be adamantanyl, R² and R⁷ can be tert-butyl, 1,1-dimethylpropyl, n-octyl, or tert-butyldimethylsilyl, m can be 0, n can be 2, both X can be represented by Formula Ic, and R²⁰, R^{20′}, R²³, R^{23′} can be hydrogen, and each R²¹ and R²² can be hydrogen or hydrocarbyl.

In any of the above exemplary embodiments of Formula (I), one of R²¹ and R²² can be hydrogen with the other being C₁-C₂₀ hydrocarbyl.

In any of the above exemplary embodiments of Formula (I), one of R²¹ and R²² can be hydrogen with the other being a C₁-C₁₀ hydrocarbyl.

In any of the above exemplary embodiments of Formula (I), one of R²¹ and R²² can be hydrogen with the other being hydrogen, methyl or 4-methylpent-3-en-1-yl.

In any of the above exemplary embodiments of Formula (I), one of R²¹ and R²² can be hydrogen with the other being methyl.

In any of the above exemplary embodiments of Formula (I), one of R²¹ and R²² can be hydrogen with the other being 4-methylpent-3-en-1-yl.

In any of the above exemplary embodiments of Formula (I), both R²¹ and R²² can be hydrogen.

In at least one embodiment, the catalyst compound is one or more of:

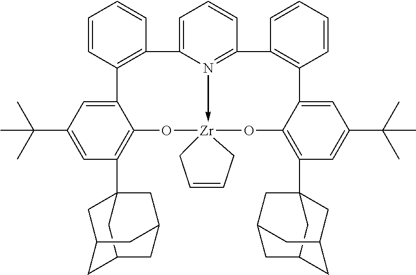

Complex 2

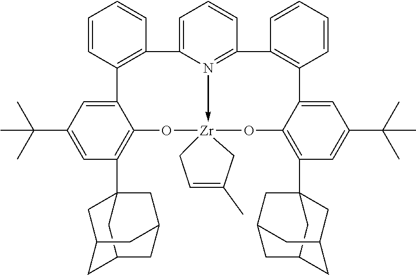

Complex 3

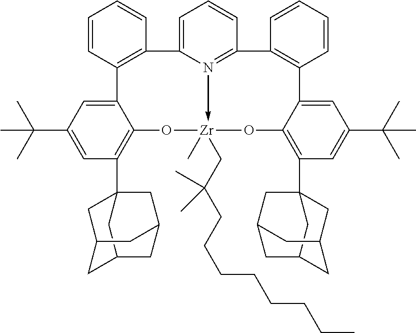

Complex 4

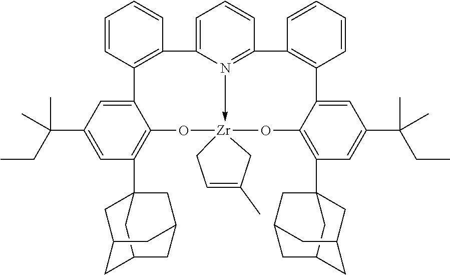

Complex 7

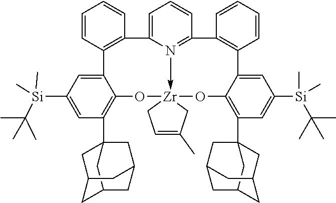

Complex 10

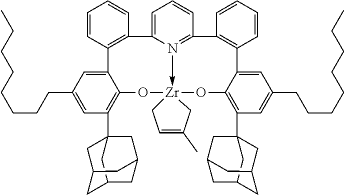

Complex 13

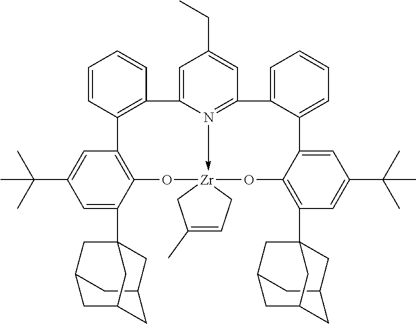

Complex 17

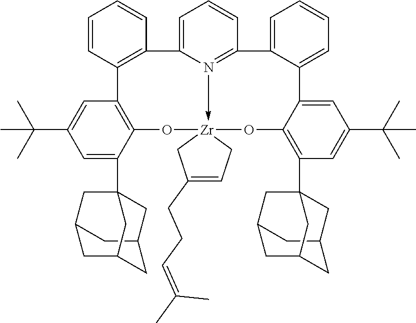

Complex 18

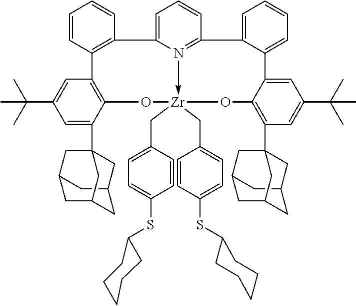

Complex 20

In at least one embodiment, one or more different catalyst compounds are present in a catalyst system. One or more different catalyst compounds can be present in the reaction zone where the process(es) described herein occur. The same activator can be used for the transition metal compounds, however, two different activators, such as a non-coordinating anion activator and an alumoxane, can be used in combination.

Exemplary embodiments of the present technological advancement can also be homogeneous solutions that include an aliphatic hydrocarbon solvent and complexes of Formula (I), with a concentration of the complex 0.20 wt % or greater (alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater). Without intending to be bound by theory, it is believed that the solubility of complexes of Formula (I) in aliphatic solvents is improved when n is 2, and both X together are represented by Formula Ic. Solubility in aliphatic solvents can further be enhanced by the choice of R⁴ and R⁵ substituents and/or R² and R⁷ substituents. For example, the combination of both X together being represented by Formula Ic as in 2-methylbut-2-ene-1,4-diyl, and the choice of R² and R⁷ substituents being octyl in complex 13 greatly enhanced the complexes solubility in isohexane.

Another exemplary embodiment of the present technological advancement includes a process for the production of a propylene based polymer comprising: polymerizing propylene and one or more optional C₃-C₄₀ olefins by contacting the propylene and the one or more optional C₃-C₄₀ olefins with a catalyst system including a composition of Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

Another exemplary embodiment of the present technological advancement includes a process for the production of an ethylene based polymer comprising: polymerizing ethylene and one or more optional C₄-C₄₀ olefins by contacting ethylene and the one or more optional C₄-C₄₀ olefins with a catalyst system including a composition of Formula (I), in one or more continuous stirred tank reactors or loop reactors, in series or in parallel, at a reactor pressure of from 0.05 MPa to 1,500 MPa and a reactor temperature of from 30° C. to 230° C. to form a propylene or ethylene based polymer.

### Activators, and Optional Scavengers, Co-Activators, and Chain Transfer Agents

U.S. patent application Ser. No. 16/788,088 (publication number US2020/0254431) describes activators, optional scavengers, optional co-activators, and optional chain transfer agents useable with the present technological advancement. Particularly useful activators are also described in PCT Application number PCT/US2020/044865 (publication number WO2021/086467), U.S. patent application Ser. No. 16/394,174 (published as US2019/0330394) and PCT Application number PCT/US2019/029056 (published as WO2019/210026) describing non-aromatic-hydrocarbon soluble activator compounds such as N-methyl-4-nonadecyl-N-octadecylanilinium [tetrakis(pentafluorophenyl)borate], N-methyl-4-nonadecyl-N-octadecylanilinium [tetrakis(heptafluoronaphthalenyl)borate], N-methyl-N-octadecyl-4-(octadecyloxy)anilinium [tetrakis(pentafluorophenyl)borate)], N-methyl-N-octadecyl-4-(octadecyloxy)anilinium [tetrakis(heptafluoronaphthalenyl)borate], N,N-di(hydrogenated tallow)methylammonium [tetrakis(pentafluorophenyl)borate], N,N-di(hydrogenated tallow)methylammonium [tetrakis(heptafluoronaphthalenyl)borate], N,N-di(octadecyl)methylammonium [tetrakis(pentafluorophenyl)borate], N,N-di(octadecyl)methylammonium [tetrakis(heptafluoronaphthalenyl)borate], N,N-di(hexadecyl)methylammonium [tetrakis(pentafluorophenyl)borate], N,N-di(hexadecyl)methylammonium [tetrakis(heptafluoronaphthalenyl)borate], N-octadecyl-N-hexadecylmethylammonium [tetrakis(pentafluorophenyl)borate], and N-octadecyl-N-hexadecylmethylammonium [tetrakis(heptafluoronaphthalenyl)borate].

While it is preferred to use an activator that is soluble in a non-aromatic hydrocarbon solvent, activators that are poorly soluble or not soluble in non-aromatic hydrocarbon solvents can be used. When used, these activators can be fed into the reactor via a slurry or as a solid. Particularly useful activators in this class include triphenylcarbenium tetrakis(pentafluorophenyl)borate, triphenylcarbenium tetrakis(perfluoronaphthyl)borate, N,N-dimethylanilinium tetrakis(pentafluorophenyl)borate, N,N-dimethylanilinium tetrakis(perfluoronaphthyl)borate, and the like.

The typical activator-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 1:10.

Particularly useful optional scavengers or co-activators or chain transfer agents include, for example tri-alkyl aluminum such as triisobutylaluminum, tri-n-hexylaluminum, tri-n-octylaluminum, and dialkyl zinc, such as diethyl zinc. Additionally, toluene-free hydrocarbon soluble alumoxanes and modified alumoxanes, including trimethylaluminum “free” alumoxanes can may be used.

Moreover, those of ordinary skill in the art are capable of selecting a suitable known activator(s) and optional scavengers or co-activators or chain transfer agents for their particular purpose without undue experimentation. Combinations of multiple activators may be used. Similarly, combinations of multiple optional scavengers or co-activators or chain transfer agents may be used.

### Solvents

While it is possible to use the catalyst components of the present technological advancement with an aromatic solvent, such as toluene, preferably they are absent when using the catalysts components in a polymerization process. Solvents useful for solubilizing the catalyst compound, the activator compound, or for combining the catalyst compound and activator, and/or for introducing the catalyst system or any component thereof into the reactor, and/or for use in the polymerization process include, but are not limited to, aliphatic hydrocarbon solvents, such as butanes, pentanes, hexanes, heptanes, octanes, nonanes, decanes, undecanes, dodecanes, tridecanes, tetradecanes, pentadecanes, hexadecanes, or a combination thereof; preferable solvents can include normal paraffins (such as Norpar™ solvents available from ExxonMobil Chemical Company in Houston, TX), isoparaffin solvents (such as Isopar™ solvents available from ExxonMobil Chemical Company in Houston, TX), non-aromatic cyclic solvents (such as Nappar™ solvents available from ExxonMobil Chemical Company in Houston, TX) and combinations thereof.

Preferably the aliphatic hydrocarbon solvent is selected from C₄ to C₁₀ linear, branched or cyclic alkanes, alternatively from C₅ to C₈ linear, branched or cyclic alkanes.

Preferably the aliphatic hydrocarbon solvent is essentially free of all aromatic solvents. Preferably the solvent is essentially free of toluene. Free of all aromatic solvents, such as toluene, means that the solvent is essentially free of aromatic solvents (e.g. present at zero mol %, alternately present at less than 1 mol %, preferably the polymerization reaction and/or the polymer produced are free of “detectable aromatic hydrocarbon solvent,” such as toluene.

Preferred aliphatic hydrocarbon solvents include isohexane, cyclohexane, methylcyclohexane, pentane, isopentane, heptane, and combinations thereof, in addition to commercially available solvent mixtures such as Nappar6™, and IsoparE™. However, those of ordinary skill in the art can select other suitable non-aromatic hydrocarbon solvents without undue experimentation.

Highly preferred aliphatic hydrocarbon solvents include isohexane, methylcyclohexane, and commercially available solvent mixtures such as Nappar6™, and IsoparE™.

For compound solubility testing, preferred solvents include isohexane and methylcyclohexane.

### Optional Support Materials

In embodiments herein, the catalyst system may include an inert support material. The supported material can be a porous support material, for example, talc, and inorganic oxides. U.S. patent application Ser. No. 16/788,088 (publication number US2020/0254431) describes optional support materials useable with the present technological advancement. Moreover, those of ordinary skill in the art are capable of selecting a suitable known support for their particular purpose without undue experimentation.

### Polymerization Processes

The present disclosure relates to polymerization processes where monomer (e.g., ethylene; propylene), and optionally one or more comonomer (such as C₂ to C₂₀ alpha olefins, C₄ to C₄₀ cyclic olefins, C₅ to C₂₀ non-conjugated dienes) are contacted with a catalyst system including an activator and at least one catalyst compound, as described above. The catalyst compound and activator may be combined in any order. The catalyst compound and activator may be combined prior to contacting with the monomer. Alternatively, the catalyst compound and activator may be introduced into the polymerization reactor separately, wherein they subsequently react to form the active catalyst.

U.S. patent application Ser. No. 16/788,088 (publication number US2020/0254431) describes monomers useable with the present technological advancement, and describes polymerization processes useable with the present technological advancement.

Additionally, catalysts that are highly soluble in aliphatic hydrocarbon solvents maybe used as trim catalysts in well-known polymerization processes as described for example in WO2015/123177 and WO2020/092587.

### Blends and Films

Polymers made with the present technological advancement can be used to make blends and films as described in U.S. patent application Ser. No. 16/788,088 (publication number US2020/0254431), without undue experimentation.

### EXAMPLES

### General Considerations for Synthesis

2-Bromoiodobenzene (Millipore Sigma), cesium carbonate (Millipore Sigma), 2,6-dibromopyridine (Millipore Sigma), diisobutylaluminum hydride (Millipore Sigma), ethyl isobutyrate (Fisher Scientific), hexane (Millipore Sigma), ethylaluminum dichloride (Millipore Sigma), hydrochloric acid (Fisher Scientific), iodine (Millipore Sigma), isoprene (Millipore Sigma), 2-isopropoxy-4,4,5,5-tetramethyl-1,3,2-dioxaborolane (Millipore Sigma), lithium diisopropylamide (Millipore Sigma), iodooctane (Fisher Scientific), magnesium powder (Strem Chemicals), methanesulfonyl chloride (Millipore Sigma), methanol (Millipore Sigma), methylmagnesium bromide (Millipore Sigma), 1-methyl-2-pyrrolidinone (Millipore Sigma), Pd/C (5% wt. Pd) (Millipore Sigma), potassium carbonate (Strem Chemicals), sodium bicarbonate (Fisher Scientific), sodium bromide (Millipore Sigma), sodium chloride (Fisher Scientific), sodium sulfate (Fisher Scientific), sodium thiosulfate (Millipore Sigma), tetrakis(triphenylphosphine) palladium (0) (Millipore Sigma), tert-pentylphenol (Millipore Sigma), triethylamine (Millipore Sigma), and zirconium(IV) chloride (Strem Chemicals) were used as received. Celite (Millipore Sigma) and molecular sieves (Fisher Scientific) were used after drying at 250° C. under high vacuum for >2 days. d₆-Benzene (Cambridge Isotope Laboratories), dichloromethane (Millipore Sigma), d₂-dichloromethane (Cambridge Isotope Laboratories), diethyl ether (Millipore Sigma), 1,2-dimethoxyethane (Millipore Sigma), pentane (Millipore Sigma), tetrahydrofuran (Millipore Sigma), toluene (Millipore Sigma) were sparged with nitrogen >30 minutes and dried over activated 3 Å molecular sieves prior to use. Isohexanes were obtained in-house and dried over 3 Å molecular sieves prior to use. All other reagents were purchased from commercial vendors (Millipore Sigma, Fisher Scientific, Strem Chemicals or Oakwood Chemical) and used as received unless otherwise noted.

Magnesium-butadiene, tetrahydrofuran adduct was prepared as described in [Organometallics 1982, v. 1, pp. 388-396]. A 0.5M solution of n-heptylmagnesium chloride in THF was synthesized from n-heptylchloride (Sigma-Aldrich) and magnesium turnings in THF via a common synthetic protocol for Grignard reagent synthesis. 2-(1-adamantanyl)-4-(tert-butyl)phenol was prepared as described in Org. Lett. 2015, v. 17, pg. 2242. Lithium diisopropylamide (LDA) was prepared as described in Org. Synth. 1986, v. 64, pg. 68. 2′,2′″-(Pyridine-2,6-diyl)bis(3-adamantan-1-yl)-5-(tert-butyl)-[1,1′-biphenyl]-2-ol) and dimethylzirconium[2′,2′″-(pyridine-2,6-diyl)bis(3-adamantan-1-yl)-5-(tert-butyl)-[1,1′-biphenyl]-2-olate)] (Complex 14) were prepared as described in United States Patent Application US2020/0255553. Dimethylzirconium[2′,2′″-(pyridine-2,6-diyl)bis(3-adamantan-1-yl)-5-(tert-butyldimethylsilyl)-[1,1′-biphenyl]-2-olate)] (Complex 8) was prepared as described in copending U.S. Provisional Application No. 63/338,164.

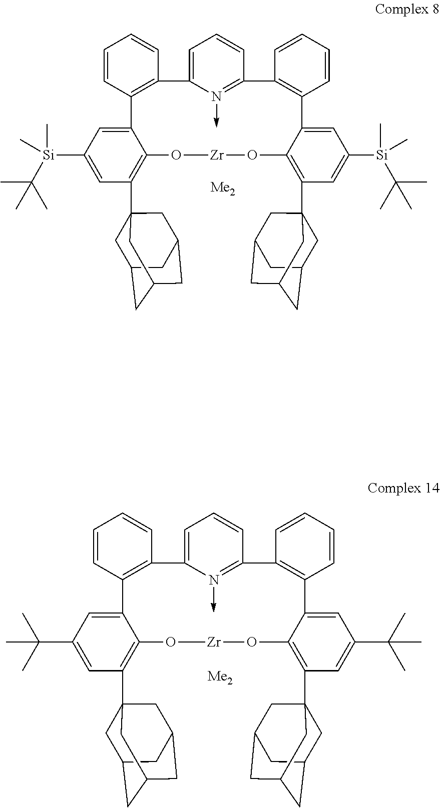

¹H and ¹³C{¹H} NMR spectra were recorded with at least a 400 MHz spectrometer (such as a Bruker Avance NEO 400 MHz spectrometer) using 1-10% solutions in deuterated solvents. Chemical shifts for ¹H and ¹³C are referenced to the residual ¹H or ¹³C resonances of the deuterated solvents.

All reactions were performed in a nitrogen-filled dry box unless otherwise specified. If not otherwise specified, room temperature is 25° C.

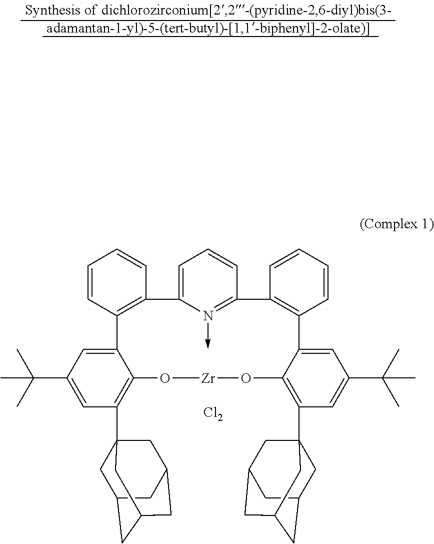

To a precooled, stirring suspension of tetrakis(dimethylamido)zirconium(IV) (0.937 g, 3.50 mmol, 1 equiv.) in 1,2-dimethoxyethane (10 mL), zirconium(IV) chloride (0.812 g, 3.48 mmol) was added with additional 1,2-dimethoxyethane (1 mL). The reaction was stirred at room temperature for 19.5 hours. The stirring was stopped, and the contents of the reaction were allowed to settle. The supernatant was collected and concentrated under a stream of nitrogen. The resulting solid was washed with pentane (10 mL). The pentane-washed solid was concentrated under high vacuum to afford bis(dimethylamido)zirconium dichloride, 1,2-dimethoxyethane adduct as a white solid (1.94 g, 81% yield). ¹H NMR (400 MHz, CD₂Cl₂): δ 3.94 (s, 4H), 3.63 (s, 6H), 3.11 (s, 12H). To a stirring solution of bis(dimethylamido)zirconium dichloride, 1,2-dimethoxyethane adduct (0.178 g, 0.524 mmol, 1 equiv.) in toluene (20 mL), a solution of 2′,2′″-(pyridine-2,6-diyl)bis(3-adamantan-1-yl)-5-(tert-butyl)-[1,1′-biphenyl]-2-ol) (0.417 g, 0.524 mmol) in toluene (20 mL) was slowly added. The reaction was stirred and heated to 70° C. for 15 hours. While cooling, the reaction as concentrated under a stream of nitrogen. The residue was then concentrated under high vacuum at 70° C. to afford the product as a white solid (0.441 g, 88% yield). ¹H NMR (400 MHz, CD₂Cl₂): δ 7.86 (t, 1H, J=7.8 Hz), 7.65 (td, 2H, J=7.6, 1.4 Hz), 7.46 (td, 2H, J=7.6, 1.3 Hz), 7.35 (dd, 2H, J=7.8, 1.2 Hz), 7.27 (d, 2H, J=7.8 Hz), 7.25-7.20 (m, 4H), 6.91 (d, 2H, J=2.5 Hz), 2.18-2.08 (m, 6H), 2.09-1.97 (m, 12H), 1.86 (br d, 6H, J=12.0 Hz), 1.71 (br d, 6H, J=12.0 Hz), 1.25 (s, 18H).

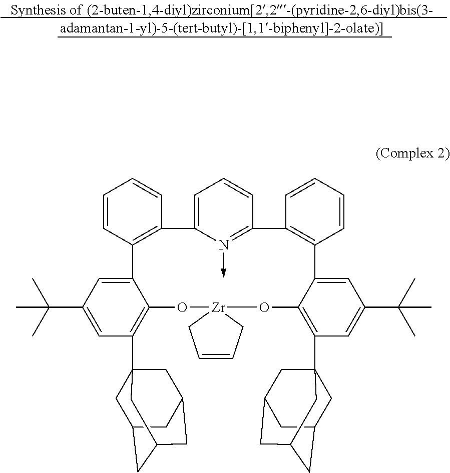

To a stirring suspension of magnesium-butadiene, tetrahydrofuran adduct (0.048 g, 0.22 mmol, 5.0 equiv.) in diethyl ether (5 mL), a solution of dichlorozirconium[2′,2′″-(pyridine-2,6-diyl)bis(3-adamantan-1-yl)-5-(tert-butyl)-[1,1′-biphenyl]-2-olate)] (Complex 1) (0.041 g, 0.043 mmol) in diethyl ether (5 mL) was added. The reaction was stirred at 35° C. for 24 hours. The reaction was filtered over Celite. The filtrate was concentrated under a stream of nitrogen and then under high vacuum to give an orange solid (0.023 g, 57% yield). The solid was mixed with pentane (2 mL), and the mixture was filtered. The filtrate was concentrated under a stream of nitrogen and then under high vacuum. The residue was mixed with hexane (2 mL) and heated to reflux until the solids residue fully dissolved. The solution was then allowed to slowly cool to room temperature, generating small, yellow crystals used for structural confirmation by x-ray diffraction. ¹H NMR (400 MHz, C₆D₆): δ 7.39 (d, 2H, J=2.6 Hz), 7.26-7.17 (m, 5H), 7.14-7.08 (m, 3H), 7.03 (d, 2H, J=2.6 Hz), 6.58 (s, 2H), 5.65-5.51 (br s, 2H), 2.67-1.54 (br m, 34H), 1.30 (s, 18H).

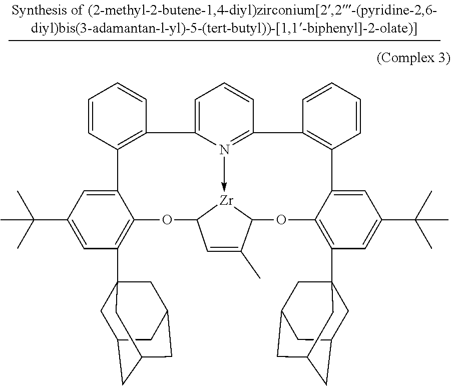

To a stirring suspension of activated magnesium powder (0.007 g, 0.3 mmol, 5.6 equiv.) in diethyl ether (2 mL), a solution of dichlorozirconium[2′,2′″-(pyridine-2,6-diyl)bis(3-adamantan-1-yl)-5-(tert-butyl)-[1,1′-biphenyl]-2-olate)] (Complex 1) (0.049 g, 0.051 mmol) in tetrahydrofuran (5 mL) was added. Then, isoprene (0.05 mL, 0.5 mmol, 9.8 equiv.) was added. The reaction was stirred at room temperature for 24 hours. The reaction was concentrated under a stream of nitrogen and then under high vacuum. The residue was extracted with hexane (10 mL) and filtered over Celite. The filtrate was concentrated under a stream of nitrogen and then under high vacuum to give an orange solid (0.036 g, 73% yield). ¹H NMR (400 MHz, C₆D₆): δ 7.42 (d, 1H, J=2.7 Hz), 7.38-7.33 (m, 2H), 7.27-7.17 (m, 4H), 7.14-7.06 (m, 3H), 7.05 (d, 1H, J=2.6 Hz), 7.00 (d, 1H, J=2.5 Hz), 6.64-6.51 (m, 3H), 5.50 (t, 1H, J=11.7 Hz), 2.93 (t, 1H, J=10.4 Hz), 2.5 (d, 1H, J=8.8 Hz), 2.29-2.15 (m, 6H), 2.15-2.08 (m, 9H), 2.05-1.96 (m, 3H), 1.91-1.73 (m, 15H), 1.33 (s, 9H), 1.27 (s, 9H), 1.09 (d, 1H, J=9.9 Hz), 1.01 (t, 1H, J=11.3 Hz).

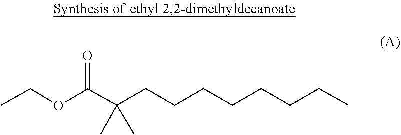 [SMILES: CCCCCCCCC(C)(C)C(=O)OCC]

To a stirring solution of lithium diisopropylamide (9.93 g, 92.7 mmol, 1.06 equiv.) in tetrahydrofuran (90 mL) at −78° C., ethyl isobutyrate (11.8 mL, 87.9 mmol) was added dropwise over the course of 5 minutes. The reaction was stirred at −78° C. for 100 minutes. Then, iodooctane (16.3 mL, 90.5 mmol, 1.03 equiv.) was added. The reaction was allowed to slowly warm to room temperature and stir overnight. The reaction was transferred to a fume hood and quenched with water (10 mL). Then, additional water (100 mL) and diethyl ether (100 mL) were added to the reaction. The contents were poured into a separatory funnel, and the organic layer was extracted. The aqueous phase was extracted further with diethyl ether (2×50 mL). The combined organic extracts were washed with brine, dried over anhydrous magnesium sulfate, and filtered. The filtrate was concentrated in vacuo to afford the crude. The crude material was purified by silica gel column chromatography (100% isohexanes, then 5% diethyl ether in isohexanes) to afford the product as a clear, colorless oil (17.8 g, 88% yield). ¹H NMR (400 MHz, C₆D₆): δ 3.99 (q, 2H, J=7.1 Hz), 1.59-1.52 (m, 2H), 1.36-1.22 (m, 12H), 1.21 (s, 6H), 0.97 (t, 3H, J=7.1 Hz), 0.90 (t, 3H, J=6.9 Hz).

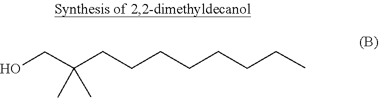

To a precooled, stirring solution of ethyl 2,2-dimethyldecanoate (A) (17.8 g, 77.9 mmol) in dichloromethane (450 mL), diisobutylaluminum hydride (29.0 mL, 163 mmol, 2.09 equiv.) was added. The reaction was stirred at room temperature for 18.5 hours. The reaction was transferred to a fume hood, quenched with wet methanol (100 mL), and diluted with brine (100 mL). The resulting mixture was filtered over a plastic, fritted funnel, extracting further from the filtered solid with diethyl ether (50 mL). Additional diethyl ether (100 mL) was added to the filtrate. The filtrate was poured into a separatory funnel, and the organic layer was collected. The aqueous phase was extracted further with diethyl ether (2×100 mL). The combined organic extracts were dried over anhydrous magnesium sulfate and filtered. The filtrate was concentrated in vacuo. The resulting crude was filtered over a thick pad of silica packed with pentane (15-20 cm thick), extracting the first fraction with pentane (300 mL). Into a separate flask, the remaining material on the silica gel was extracted with 20% diethyl ether in pentane (500 mL). The second fraction was concentrated in vacuo to afford a fraction of the product (11.0 g). The first fraction contained iodooctane contamination (1:0.14 product: iodooctane), and was therefore purified further via silica gel column chromatography. The pure fractions of this column were combined with the pure second fraction from the silica filtration to afford the product as a clear, colorless oil (12.88 g, 88% yield). ¹H NMR (400 MHz, C₆D₆): δ 3.10 (d, 2H, J=5.7 Hz), 1.38-1.15 (m, 14H), 0.95-0.89 (m, 3H), 0.82 (s, 6H), 0.65 (t, 1H, J=5.7 Hz).

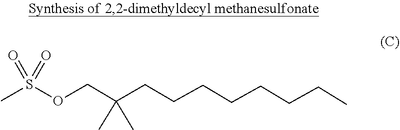 [SMILES: CCCCCCCCC(C)(C)COS(C)(=O)=O]

To a stirring solution of 2,2-dimethyldecanol (B) (4.71 g, 25.3 mmol) and triethylamine (5.3 mL, 38 mmol, 1.5 equiv.) in dichloromethane (150 mL), methanesulfonyl chloride (2.2 mL, 28 mmol, 1.1 equiv.) was added over the course of approximately 30 seconds. The reaction, a light orange solution, was stirred at room temperature for 19 hours. The reaction was transferred to a fume hood and poured into ice water in a separatory funnel. The mixture was shaken, and the organic layer was collected. The aqueous layer was extracted further with dichloromethane (100 mL). The combined dichloromethane extracts were washed with aqueous hydrochloric acid (50 mL, 1M), then saturated aqueous sodium bicarbonate (50 mL), then brine. The organic extract was dried over anhydrous sodium sulfate and filtered. The filtrate was concentrated in vacuo to afford the product as an orange-brown oil (5.32 g, 79% yield). ¹H NMR (400 MHz, C₆D₆): δ 3.65 (s, 2H), 2.36-2.21 (m, 3H), 1.42-1.00 (m, 14H), 0.95-0.86 (m, 3H), 0.74 (s, 6H).

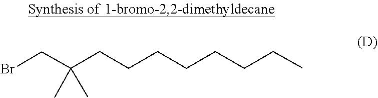

A mixture of 2,2-dimethyldecyl methanesulfonate (C) (1.00 g, 3.80 mmol) and anhydrous sodium bromide (1.17 g, 11.4 mmol, 3 equiv.) were stirred under high vacuum for 1 hour. Then, 1-methyl-2-pyrrolidinone (8 mL) was added to the mixture. The resulting solution was stirred and heated to 140° C. for 2 hours. The reaction was allowed to cool to room temperature. The reaction was then transferred to a fume hood and partitioned between water (100 mL) and pentane (50 mL). The aqueous layer was drained, and the pentane extract was washed with aqueous sodium thiosulfate (50 mL). The pentane extract was collected, dried over anhydrous potassium carbonate, and filtered. The filtrate was concentrated in vacuo to afford the product as an orange oil (0.728 g, 76% yield). ¹H NMR (400 MHz, C₆D₆): δ 2.98 (s, 2H), 1.38-1.14 (m, 12H), 1.13-1.00 (m, 2H), 0.93 (t, 3H, J=6.9 Hz), 0.82 (s, 6H).

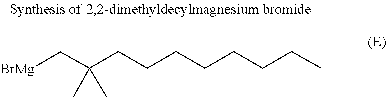

To a grey suspension of magnesium powder (0.390 g, 16.0 mmol, 2 equiv.) in diethyl ether (20 mL), iodine (0.102 g, 0.05 equiv.) was added. The reaction was stirred until the brown suspension returned to a grey suspension. Then, 1-bromo-2,2-dimethyldecane (D) (2.00 g, 8.02 mmol) was added. The reaction was stirred at room temperature for 5 hours. The resulting suspension was filtered over Celite. The filtrate was titrated, suggesting a 0.13M concentration. The ¹H NMR also revealed the formation of 9,9,12,12-tetramethyleicosane (see procedure below). Solution used as is without further characterization.

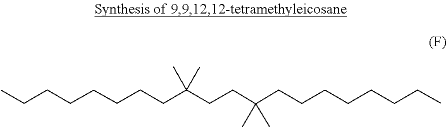 [SMILES: CCCCCCCCC(C)(C)CCC(C)(C)CCCCCCCC]

To a stirring suspension of magnesium powder (0.360 g, 14.8 mmol, 19.1 equiv.) in diethyl ether (50 mL), a solution of 1-bromo-2,2-dimethyldecane (D) (0.193 g, 0.774 mmol) in diethyl ether (10 mL) was added rapidly. The reaction was stirred at room temperature overnight. The reaction was filtered over Celite. A sample of the filtrate was titrated with iodine in tetrahydrofuran/lithium chloride, with no disappearance of color, confirming no activate Grignard species. ¹H NMR (400 MHz, C₆D₆): δ 1.37-1.21 (m, 16H), 0.96-0.87 (m, 9H).

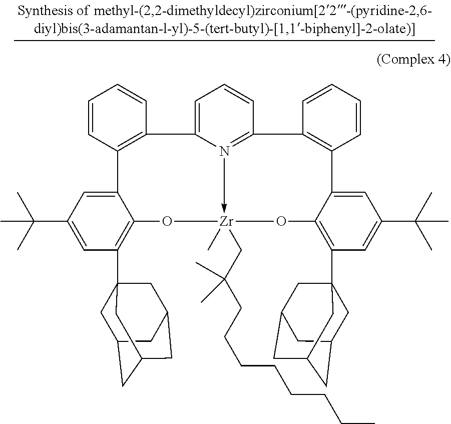

To a stirring solution of dichlorozirconium[2′,2′″-(pyridine-2,6-diyl)bis(3-adamantan-1-yl)-5-(tert-butyl)-[1,1′-biphenyl]-2-olate)] (Complex 1) (0.070 g, 0.073 mmol) in diethyl ether, methylmagnesium bromide (0.02 mL, 3.0M in diethyl ether, 0.07 mmol, 0.8 equiv.) was added. The reaction was stirred and heated to reflux for 2 hours. Then, a solution of 2,2-dimethyldecylmagnesium bromide (E) in diethyl ether (0.56 mL, 0.13M in diethyl ether, 0.073 mmol, 1 equiv.) and toluene (5 mL) was added. The reaction was stirred and heated to 90° C. for 66 hours. Then, additional methylmagnesium bromide was added, and the reaction was heated to 105° C. for 1.5 hours. The reaction was concentrated under a stream of nitrogen. The resulting residue was extracted with pentane (5 mL) and filtered over Celite. The filtrate was concentrated under a stream of nitrogen and then under high vacuum. The resulting residue was dissolved in pentane (2 mL) and cooled to −35° C. The resulting mixture was filtered over Celite. The filtrate was concentrated under a stream of nitrogen and then under high vacuum to afford the product, containing 9,9,12,12-tetramethyleicosane (1.42 equiv.) as an impurity. ¹H NMR (400 MHz, C₆D₆): δ 7.59 (d, 1H, J=2.6 Hz), 7.55 (d, 1H, J=2.7 Hz), 7.43 (dd, 1H, J=7.7, 1.1 Hz), 7.31 (td, 1H, J=7.6, 1.3 Hz), 7.21 (dd, 2H, J=7.7, 1.4 Hz), 7.12-6.99 (m, 5H), 6.86 (dd, 1H, J=7.5, 1.6 Hz), 6.46-6.40 (m, 2H), 6.29 (dd, 1H, J=6.4, 2.5 Hz), 2.70-2.61 (m, 3H), 2.58-2.52 (m, 3H), 2.51-2.45 (m, 3H), 2.39-2.32 (m, 3H), 2.29-2.22 (m, 6H), 2.12-2.03 (m, 6H), 1.94-1.82 (m, 6H), 1.73 (d, 1H, J=12.6 Hz), 1.40-0.84 (m, 41H), 0.04 (s, 3H), −1.01 (d, 1H, J=12.7 Hz).

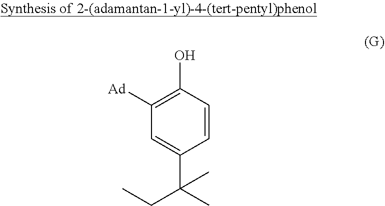

To a solution of 39.5 g (241 mmol) of tert-pentylphenol in 240 ml of dichloromethane 36.7 g (241 mmol) of adamantan-1-ol was added. Next, to the obtained solution 14.5 ml of sulfuric acid was added dropwise for 30 minutes. The resulting suspension was stirred for 30 minutes at room temperature and then carefully poured into 300 ml of the crushed ice containing 50 ml of the saturated aqueous ammonia. The obtained mixture was extracted with dichloromethane (3×100 ml), the combined organic extract was washed with 5% NaHCO₃, dried over Na₂SO₄, and then evaporated to dryness. The residue was recrystallized from n-hexane. Yield 43.2 g (60%) of a white solid. ¹H NMR (CDCl₃, 400 MHz): δ 7.21 (d, J=2.3 Hz, 1H), 7.03 (dd, J=8.2, 2.3 Hz, 1H), 6.58 (d, J=8.2 Hz, 1H), 4.60 (s, 1H), 2.13-2.19 (m, 6H), 2.12 (br.s, 3H), 1.79-1.85 (m, 6H), 1.64 (q, J=7.5 Hz, 2H), 1.29 (s, 6H), 0.73 (t, J=7.5 Hz, 3H). ¹³C NMR (CDCl₃, 100 MHz): δ 151.8, 141.4, 135.4, 124.6, 123.9, 116.1, 40.6, 37.5, 37.1, 37.0, 36.8, 29.1, 28.6, 9.2.

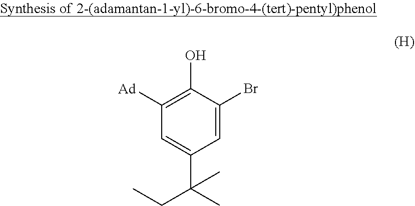

To a solution of 43.9 g (147 mmol) of 2-(adamantan-1-yl)-4-(tert-pentyl)phenol (G) in 400 ml of chloroform a solution of 7.53 ml (147 mmol) of bromine in 200 ml of chloroform was added dropwise for 30 minutes at room temperature. The resulting mixture was diluted with 400 ml of water. The obtained mixture was extracted with dichloromethane (3×100 ml), the combined organic extract was washed with 5% NaHCO₃, dried over Na₂SO₄, and then evaporated to dryness. Yield 55.4 g (almost quant.) of a white solid. ¹H NMR (CDCl₃, 400 MHz): δ 7.28 (d, J=2.2 Hz, 1H), 7.14 (d, J=2.2 Hz, 1H), 5.67 (s, 1H), 2.13-2.17 (m, 6H), 2.11 (br.s, 3H), 1.78-1.84 (m, 6H), 1.62 (q, J=7.5 Hz, 2H), 1.27 (s, 6H), 0.72 (t, J=7.5 Hz, 3H). ¹³C NMR (CDCl₃, 100 MHz): δ 147.9, 142.1, 136.9, 126.7, 124.2, 112.2, 40.3, 37.63, 37.60, 37.0, 36.9, 29.0, 28.5, 9.2.

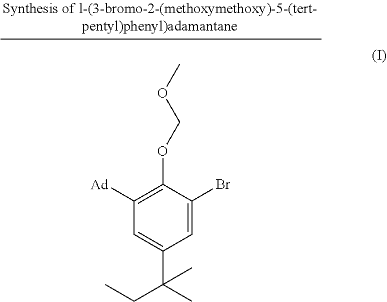

To a solution of 55.4 g (147 mmol) of 2-(adamantan-1-yl)-6-bromo-4-(tert-pentyl)phenol (H) in 700 ml of THF 6.35 g (159 mmol, 60% wt. in mineral oil) of sodium hydride was added portionwise at room temperature. To the resulting suspension 12.1 ml (159 mmol) of methoxymethyl chloride was added dropwise for 10 minutes at room temperature. The obtained mixture was stirred overnight, then poured into 1000 ml of water. The obtained mixture was extracted with dichloromethane (3×300 ml), the combined organic extract was washed with 5% NaHCO₃, dried over Na₂SO₄, and then evaporated to dryness. Yield 61.8 g (quant.) of a white solid. ¹H NMR (CDCl₃, 400 MHz): δ7.32 (d, J=2.4 Hz, 1H), 7.17 (d, J=2.4 Hz, 1H), 5.22 (s, 2H), 3.70 (s, 3H), 2.04-2.14 (m, 9H), 1.72-1.80 (m, 6H), 1.58 (q, J=7.4 Hz, 2H), 1.23 (s, 6H), 0.68 (t, J=7.4 Hz, 3H). ¹³C NMR (CDCl₃, 100 MHz): δ 150.7, 146.0, 144.3, 129.1, 124.4, 117.5, 99.5, 57.8, 41.4, 38.0, 37.8, 36.9, 36.8, 29.1, 28.3, 9.1.

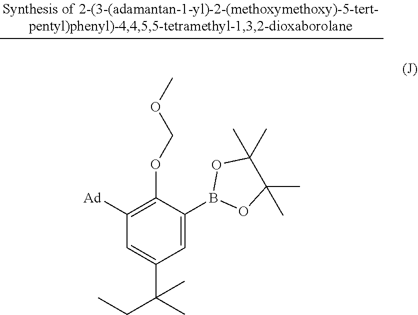

To a solution of 61.8 g (147 mmol) of 1-(3-bromo-2-(methoxymethoxy)-5-(tert-pentyl)phenyl)adamantane (I) in 1,000 ml of dry THF 70.1 ml (176 mmol) of 2.5M ⁿBuLi in hexanes was added dropwise for 20 minutes at −80° C. The reaction mixture was stirred at this temperature for 1 hour followed by addition of 45.3 ml (220 mmol) of 2-isopropoxy-4,4,5,5-tetramethyl-1,3,2-dioxaborolane. The obtained suspension was stirred for 1 hour at room temperature, then poured into 300 ml of water. The obtained mixture was extracted with dichloromethane (3×300 ml), the combined organic extract was dried over Na₂SO₄ and then evaporated to dryness. Yield 69.2 g (quant.) of a colorless viscous oil. ¹H NMR (CDCl₃, 400 MHz): δ 7.45 (d, J=2.6 Hz, 1H), 7.33 (d, J=2.6 Hz, 1H), 5.16 (s, 2H), 3.58 (s, 3H), 2.13-2.18 (m, 6H), 2.07 (br.s, 3H), 1.73-1.83 (m, 6H), 1.62 (q, J=7.4 Hz, 2H), 1.35 (s, 12H), 1.27 (s, 6H), 0.69 (t, J=7.4 Hz, 3H). ¹³C NMR (CDCl₃, 100 MHz): δ 159.6, 143.0, 140.4, 131.3, 128.0, 100.9, 83.5, 57.7, 41.3, 37.6, 37.3, 37.1, 36.9, 29.2, 28.4, 24.8, 9.2.

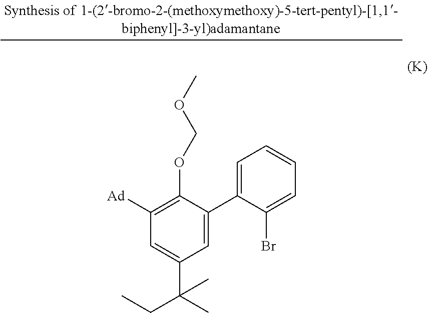

To a solution of 34.5 g (73.5 mmol) of 2-(3-(adamantan-1-yl)-2-(methoxymethoxy)-5-(tert-pentyl)phenyl)-4,4,5,5-tetramethyl-1,3,2-dioxaborolane (J) in 200 ml of 1,4-dioxane 20.9 g (73.5 mmol) of 2-bromoiodobenzene, 60.1 g (184 mmol) of cesium carbonate, and 100 ml of water were subsequently added. The mixture obtained was purged with argon for 10 minutes followed by addition of 4.25 g (3.69 mmol) of Pd(PPh₃)₄. This mixture was stirred for 12 hours at 100° C., then cooled to room temperature, and diluted with 100 ml of water. The obtained mixture was extracted with dichloromethane (3×100 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 19.7 g (54%) of a white solid. ¹H NMR (CDCl₃, 400 MHz): δ7.68 (d, J=7.8 Hz, 1H), 7.42 (dd, J=7.6, 1.5 Hz, 1H), 7.35 (t, J=7.1 Hz, 1H), 7.29 (d, J=2.3 Hz, 1H), 7.20 (dt, J=7.9, 1.5 Hz, 1H), 7.02 (d, J=2.3 Hz, 1H), 4.54-4.55 (m, 1H), 4.41-4.42 (m, 1H), 3.21 (s, 3H), 2.17-2.21 (m, 6H), 2.11 (br.s, 3H), 1.75-1.86 (m, 6H), 1.64 (dq, J=7.5, 3.0 Hz, 2H), 1.31 (s, 3H), 1.28 (s, 3H), 0.73 (t, J=7.5 Hz, 3H). 3C NMR (CDCl₃, 100 MHz): δ 151.2, 143.5, 142.0, 141.6, 133.8, 132.9, 132.4, 128.5, 127.4, 127.0, 124.5, 124.3, 98.8, 57.1, 41.4, 37.8, 37.5, 37.0, 29.2, 28.43, 28.38, 9.2.

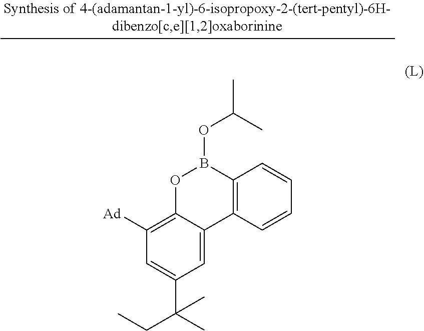

To a solution of 19.7 g (39.6 mmol) of 1-(2′-bromo-2-(methoxymethoxy)-5-(tert-pentyl)-[1,1′-biphenyl]-3-yl)adamantane (K) in 300 ml of dry THF 19.0 ml (47.5 mmol) of 2.5M ⁿBuLi in hexanes was added dropwise for 20 minutes at −80° C. The reaction mixture was stirred for 1 hour at this temperature followed by addition of 12.1 ml (59.3 mmol) of 2-isopropoxy-4,4,5,5-tetramethyl-1,3,2-dioxaborolane. The obtained suspension was stirred for 1 hour at room temperature, then poured into 300 ml of water. The obtained mixture was extracted with dichloromethane (3×300 ml), the combined organic extract was dried over Na₂SO₄ and then evaporated to dryness. To the residue 120 ml of isopropanol was added, and the resulting solution was refluxed for 2 hours. After cooling to room temperature, the precipitate formed was filtered off on glass frit (G4), washed with 10 ml of cold isopropanol and dried in vacuum. Yield 13.6 g (77%) of a white solid. ¹H NMR (CDCl₃, 400 MHz): δ8.19 (d, J=8.3 Hz, 1H), 8.09 (d, J=6.5 Hz, 1H), 8.01 (d, J=2.0 Hz, 1H), 7.67 (dt, J=7.6, 1.5 Hz, 1H), 7.43 (t, J=7.3 Hz, 1H), 7.37 (d, J=2.2 Hz, 1H), 5.27 (sept, J=6.1 Hz, 1H), 2.28-2.38 (m, 6H), 2.18 (br.s, 3H), 1.83-1.93 (m, 6H), 1.74 (q, J=7.4 Hz, 2H), 1.43 (d, J=6.1 Hz, 6H), 1.40 (s, 6H), 0.76 (t, J=7.4 Hz, 3H). ¹³C NMR (CDCl₃, 100 MHz): δ148.2, 142.2, 141.0, 138.8, 133.1, 126.5, 124.6, 122.1, 118.8, 65.7, 40.8, 37.9, 37.4, 37.2, 37.0, 29.2, 28.7, 24.7, 9.3.

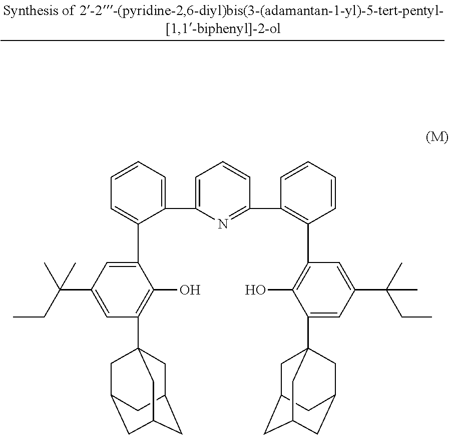 [SMILES: CCC(C)(C)c1cc(-c2ccccc2-c2cccc(-c3ccccc3-c3cc(C(C)(C)CC)cc(C45CC6CC(CC(C6)C4)C5)c3O)n2)c(O)c(C23CC4CC(CC(C4)C2)C3)c1]

To a solution of 13.6 g (30.6 mmol) of 4-(adamantan-1-yl)-6-isopropoxy-2-(tert-pentyl)-6H-dibenzo[c,e][1,2] oxaborinine (L) in 80 ml of 1,4-dioxane 3.55 g (15.0 mmol) of 2,6-dibromopyridine, 24.4 g (76.6 mmol) of cesium carbonate, and 38 ml of water were subsequently added. The mixture obtained was purged with argon for 10 minutes followed by addition of 1.77 g (1.55 mmol) of Pd(PPh₃)₄. This mixture was stirred for 12 hours at 100° C., then cooled to room temperature, and diluted with 50 ml of water. The obtained mixture was extracted with dichloromethane (3×50 ml), the combined organic extract was dried over Na₂SO₄ and then evaporated to dryness. The residue was purified by flash chromatography on silica gel 60 (40-63 um, eluent: hexane-ethyl acetate=10:1, vol.). Yield 10.5 g (85%) of a mixture of two isomers as a glassy solid. ¹H NMR (CDCl₃, 400 MHz): δ 8.00 (s, 2H in A), 7.39-7.59 (m, 9H in A and B), 7.06 (d, J=2.1 Hz, 2H in A and B), 7.01 (d, J=7.6 Hz, 2H in B), 6.99 (d, J=7.8 Hz, 2H in A), 6.88 (d, J=2.1 Hz, 2H in B), 6.55 (d, J=2.1 Hz, 2H in A), 6.36 (s, 2H in B), 1.91-2.08 (m, 18H in A and B), 1.71 (br.s, 12H in A and B), 1.49 (dq, J=7.6, 2.5 Hz, 4H in B), 1.26-1.45 (m, 4H in A), 1.18 (s, 6H in B), 1.17 (s, 6H in B), 1.06 (s, 6H in A), 1.03 (s, 6H in A), 0.57 (t, J=7.5 Hz, 6H in B), 0.42 (t, J=7.5 Hz, 6H in A). ¹³C NMR (CDCl₃, 100 MHz, signals attributed to the minor isomer are marked with *): δ 157.8, 149.9, 149.1*, 140.1*, 140.0*, 139.9, 139.5, 137.8, 137.2, 137.1*, 136.8, 136.1*, 131.8, 130.9, 130.5*, 129.6, 129.0*, 128.9, 128.5*, 127.9*, 127.7, 126.8, 126.3*, 123.6, 122.5, 122.1*, 40.5, 40.4*, 37.3*, 37.2, 37.0, 36.99*, 36.92*, 36.87, 29.12, 29.09*, 28.49, 28.44, 28.41*, 28.3, 9.12*, 9.07.

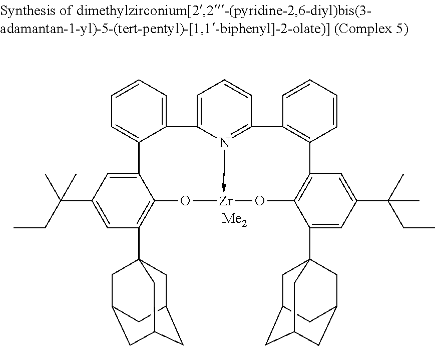

To a suspension of 707 mg (3.03 mmol) of zirconium tetrachloride in 350 ml of dry toluene 4.71 ml (13.5 mmol) of 2.9M MeMgBr in diethyl ether was added in one portion via syringe at −30° C. To the resulting suspension 2.50 g (3.03 mmol) of 2′,2′″-(pyridine-2,6-diyl)bis(3-(adamantan-1-yl)-5-(tert-pentyl)-[1,1′-biphenyl]-2-ol) (M) was immediately added in one portion. The reaction mixture was stirred for 3 hours at room temperature and then evaporated to near dryness. The solids obtained were extracted with 2×100 ml of toluene, and the combined organic extract was filtered through a thin pad of Celite 503. Next, the filtrate was evaporated to dryness. The residue was triturated with 10 ml of n-hexane, the obtained precipitate was filtered off (G3), washed two times with 10 ml of n-hexane, and then dried in vacuum. Yield 2.66 g (93%) of a beige solid. Anal. Calc. for C₆₁H₇₃ZrNO₂: C, 77.66; H, 7.80; N, 1.48. Found: C, 77.88; H, 8.01; N, 1.26. ¹H NMR (C₆D₆, 400 MHz): δ 7.48 (d, J=2.4 Hz, 2H), 7.20 (dd, J=7.2, 1.1 Hz, 2H), 6.95-7.13 (m, 8H), 6.54 (dd, J=8.3, 7.2 Hz, 1H), 6.41 (d, J=7.9 Hz, 2H), 2.52-2.61 (m, 6H), 2.38-2.47 (m, 6H), 2.19 (br.s, 6H), 1.95-2.04 (m, 6H), 1.80-1.89 (m, 6H), 1.64 (dq, J=7.5, 2.3 Hz, 4H), 1.31 (s, 6H), 1.29 (s, 6H), 0.76 (t, J=7.5 Hz, 6H), 0.12 (s, 6H). ¹³C NMR (C₆D₆, 100 MHz): δ 159.1, 158.3, 143.8, 139.4, 138.7, 138.0, 133.6, 133.3, 133.1, 131.5, 131.2, 127.9, 126.5, 125.1, 124.5, 42.9, 42.0, 38.5, 38.0, 37.91, 37.85, 30.0, 29.3, 29.2, 9.9.

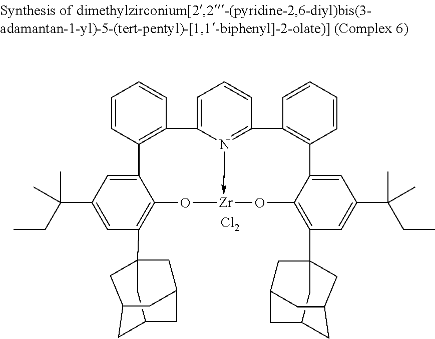

To a stirring solution of dimethylzirconium[2′,2′″-(pyridine-2,6-diyl)bis(3-adamantan-1-yl)-5-(tert-pentyl)-[1,1′-biphenyl]-2-olate)] (Complex 5) (0.236 g, 0.250 mmol) in toluene (15 mL), a solution of ethylaluminum dichloride (0.55 mL, 1.01M in hexane, 0.56 mmol, 2.2 equiv.) was added. The reaction was stirred and heated to 60° C. for 3 hours. While cooling, the reaction was concentrated under a stream of nitrogen and then under high vacuum. The residue was stirred in hexane (10 mL) and filtered over a plastic, fritted funnel. The filtered solid was washed further with hexane (5 mL). The solid was collected and concentrated under high vacuum to afford the product as a light grey solid (0.226 g, 91% yield). ¹H NMR (400 MHz, C₆D₆): δ 7.50-7.44 (m, 2H), 7.26-7.13 (m, 6H), 7.09-7.02 (m, 2H), 7.01-6.94 (m, 2H), 6.52-6.46 (m, 1H), 6.42-6.33 (m, 2H), 2.52-2.40 (m, 6H), 2.40-2.28 (m, 6H), 2.23-2.03 (m, 12H), 1.88-1.77 (m, 6H), 1.67-1.55 (m, 4H), 1.31-1.20 (m, 12H), 0.79-0.70 (m, 6H).

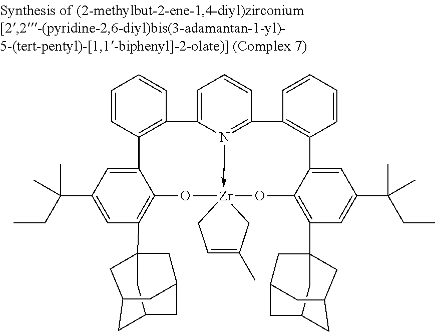

To a stirring suspension of activated magnesium powder (0.015 g, 0.62 mmol, 6.1 equiv.) in diethyl ether (3 mL), a solution of dichlorozirconium[2′,2′″-(pyridine-2,6-diyl)bis(3-adamantan-1-yl)-5-(tert-pentyl)-[1,1′-biphenyl]-2-olate)] (Complex 6) (0.099 g, 0.10 mmol) in tetrahydrofuran (3 mL) was added. Then, isoprene (0.08 mL, 0.8 mmol, 8 equiv.) was added. The reaction was stirred at room temperature for 2.5 hours. The reaction was concentrated under a stream of nitrogen and then under high vacuum. The residue was extracted with hexane (15 mL) and filtered over Celite. The filtrate was concentrated under a stream of nitrogen and then under high vacuum to afford the product as an orange solid, containing hexane (0.42 equiv) (0.049 g, 48% yield). ¹H NMR (400 MHz, C₆D₆): δ 7.38-7.32 (m, 2H), 7.27 (d, 1H, J=2.6 Hz), 7.26-7.08 (m, 7H), 6.95 (d, 1H, J=2.6 Hz), 6.91 (d, 1H, J=2.5 Hz), 6.73-6.57 (m, 3H), 5.49 (t, 1H, J=11.7 Hz), 2.93 (t, 1H, J=10.6 Hz), 2.61 (d, 1H, J=8.6 Hz), 2.30-2.15 (m, 6H), 2.15-2.06 (m, 9H), 2.04-1.95 (m, 3H), 1.92-1.74 (m, 15H), 1.66-1.52 (m, 4H), 1.30 (s, 3H), 1.28 (s, 3H), 1.26 (s, 3H), 1.23 (s, 3H), 1.09 (d, 1H, J=9.1 Hz), 1.02 (t, 1H, J=11.3 Hz), 0.74 (t, 3H, J=7.4 Hz), 0.66 (t, 3H, J=7.4 Hz).

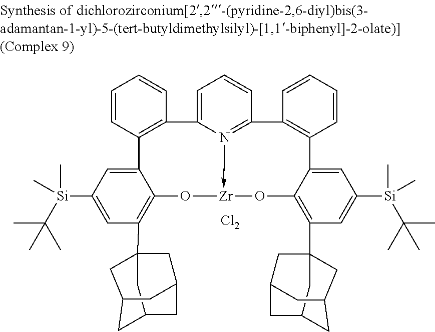

To a stirring solution of dimethylzirconium[2′,2′″-(pyridine-2,6-diyl)bis(3-adamantan-1-yl)-5-(tert-butyldimethylsilyl)-[1,1′-biphenyl]-2-olate)] (Complex 8) (0.272 g, 0.264 mmol) in toluene (15 mL), a solution of ethylaluminum dichloride (0.58 mL, 1.01M in hexane, 0.59 mmol, 2.2 equiv.) was added. The reaction was stirred and heated to 60° C. for 5 hours. While cooling, the reaction was concentrated under a stream of nitrogen and then under high vacuum. The residue was stirred in hexane (10 mL) and filtered over a plastic, fritted funnel. The filtered solid was washed further with hexane (5 mL). The solid was collected and concentrated under high vacuum to afford the product as a light grey solid (0.262 g, 92% yield). ¹H NMR (400 MHz, C₆D₆): δ 7.74-7.69 (m, 2H), 7.28-7.12 (m, 8H), 7.08-7.03 (m, 2H), 6.49-6.43 (m, 1H), 6.39-6.30 (m, 2H), 2.53-2.41 (m, 6H), 2.41-2.31 (m, 6H), 2.21-2.12 (m, 6H), 2.11-2.00 (m, 6H), 1.86-1.73 (m, 6H), 1.01-0.95 (m, 18H), 0.30-0.21 (m, 12H).

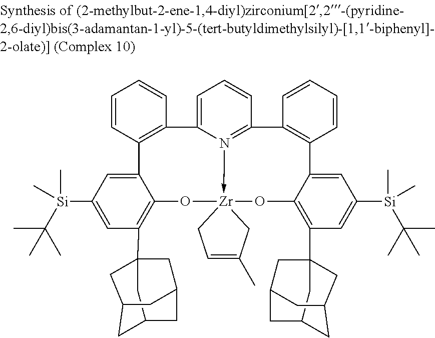

To a stirring suspension of activated magnesium powder (0.012 g, 0.49 mmol, 5.3 equiv.) in diethyl ether (3 mL), a solution of dichlorozirconium[2′,2′″-(pyridine-2,6-diyl)bis(3-adamantan-1-yl)-5-(tert-butyldimethylsilyl)-[1,1′-biphenyl]-2-olate)] (Complex 9) (0.100 g, 0.093 mmol) in tetrahydrofuran (3 mL) was added. Then, isoprene (0.07 mL, 0.7 mmol, 7.5 equiv.) was added. The reaction was stirred at room temperature for 2 hours. The reaction was concentrated under a stream of nitrogen and then under high vacuum. The residue was washed stirred in hexane (10 mL) and filtered over Celite. The hexane washed solid was then extracted with toluene (5 mL). The toluene extract was concentrated under a stream of nitrogen and then under high vacuum to afford the product as a brown solid (0.068 g, 68% yield). ¹H NMR (400 MHz, C₆D₆): δ 7.58 (d, 1H, J=1.8 Hz), 7.50 (d, 1H, J=1.8 Hz), 7.33 (d, 1H, J=6.7 Hz), 7.25-6.99 (m, 9H), 6.70-6.64 (m, 1H), 6.63-6.56 (m, 2H), 5.49 (t, 1H, J=11.7 Hz), 2.92 (t, 1H, J=10.7 Hz), 2.59 (d, 1H, J=9.1 Hz), 2.31-2.16 (m, 6H), 2.15-2.04 (m, 9H), 2.03-1.95 (m, 3H), 1.91-1.69 (m, 15H), 1.13 (d, 1H, J=8.9 Hz), 1.09-1.03 (m, 1H), 0.97 (s, 9H), 0.91 (s, 9H), 0.29 (s, 3H), 0.27 (s, 3H), 0.26 (s, 3H), 0.23 (s, 3H).

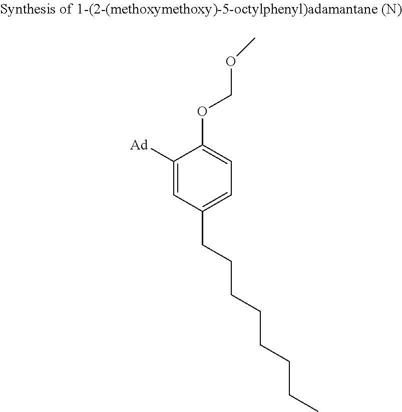

To a solution of 17.1 g (56.9 mmol) of 3-(adamantan-1-yl)-4-(methoxymethoxy)benzaldehyde in 100 ml of THF 240 ml (120 mmol) of 0.5M n-heptylmagnesium chloride in THF was added dropwise for 20 minutes at 0° C. The obtained suspension was stirred for 12 hours at room temperature, then poured into 300 ml of water. The obtained mixture was extracted with dichloromethane (3×200 ml), the combined organic extract was dried over Na₂SO₄ and then evaporated to dryness. The residue was transferred to hydrogenation reactor and then was dissolved in a mixture of 75 ml of methanol and 75 ml of THF. To the obtained solution 4.0 g of Pd/C (5% wt. Pd) was added, and the reactor was pressurized with hydrogen to 270 psi. The reaction mixture was stirred at constant pressure overnight at room temperature, after that the pressure was released. The reaction mixture was filtered through a Celite 503 pad, and the obtained filtrate was evaporated to dryness. The residue was purified by flash chromatography on silica gel 60 (40-63 um, eluent: hexane-dichloromethane=10:1→4:1, vol.). Yield 16.1 g (73%) of a yellow oil. ¹H NMR (CDCl₃, 400 MHz): δ7.09 (d, J=2.1 Hz, 1H), 7.06 (d, J=8.3 Hz, 1H), 6.99 (dd, J=8.3, 2.1 Hz, 1H), 5.24 (s, 2H), 3.56 (s, 3H), 2.56-2.60 (m, 2H), 2.16-2.19 (m, 6H), 2.12 (br.s, 3H), 1.81-1.85 (m, 6H), 1.59-1.68 (m, 2H), 1.25-1.40 (m, 10H), 0.93 (t, J=7.1 Hz, 3H). ¹³C NMR (CDCl₃, 100 MHz): δ 154.5, 138.2, 135.7, 126.8, 126.3, 114.3, 94.4, 56.0, 40.7, 37.1, 36.9, 35.6, 31.9, 31.8, 29.5, 29.3, 29.1, 22.7, 14.1.

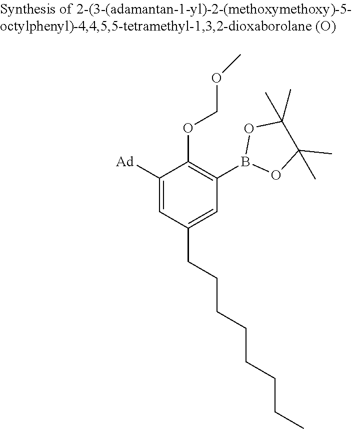

To a solution of 16.0 g (41.6 mmol) of 1-(2-(methoxymethoxy)-5-octylphenyl)adamantane (N) in 250 ml of diethyl ether 25.0 ml (62.4 mmol) of 2.5M ⁿBuLi in hexanes was added dropwise for 20 minutes at 0° C. The reaction mixture was stirred for 12 hours at room temperature, cooled to −80° C. followed by addition of 17.0 ml (83.2 mmol) of 2-isopropoxy-4,4,5,5-tetramethyl-1,3,2-dioxaborolane. The obtained suspension was stirred for 1 hour at room temperature, then poured into 300 ml of water. The obtained mixture was extracted with dichloromethane (3×200 ml), the combined organic extract was dried over Na₂SO₄ and then evaporated to dryness. Yield 20.6 g (97%) of a colorless oil. ¹H NMR (CDCl₃, 400 MHz): δ7.36 (d, J=2.3 Hz, 1H), 7.20 (d, J=2.3 Hz, 1H), 5.17 (s, 2H), 3.61 (s, 3H), 2.53-2.57 (m, 2H), 2.15-2.20 (m, 6H), 2.09 (br.s, 3H), 1.74-1.84 (m, 6H), 1.55-1.64 (m, 2H), 1.37 (s, 12H), 1.24-1.38 (m, 10H), 0.90 (t, J=7.1 Hz, 3H). ¹³C NMR (CDCl₃, 100 MHz): δ 159.5, 140.8, 136.5, 133.5, 130.1, 100.6, 83.2, 57.4, 40.9, 36.7, 35.2, 31.5, 31.4, 29.2, 29.1, 28.9, 28.8, 24.4, 22.3, 13.7.

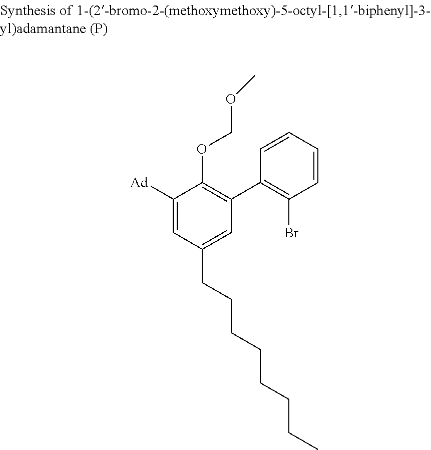

To a solution of 20.5 g (40.3 mmol) of 2-(3-(adamantan-1-yl)-2-(methoxymethoxy)-5-octylphenyl)-4,4,5,5-tetramethyl-1,3,2-dioxaborolane (O) in 100 ml of 1,4-dioxane 13.7 g (48.3 mmol) of 2-bromoiodobenzene, 33.0 g (100 mmol) of cesium carbonate, and 50 ml of water were subsequently added. The mixture obtained was purged with argon for 10 min followed by addition of 2.31 g (2.00 mmol) of Pd(PPh₃)₄. This mixture was stirred for 12 hours at 100° C., then cooled to room temperature, and diluted with 100 ml of water. The obtained mixture was extracted with dichloromethane (3×100 ml), the combined organic extract was dried over Na₂SO₄ and then evaporated to dryness. The residue was purified by flash chromatography on silica gel 60 (40-63 um, eluent: hexane-dichloromethane=10:1, vol.). Yield 14.5 g (67%) of a colorless oil. ¹H NMR (CDCl₃, 400 MHz): δ7.69 (d, J=8.0 Hz, 1H), 7.40 (d, J=7.6 Hz, 1H), 7.36 (t, J=7.6 Hz, 1H), 7.21 (dt, J=8.0, 1.8 Hz, 1H), 7.16 (d, J=1.8 Hz, 1H), 6.91 (d, J=1.8 Hz, 1H), 4.53-4.54 (m, 1H), 4.45-4.46 (m, 1H), 3.22 (s, 3H), 2.58-2.62 (m, 2H), 2.19-2.21 (m, 6H), 2.12 (br.s, 3H), 1.78-1.84 (m, 6H), 1.60-1.69 (m, 2H), 1.25-1.37 (m, 10H), 0.90-0.92 (m, 3H). ¹³C NMR (CDCl₃, 100 MHz): δ151.2, 142.4, 140.9, 136.9, 134.1, 132.5, 131.9, 128.9, 128.2, 126.72, 126.69, 123.8, 98.5, 56.7, 40.9, 36.9, 36.6, 35.3, 31.5, 31.1, 29.08, 29.06, 28.9, 28.8, 22.4, 13.8.

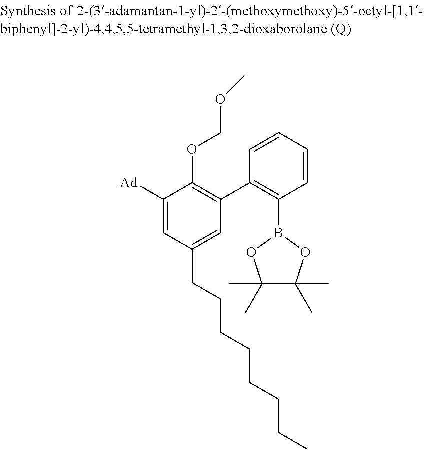

To a solution of 14.5 g (26.9 mmol) of 1-(2′-bromo-2-(methoxymethoxy)-5-octyl-[1,1′-biphenyl]-3-yl)adamantane (P) in 200 ml of dry THF 11.4 ml (28.3 mmol) of 2.5M ⁿBuLi in hexanes was added dropwise for 20 minutes at −80° C. The reaction mixture was stirred for 1 hour at this temperature followed by addition of 8.50 ml (40.4 mmol) of 2-isopropoxy-4,4,5,5-tetramethyl-1,3,2-dioxaborolane. The obtained suspension was stirred for 1 hour at room temperature, then poured into 300 ml of water. The obtained mixture was extracted with dichloromethane (3×100 ml), the combined organic extract was dried over Na₂SO₄ and then evaporated to dryness. Yield 15.8 g (99%) of a colorless glassy solid. ¹H NMR (CDCl₃, 400 MHz): δ7.75 (d, J=7.4 Hz, 1H), 7.42 (dt, J=7.4, 1.4 Hz, 1H), 7.36 (d, J=7.6 Hz, 1H), 7.32 (dt, J=7.3, 1.3 Hz, 1H), 7.06 (d, J=2.1 Hz, 1H), 6.83 (d, J=2.1 Hz, 1H), 4.49-4.50 (m, 1H), 4.40-4.41 (m, 1H), 3.25 (s, 3H), 2.53-2.57 (m, 2H), 2.19-2.22 (m, 6H), 2.11 (br.s, 3H), 1.76-1.84 (m, 6H), 1.58-1.67 (m, 2H), 1.25-1.38 (m, 10H), 1.19 (s, 6H), 1.14 (s, 6H), 0.89 (t, J=6.8 Hz, 3H). ¹³C NMR (CDCl₃, 100 MHz): δ151.6, 146.0, 141.8, 136.7, 136.6, 134.3, 130.3, 129.8, 129.6, 126.04, 125.99, 98.7, 83.4, 67.9, 57.2, 41.5, 37.3, 37.1, 35.7, 31.9, 31.5, 29.51, 29.46, 29.3, 29.2, 25.6, 25.0, 24.3, 22.7, 14.1.

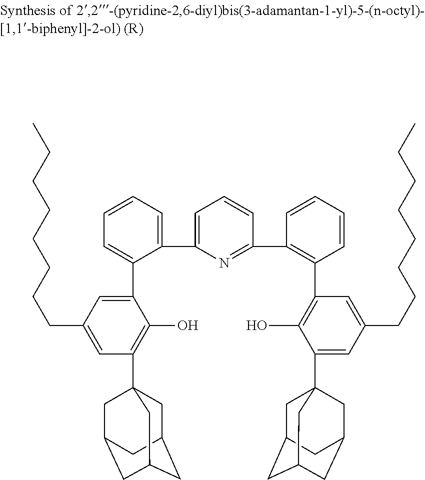 [SMILES: CCCCCCCCc1cc(-c2ccccc2-c2cccc(-c3ccccc3-c3cc(CCCCCCCC)cc(C45CC6CC(CC(C6)C4)C5)c3O)n2)c(O)c(C23CC4CC(CC(C4)C2)C3)c1]

To a solution of 15.8 g (26.9 mmol) of 2-(3′-(adamantan-1-yl)-2′-(methoxymethoxy)-5′-octyl-[1,1′-biphenyl]-2-yl)-4,4,5,5-tetramethyl-1,3,2-dioxaborolane (Q) in 80 ml of 1,4-dioxane 2.93 g (12.4 mmol) of 2,6-dibromopyridine, 26.0 g (80.7 mmol) of cesium carbonate, and 30 ml of water were subsequently added. The mixture obtained was purged with argon for 10 minutes followed by addition of 1.55 g (1.34 mmol) of Pd(PPh₃)₄. This mixture was stirred for 12 hours at 100° C., then cooled to room temperature, and diluted with 50 ml of water. The obtained mixture was extracted with dichloromethane (3×50 ml), the combined organic extract was dried over Na₂SO₄ and then evaporated to dryness. To the resulting oil 100 ml of THF, 100 ml of methanol, and 5 ml of 12N HCl were subsequently added. The reaction mixture was stirred overnight at 60° C. and then poured into 300 ml of water. The obtained mixture was extracted with dichloromethane (3×350 ml), the combined organic extract was washed with 5% NaHCO₃, dried over Na₂SO₄, and then evaporated to dryness. The residue was purified by flash chromatography on silica gel 60 (40-63 um, eluent: hexane-ethyl acetate=10:1, vol.). Yield 4.60 g (41%) of a mixture of two isomers as a colorless glassy solid. ¹H NMR (CDCl₃, 400 MHz): δ7.75 (s, 2H in A), 7.34-7.54 (m, 9H), 7.04 (s, 2H in B), 6.99 (d, J=7.8 Hz, 2H in B), 6.98 (d, J=7.8 Hz, 2H in A), 6.90 (d, J=1.8 Hz, 2H in B), 6.84 (d, J=7.8 Hz, 2H in A), 6.25 (d, J=1.8 Hz, 2H in A), 2.46-2.50 (m, 4H in B), 2.18-2.27 (m, 4H in A), 1.78-1.98 (m, 16H), 1.52-1.71 (m, 18H), 1.11-1.36 (m, 20H), 0.85-0.91 (m, 6H). ¹³C NMR (CDCl₃, 100 MHz, signals attributed to the minor isomer are marked with *): δ 157.94, 157.88*, 150.3, 149.7*, 139.6, 138.8*, 137.9, 137.6, 137.5*, 137.3*, 136.8*, 133.9*, 133.6, 132.3*, 131.6, 130.4, 130.2*, 129.7*, 129.3*, 128.8, 128.5, 128.2*, 127.8*, 127.7, 126.2*, 125.9, 122.3, 122.1*, 40.4, 40.2*, 37.0, 36.9*, 36.7, 36.6*, 35.4*, 35.2, 31.9, 31.6*, 29.51, 29.49*, 29.29*, 29.28, 29.12, 29.02*, 22.7, 14.1.

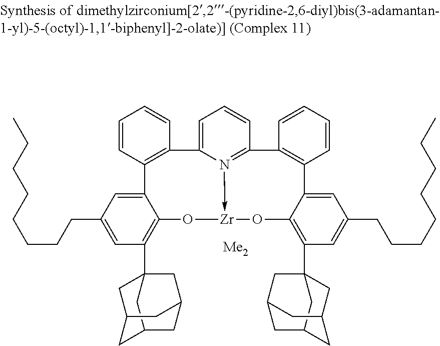

To a suspension of 551 mg (2.37 mmol) of zirconium tetrachloride in 300 ml of dry toluene 3.73 ml (10.7 mmol) of 2.9M MeMgBr in diethyl ether was added in one portion via syringe at 30° C. To the resulting suspension 2.50 g (3.03 mmol) of 2′,2′″-(pyridine-2,6-diyl)bis(3-(adamantan-1-yl)-5-(n-octyl)-[1,1′-biphenyl]-2-ol) (R) was immediately added in one portion. The reaction mixture was stirred for 3 hours at room temperature and then evaporated to near dryness. The solids obtained were extracted with 2×100 ml of toluene, and the combined organic extract was filtered through a thin pad of Celite 503. Next, the filtrate was evaporated to dryness. The residue was triturated with 10 ml of n-hexane, the obtained precipitate was filtered off (G3), washed two times with 10 ml of n-hexane, and then dried in vacuum. Yield 2.22 g (91%) of a beige solid. Anal. Calc. for C₆₇H₈₅ZrNO₂: C, 78.31; H, 8.34; N, 1.36. Found: C, 78.51; H, 8.60; N, 1.27. ¹H NMR (C₆D₆, 400 MHz): δ 7.30 (d, J=2.1 Hz, 2H), 7.23 (dd, J=6.1, 2.1, Hz, 2H), 7.08-7.15 (m, 4H), 7.02 (dd, J=6.1, 2.1 Hz, 2H), 6.85 (d, J=2.1 Hz, 2H), 6.55 (dd, J=8.4, 7.1 Hz, 1H), 6.44 (d, J=8.1 Hz, 2H), 2.61 (t, J=7.6 Hz, 4H), 2.49-2.58 (m, 6H), 2.33-2.44 (m, 6H), 2.18 (br.s, 6H), 1.95-2.03 (m, 6H), 1.79-1.88 (m, 6H), 1.68 (quint, J=7.6 Hz, 4H), 1.22-1.38 (m, 20H), 0.90 (t, J=7.1 Hz, 6H), 0.11 (s, 6H). ¹³C NMR (C₆D₆, 100 MHz): δ 159.5, 158.3, 143.6, 139.5, 138.6, 133.7, 133.2, 132.5, 131.5, 131.2, 128.0, 127.8, 124.5, 42.9, 42.0, 38.3, 37.9, 36.5, 32.7, 32.65, 30.3, 30.1, 30.0, 23.5, 14.7.

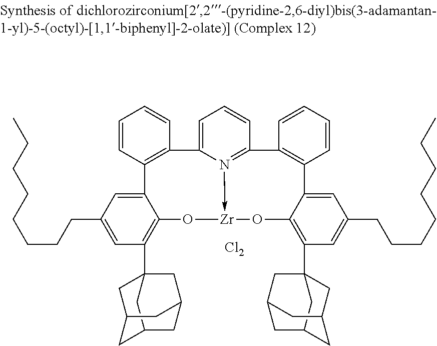

To a stirring solution of dimethylzirconium[2′,2′″-(pyridine-2,6-diyl)bis(3-adamantan-1-yl)-5-(octyl)-[1,1′-biphenyl]-2-olate)] (Complex 11) (0.246 g, 0.239 mmol) in toluene (15 mL), a solution of ethylaluminum dichloride (0.52 mL, 1.01M in hexane, 0.53 mmol, 2.2 equiv.) was added. The reaction was stirred and heated to 60° C. for 3 hours. While cooling, the reaction was concentrated under a stream of nitrogen and then under high vacuum. The residue was stirred in hexane (10 mL) and filtered over a plastic, fritted funnel. The filtered solid was washed further with hexane (5 mL). The solid was collected and concentrated under high vacuum to afford the product as a light grey solid (0.223 g, 87% yield). ¹H NMR (400 MHz, C₆D₆): δ 7.30-7.18 (m, 8H), 7.13-7.07 (m, 2H), 6.88-6.79 (m, 2H), 6.54-6.47 (m, 1H), 6.46-6.32 (m, 2H), 2.61-2.53 (m, 4H), 2.48-2.36 (m, 6H), 2.36-2.24 (m, 6H), 2.24-2.03 (m, 12H), 1.87-1.74 (m, 6H), 1.72-1.58 (m, 4H), 1.47-1.07 (m, 20H), 0.95-0.84 (m, 6H).

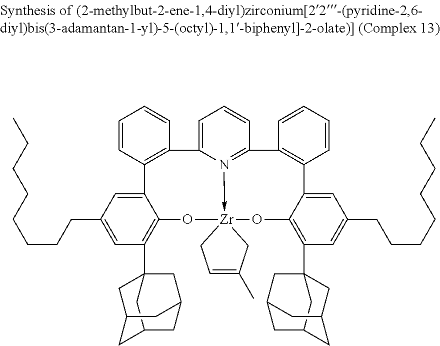

To a stirring suspension of activated magnesium powder (0.015 g, 0.62 mmol, 6.7 equiv.) in diethyl ether (3 mL), a solution of dichlorozirconium[2′,2′″-(pyridine-2,6-diyl)bis(3-adamantan-1-yl)-5-(octyl)-[1,1′-biphenyl]-2-olate)] (Complex 12) (0.098 g, 0.092 mmol) in tetrahydrofuran (3 mL) was added. Then, isoprene (0.07 mL, 0.7 mmol, 7.6 equiv.) was added. The reaction was stirred at room temperature for 2 hours. The reaction was concentrated under a stream of nitrogen and then under high vacuum. The residue was stirred in hexane (15 mL) and then filtered over Celite. The filtrate was concentrated under a stream of nitrogen and then under high vacuum to afford the product as an orange foam (0.058 g, 59% yield). ¹H NMR (400 MHz, C₆D₆): δ 7.38 (dd, 1H, J=7.3, 1.5 Hz), 7.26 (td, 1H, J=7.4, 1.5 Hz), 7.23-7.08 (m, 8H), 6.85 (d, 1H, J=2.3 Hz), 6.80 (d, 1H, J=2.2 Hz), 6.68-6.64 (m, 2H), 6.62-6.58 (m, 1H), 5.51 (t, 1H, J=11.5 Hz), 2.94 (t, 1H, J=10.5 Hz), 2.66-2.50 (m, 4H), 2.27-2.03 (m, 15H), 2.03-1.93 (m, 3H), 1.91-1.72 (m, 15H), 1.72-1.56 (m, 5H), 1.40-1.16 (m, 20H), 1.12-1.07 (m, 1H), 1.02 (t, 1H, J=11.3 Hz), 0.92-0.86 (m, 6H).

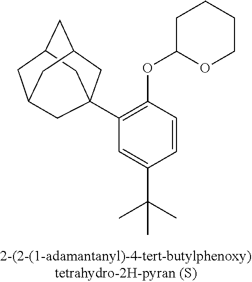 [SMILES: CC(C)(C)c1ccc(OC2CCCCO2)c(C23CC4CC(CC(C4)C2)C3)c1]

To a solution of 2-(1-adamantanyl)-4-(tert-butyl)phenol (38.0 g, 133 mmol) and 3,4-dihydro-2H-pyran (22.5 g, 267 mmol) in dichloromethane (300 mL) at −10° C., p-toluenesulfonic acid monohydrate (203 mg, 1.07 mmol) was added. The reaction mixture was slowly warmed to ambient temperature and stirred, while monitoring the reaction by thin layer chromatography (TLC). Upon full conversion of the starting material (indicated by TLC, approximately 5 minutes at ambient temperature), sodium tert-butoxide (128 mg, 1.33 mmol) was added immediately. The resulting mixture was filtered through a silica gel plug, which was then washed with a 1:1 dichloromethane: hexane solution. The combined filtrate was concentrated to afford the product as a white solid (46.30 g, 94%). ¹H NMR (400 MHz, CDCl₃) δ 7.26 (s, 1H), 7.17-7.08 (m, 2H), 5.46 (s, 1H), 3.92 (t, J=10.8 Hz, 1H), 3.65 (d, J=11.8 Hz, 1H), 2.28-2.00 (m, 10H), 1.99-1.84 (m, 2H), 1.84-1.56 (m, 9H), 1.30 (s, 9H).

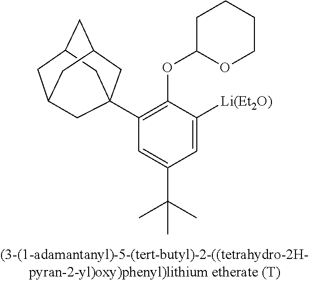

To a solution of 2-(2-(1-adamantanyl)-4-tert-butylphenoxy)tetrahydro-2H-pyran(S) (46.3 g, 126 mmol) in diethyl ether (100 mL) at ambient temperature, n-butyllithium in hexanes (1.6 M, 82.4 mL, 132 mmol) was added. The solution was stirred for 1 hour, then concentrated to dryness. The crude product was slurried into pentane (30 mL) and stirred for 30 minutes. The product was isolated by filtration as a white solid (40.0 g, 71%). ¹H NMR (400 MHz, THF-d₈) δ 7.73 (s, 1H), 6.86 (s, 1H), 6.59 (br, 1H), 3.91 (t, J=11.7 Hz, 1H), 3.55-3.43 (m, 1H), 2.27 (q, J=12.4 Hz, 7H), 2.04 (d, J=18.1 Hz, 5H), 1.80 (td, J=23.8, 13.1 Hz, 9H), 1.32 (s, 9H).

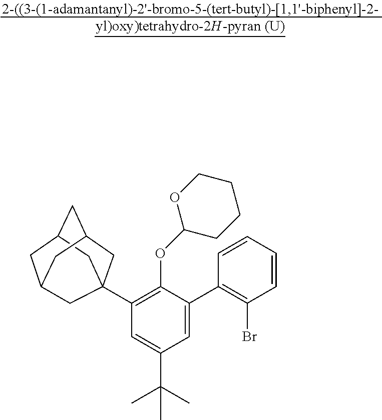 [SMILES: CC(C)(C)c1cc(-c2ccccc2Br)c(OC2CCCCO2)c(C23CC4CC(CC(C4)C2)C3)c1]

(3-(1-an)-5-(tert-butyl)-2-((tetrahydro-2H-pyran-2-yl)oxy)phenyl)lithium etherate (T) (20.1 g, 44.8 mmol) was dissolved in THF (100 mL) and hexanes (100 mL). To the resulting solution at 60° C., 2-bromochlorobenzene (9.44 g, 49.4 mmol) in hexane (50 mL) was added dropwise. The reaction was stirred for 1 hour at 60° C. After allowing the reaction to cool to room temperature, water (100 mL) was added and the resulting mixture was stirred for 10 minutes. After separating the two phases, the aqueous phase was extracted with diethyl ether. The combined organic extracts were dried over MgSO₄, then concentrated under vacuum. The product was then precipitated from a minimal amount of pentane as a white solid, which was collected by filtration. Additional product remaining in the filtrate was purified by flash chromatography on silica gel (30% dichloromethane in hexane). The combined yield was 87% (20.5 g). ¹H NMR (400 MHz, Chloroform-d) δ 7.68 (dd, J=30.1, 8.0 Hz, 1H), 7.53-7.13 (m, 4H), 7.01 (dd, J=59.7, 2.3 Hz, 1H), 4.31 (dd, J=8.1, 2.3 Hz, 1H), 3.79 (dd, J=39.7, 12.0 Hz, 1H), 2.99 (dt, J=97.6, 11.2 Hz, 1H), 2.26 (dt, J=22.7, 12.8 Hz, 6H), 2.11 (s, 3H), 1.86-1.50 (m, 8H), 1.47-1.23 (m, 12H), 1.20-1.01 (m, 1H).

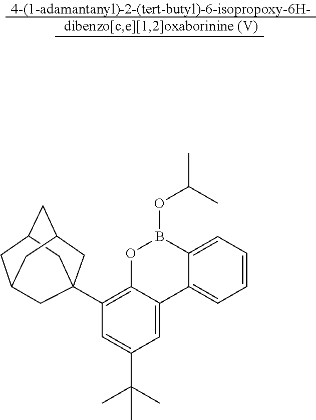 [SMILES: CC(C)OB1Oc2c(cc(C(C)(C)C)cc2C23CC4CC(CC(C4)C2)C3)-c2ccccc21]

To a solution of 2-((3-(1-adamantanyl)-2′-bromo-5-(tert-butyl)-[1,1′-biphenyl]-2-yl)oxy)tetrahydro-2H-pyran (U) (23.5 g, 44.9 mmol) in THF (200 mL) at −78° C., n-butyllithium in hexanes (1.6 M, 33.4 mL, 53.5 mmol) was added dropwise over 20 minutes. The reaction mixture was stirred for 1 hour at −78° C., followed by addition of 2-isopropoxy-4,4,5,5-tetramethyl-1,3,2-dioxaborolane (11.8 g, 63.1 mmol). The resulting suspension was stirred for 1 hour at ambient temperature, then poured into 100 mL of water. The resulting mixture was extracted with hexane (100 mL). After separating the two phases, the aqueous phase was extracted with dichloromethane (2×50 mL). The combined organic extracts were dried over MgSO₄, then evaporated to dryness. To the resulting residue, isopropanol (150 mL) was added, and the resulting solution was refluxed for 16 hours. After allowing the reaction to cool to ambient temperature, the reaction was concentrated and cooled to −20° C. for 1 hour, to afford the product as a white solid (16.6 g, 80%), which was isolated by filtration. ¹H NMR (400 MHz, CDCl₃) δ 8.17 (d, J=8.2 Hz, 1H), 8.09-8.02 (m, 2H), 7.65 (t, J=8.0 Hz, 1H), 7.45-7.40 (m, 2H), 5.24 (p, J=6.1 Hz, 1H), 2.30 (br, 6H), 2.16 (br, 3H), 1.84 (br, 6H), 1.43-1.39 (m, 15H).

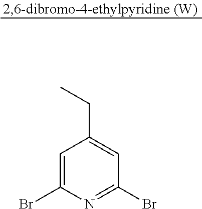

Solutions of 2,6-dibromo-4-methylpyridine (3.00 g, 12.0 mmol) in THF (5 mL) and freshly prepared LDA (1.28 g, 12.0 mmol) in THF (3 mL) were separately cooled in a cooling bath under −55° C. for 10 minutes. The chilled LDA solution was then slowly added to the solution of 2,6-dibromo-4-methylpyridine, which was stirred at −55° C. for 1 hour. Iodomethane (1.70 g, 12.0 mmol) was then added to the reaction mixture, which was stirred at ambient temperature for 2 hours. The reaction was then quenched with water and diluted with hexane. After separating the two phases, the aqueous phase was extracted with dichloromethane (2×10 mL). The combined organic extracts were dried over MgSO₄, then concentrated to dryness. Purification by flash chromatography on silica gel (30% dichloromethane in hexane) afforded the product in 67% yield (2.11 g). ¹H NMR (400 MHz, CDCl₃) δ 7.29 (s, 1H), 2.61 (q, J=7.6 Hz, 2H), 1.24 (td, J=7.7, 1.2 Hz, 3H.

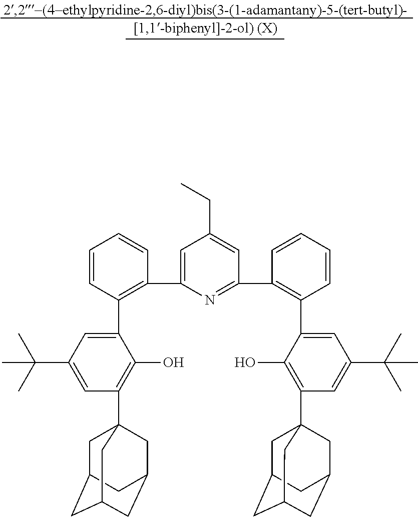 [SMILES: CCc1cc(-c2ccccc2-c2cc(C(C)(C)C)cc(C34CC5CC(CC(C5)C3)C4)c2O)nc(-c2ccccc2-c2cc(C(C)(C)C)cc(C34CC5CC(CC(C5)C3)C4)c2O)c1]

To a solution of 4-(1-adamantanyl)-2-(tert-butyl)-6-isopropoxy-6H-dibenzo[c,e][1,2] oxaborinine (V) (2.10 g, 4.91 mmol) in 1,4-dioxane (12 mL), 2,6-bromo-4-ethylpyridine (W) (0.65 g, 2.45 mmol), potassium carbonate (2.03 g, 14.7 mmol), Buchwald RuPhos Palladacycle Gen I precatalyst (Strem, CAS 1028206-60-1, 27.0 mg, 0.04 mmol,), and water (6 mL) were added. This mixture was stirred for 16 hours at 100° C., then cooled to ambient temperature and diluted with water (30 mL). The resulting mixture was diluted with hexane (20 mL). After separating the two phases, the aqueous phase was extracted with dichloromethane (2×50 mL). The combined organic extracts were dried over MgSO₄, then concentrated to dryness. The product was purified by the flash chromatography on silica gel (impurities eluted with 15% dichloromethane in hexane, followed by 25% dichloromethane+2% acetone in hexane to elute the product). The product was isolated (1.59 g, 79%) as a mixture of two isomers. ¹H NMR (400 MHz, CDCl₃) δ 8.29 (s, 2H in A), 7.54-7.32 (m, 8H), 7.07-7.01 (m, 2H), 6.88 (s, 2H in B), 6.77 (s, 2H in B), 6.72 (s, 2H in A), 6.63 (s, 2H in B), 6.50 (s, 2H in A), 2.33 (q, J=7.5 Hz, 2H), 2.06-1.77 (m, 18H), 1.62 (br, 12H), 1.13 (s, 18H in B), 0.95 (s, 18H in A), 0.88-0.79 (m, 3H).

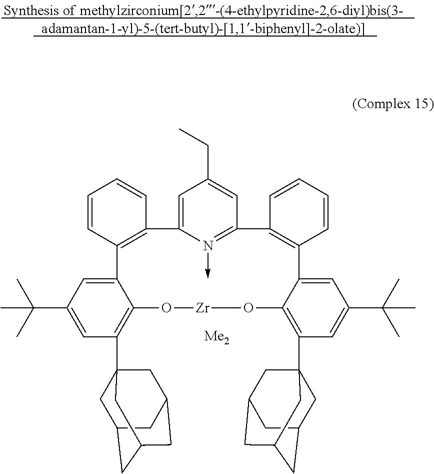

To a precooled, stirring suspension of zirconium chloride (0.142 g, 0.609 mmol, 1 equiv.) in toluene (2 mL), methylmagnesium bromide (0.82 mL, 3.0M in diethyl ether, 2.5 mmol, 4.0 equiv.) was added. Then, a precooled solution of 2′,2′″-(4-ethylpyridine-2,6-diyl)bis(3-adamantan-1-yl)-5-(tert-butyl)-[1,1′-biphenyl]-2-ol) (X) (0.502 g, 0.609 mmol) in toluene (3 mL) was added dropwise. The reaction was stirred at room temperature for 3 hours. The reaction was concentrated under a stream of nitrogen and then under high vacuum. The residue was stirred in hexane (20 mL) and heated to reflux. The mixture was filtered over Celite while hot. The filtered solid was extracted further with refluxing hexane (2× 20 mL). The combined hexane filtrate was concentrated under a stream of nitrogen and then under high vacuum to afford the product as a tan-grey solid, containing hexane (0.18 equiv.) and toluene (0.96 equiv.) (0.424 g, 66% yield). ¹H NMR (C₆D₆, 400 MHz): δ 7.54 (d, 2H, J=2.6 Hz), 7.24-7.20 (m, 2H), 7.14-7.00 (m, 8H), 6.39 (s, 2H), 2.65-2.54 (m, 6H), 2.49-2.40 (m, 6H), 2.24-2.15 (m, 6H), 2.06-1.96 (m, 6H), 1.89-1.80 (m, 6H), 1.68 (q, 2H, J=7.6 Hz), 1.33 (s, 18H), 0.48 (t, 3H, J=7.6 Hz), 0.14 (s, 6H).

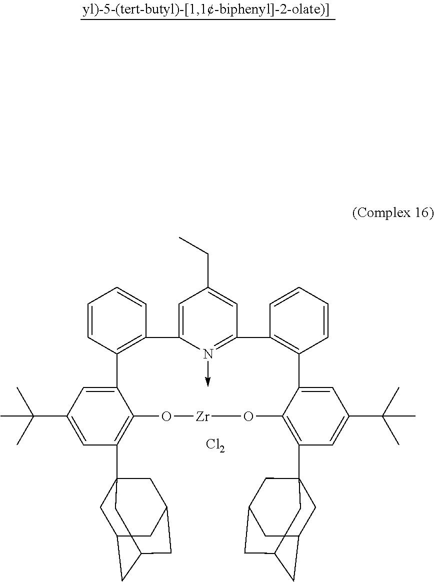

To a stirring solution of dimethylzirconium[2′,2′″-(4-ethylpyridine-2,6-diyl)bis(3-adamantan-1-yl)-5-(tert-butyl)-[1,1′-biphenyl]-2-olate)] (Complex 15) (0.180 g, 0.191 mmol) in toluene (5 mL), ethylaluminum dichloride (0.42 mL, 1.01M in hexane, 0.42 mmol, 2.2 equiv.) was added. The reaction was stirred and heated to 60° C. for 2 hours. The reaction was concentrated under a stream of nitrogen while cooling. The residue was stirred in pentane (10 mL) and filtered. The filtered solid was washed further with additional pentane (5 mL). The filtered solid was collected and concentrated under high vacuum to afford the product as a grey solid (0.147 g, 78% yield). ¹H NMR (400 MHz, C₆D₆): δ 7.51 (d, 2H, J=2.6 Hz), 7.27-7.17 (m, 7H), 7.15-6.99 (m, 3H), 6.39 (s, 2H), 2.51-2.42 (m, 6H), 2.38-2.29 (m, 6H), 2.23-2.15 (m, 6H), 2.13-2.05 (m, 6H), 1.88-1.78 (m, 6H), 1.64 (q, 2H, J=7.5 Hz), 1.29 (s, 18H), 0.44 (t, 3H, J=7.5 Hz).

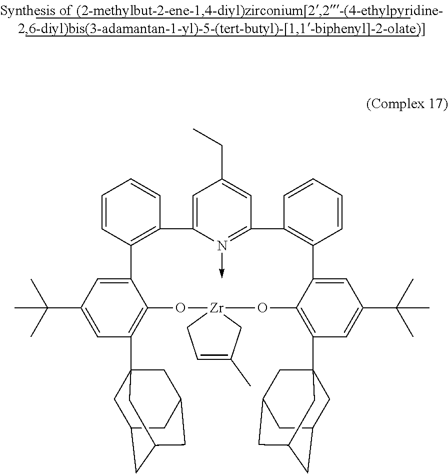

To a stirring suspension of activated magnesium powder (0.018 g, 0.74 mmol, 5 equiv) in diethyl ether (7 mL), a solution of dichlorozirconium[2′,2′″-(4-ethylpyridine-2,6-diyl)bis(3-adamantan-1-yl)-5-(tert-butyl)-[1,1′-biphenyl]-2-olate)] (Complex 16) (0.147 g, 0.149 mmol) in tetrahydrofuran (3 mL) was added. Then, isoprene (0.10 mL, 1.0 mmol, 6.7 equiv.) was added. The reaction was stirred at room temperature for 2 hours. Then, additional isoprene (0.10 mL, 1.0 mmol, 6.7 equiv.) was added. The reaction was stirred at room temperature for an additional 2 hours. Then, additional isoprene (0.10 mL, 1.0 mmol, 6.7 equiv.) was added. The reaction was stirred at room temperature for 3 days. The reaction was concentrated under a stream of nitrogen and then under high vacuum. The residue was stirred in hexane (15 mL) and then filtered over Celite. The filtrate was concentrated under a stream of nitrogen and then under high vacuum to afford the product as an orange solid (0.027 g, 18% yield). ¹H NMR (400 MHz, C₆D₆): δ 7.46 (d, 2H, J=7.6 Hz), 7.40 (s, 1H), 7.30 (s, 1H), 7.31-7.25 (m, 2H), 7.25-7.20 (m, 4H), 7.07-7.00 (m, 2H), 6.61 (s, 1H), 6.53 (s, 1H), 5.57-5.47 (m, 1H), 2.96 (t, 1H, J=10.4 Hz), 2.63 (d, 1H, J=8.6 Hz), 2.30-2.22 (m, 3H), 2.22-2.16 (m, 3H), 2.16-2.09 (m, 9H), 2.05-1.98 (m, 3H), 1.91-1.76 (m, 17H), 1.32 (s, 9H), 1.26 (s, 9H), 1.06 (d, 1H, J=12.2 Hz), 0.88 (t, 1H, J=6.5 Hz), 0.56 (t, 3H, J=7.5 Hz).

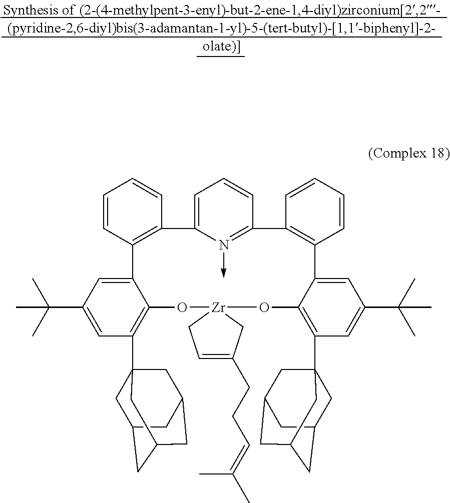

To a stirring suspension of activated magnesium powder (7 mg, 0.29 mmol, 2.5 equiv.) in diethyl ether (3 mL), a solution of dichlorozirconium[2′,2′″-(pyridine-2,6-diyl)bis(3-adamantan-1-yl)-5-(tert-butyl)-[1,1′-biphenyl]-2-olate)] (Complex 1) (0.111 g, 0.116 mmol) in tetrahydrofuran (10 mL) was added. Then, myrcene (0.02 mL, 0.12 mmol, 1 equiv.) was added, at which point the reaction changed to a light yellow-orange color. The reaction was stirred at room temperature for 4 days. The reaction was concentrated under a stream of nitrogen and then under high vacuum. The residue was extracted with hexane and then filtered over Celite. The filtrate was placed in the freezer for 1 week, after which time solids precipitated. The mixture was filtered over Celite, and the filtrate was collected and concentrated under a stream of nitrogen and then under high vacuum to afford the product as a brown, glassy solid (0.087 g, 73% yield). ¹H NMR (400 MHz, C₆D₆): δ 7.42 (d, 1H, J=2.7 Hz), 7.39-7.32 (m, 2H), 7.29-7.21 (m, 3H), 7.19-7.16 (m, 1H), 7.13-7.06 (m, 3H), 7.05 (d, 1H, J=2.6 Hz), 7.01 (d, 1H, J=2.5 Hz), 6.63-6.50 (m, 3H), 5.59 (t, 1H, J=11.6 Hz), 5.41-5.34 (m, 1H), 2.94 (t, 1H, J=10.6 Hz), 2.71 (d, 1H, J=9.1 Hz), 2.48-2.37 (m, 2H), 2.29-2.22 (m, 3H), 2.22-2.16 (m, 3H), 2.15-2.08 (m, 9H), 2.04-1.96 (m, 3H), 1.95-1.74 (m, 14H), 1.61 (d, 3H, J=1.4 Hz), 1.53 (d, 3H, J=1.2 Hz), 1.33 (s, 9H), 1.26 (s, 9H), 1.10-0.98 (m, 2H).

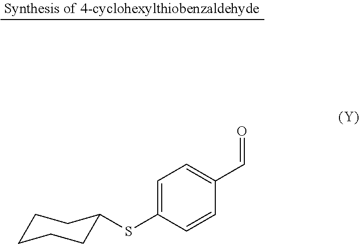 [SMILES: O=Cc1ccc(SC2CCCCC2)cc1]

To a stirring suspension of potassium carbonate (3.90 g, 28.2 mmol, 1.01 equiv.) in dimethyl sulfoxide (12 mL), cyclohexanethiol (3.5 mL, 29 mmol, 1.0 equiv.) was added. Then, 4-fluorobenzaldehyde (3.0 mL, 28 mmol) was added. The reaction was stirred and heated to 95° C. for 4 hours. The reaction was allowed to cool to room temperature. Then, the reaction was poured onto water (100 mL), washing residue of the reaction into the water with dichloromethane (75 mL). The resulting mixture was poured into a separatory funnel, and the organic phase was extracted. The aqueous phase was extracted further with dichloromethane (2×75 mL). The combined organic extracts were washed with brine (100 mL), dried over anhydrous magnesium sulfate, and filtered. The filtrate was concentrated in vacuo to afford the product as an orange-yellow liquid, containing residual dichloromethane (0.16 equiv.) and dimethyl sulfoxide (0.02 equiv.) (6.20 g, 94% yield). ¹H NMR (400 MHz, C₆D₆): δ 9.62 (s, 1H), 7.44-7.39 (m, 2H), 7.11-7.05 (m, 2H), 2.98 (tt, 1H, J=10.5, 3.7 Hz), 1.89-1.77 (m, 2H), 1.57-1.46 (m, 2H), 1.41-1.20 (m, 3H), 1.13-0.94 (m, 3H).

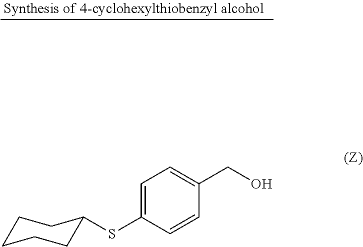 [SMILES: OCc1ccc(SC2CCCCC2)cc1]

To a stirring solution of 4-cyclohexylthiobenzaldehyde (Y) (6.20 g, 26.3 mmol) in ethanol (75 mL) cooled in an ice bath, sodium borohydride (1.10 g, 29.0 mmol, 1.10 equiv.) was added in small portions. The reaction was stirred at room temperature for 5 hours. The reaction was poured onto a mixture of pentane (100 mL) and hydrochloric acid (100 mL, 4M, aqueous). The mixture was poured into a separatory funnel. The organic layer was collected, and the aqueous phase was further extracted with additional pentane (2×50 mL). The combined pentane extracts were washed with brine (100 mL), dried over anhydrous magnesium sulfate, and filtered. The filtrate was concentrated in vacuo to give a pale yellow oil. The oil was purified by silica gel column chromatography to afford the product as a clear, colorless oil (3.94 g, 67% yield). ¹H NMR (400 MHz, C₆D₆): δ 7.41 (d, 2H, J=8.2 Hz), 7.05 (d, 2H, J=8.5 Hz), 4.24 (d, 2H, J=5.5 Hz), 2.98 (tt, 1H, J=10.6, 3.7 Hz), 2.00-1.89 (m, 2H), 1.63-1.52 (m, 2H), 1.44-1.29 (m, 3H), 1.15-0.98 (m, 3H).

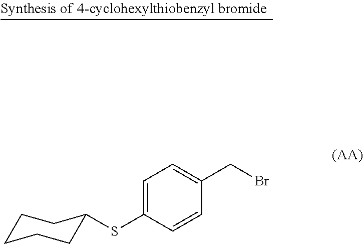 [SMILES: BrCc1ccc(SC2CCCCC2)cc1]

To a stirring solution of 4-cyclohexylthiobenzyl alcohol (Z) (3.94 g, 17.7 mmol) in diethyl ether cooled in an ice-water bath, phosphorus tribromide (1.9 mL, 20 mmol, 1.1 equiv.) was added. The reaction was stirred and allowed to warm to room temperature for 4 hours. The reaction was then poured onto cold water (200 mL). Then, pentane (100 mL) was added to the water, and the mixture was poured into a separatory funnel. The organic layer was collected, and the aqueous phase was extracted further with additional pentane (100 mL). The combined pentane extracts were washed with water (100 mL), dried over anhydrous magnesium sulfate, and filtered. The filtrate was concentrated in vacuo to afford the product (3.73 g, 73% yield). ¹H NMR (400 MHz, C₆D₆): δ 7.19 (d, 2H, J=8.3 Hz), 6.91 (d, 2H, J=8.3 Hz), 3.96 (s, 2H), 2.95 (tt, 1H, J=10.6, 3.7 Hz), 1.95-1.79 (m, 2H), 1.63-1.46 (m, 2H), 1.43-1.22 (m, 3H), 1.15-0.96 (m, 3H).

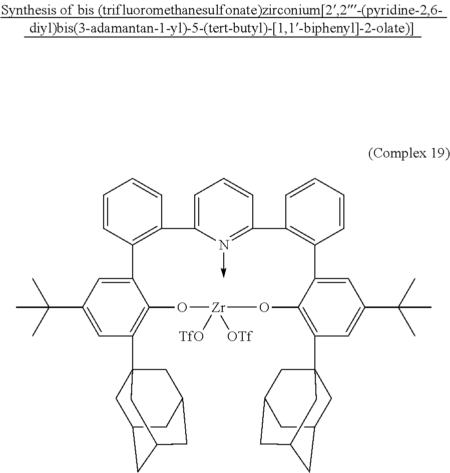

To a stirring suspension of dichlorozirconium[2′,2′″-(pyridine-2,6-diyl)bis(3-adamantan-1-yl)-5-(tert-butyl)-[1,1′-biphenyl]-2-olate)] (Complex 1) (0.572 g, 0.598 mmol) in toluene (5 mL) heated to 110° C., a solution of silver (I) trifluoromethanesulfonate (0.394 g, 1.53 mmol, 2.56 equiv.) in toluene (10 mL) was added. The reaction was stirred and heated to 110° C. for 2 hours. The reaction was filtered over Celite, with the filtered solid being further extracted with diethyl ether. The combined filtrate was concentrated under a stream of nitrogen and then under high vacuum to afford the product as an off-white solid, containing toluene (2 equiv.) (0.743 g, 90% yield). ¹H NMR (400 MHz, C₆D₆): δ 7.56-7.49 (m, 4H), 7.43 (d, 2H, J=7.7 Hz), 7.32 (td, 2H, J=7.6, 1.3 Hz), 7.14-6.99 (m, 4H), 6.41-6.36 (m, 1H), 6.33-6.29 (m, 2H), 2.30-2.22 (m, 12H), 2.21-2.13 (m, 6H), 2.02-1.93 (m, 6H), 1.90-1.81 (m, 6H), 1.21 (s, 18H).

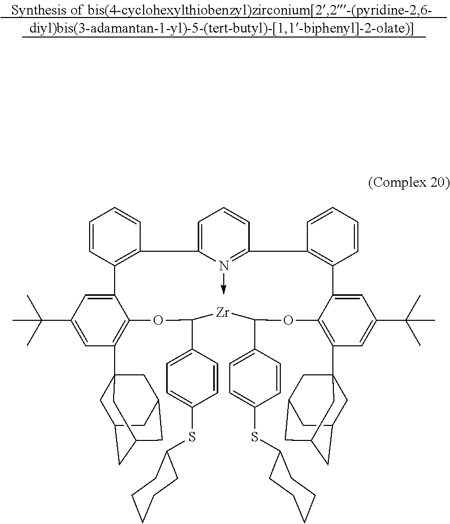

To a stirring suspension of activated magnesium powder (0.086 g, 3.5 mmol, 2.1 equiv.) in diethyl ether (15 mL), a solution of 4-cyclohexylthiobenzyl bromide (AA) (0.491 g, 1.72 mmol) in diethyl ether (5 mL) was added dropwise. The reaction was stirred at room temperature for 4 hours. The reaction was filtered over Celite on a glass wool plug, and the filtrate was titrated against iodine to reveal a concentration of 79.6 mM. Then, to a stirring solution of bis(trifluoromethanesulfonate)zirconium[2′,2′″-(pyridine-2,6-diyl)bis(3-adamantan-1-yl)-5-(tert-butyl)-[1,1′-biphenyl]-2-olate)] (Complex 19) (0.200 g, 0.169 mmol) in toluene (10 mL), a solution of the prepared 4-cyclohexylthiobenzylmagnesium bromide (4.3 mL, 79.6 mM, 0.342 mmol, 2 equiv.). The reaction was stirred and heated to 70° C. for 20 hours. Then, additional 4-cyclohexylthiobenzylmagnesium bromide (2.0 mL, 79.6 mM, 0.16 mmol, 0.94 equiv.) was added. The reaction was stirred and heated at 70° C. for 2 hours. The reaction was then heated further to reflux for an additional 4 hours. The reaction was filtered over Celite, extracting from the reaction further with additional toluene (2 mL). The combined toluene filtrate was concentrated under a stream of nitrogen and then under high vacuum. The residue was mixed with hexane (15 mL) and heated to gentle reflux. The mixture was removed from heating, and, while still hot, the supernatant was removed. The remaining solid was concentrated under high vacuum to afford the product as an off-white solid (0.135 g, 61% yield). ¹H NMR (400 MHz, C₆D₆): δ 7.61 (d, 2H, J=2.6 Hz), 7.42 (dd, 2H, J=7.5, 1.5 Hz), 7.33 (d, 4H, J=8.2 Hz), 7.11 (d, 2H, J=2.5 Hz), 7.04-6.92 (m, 6H), 6.78 (d, 4H, J=8.1 Hz), 6.51-6.44 (m, 1H), 6.37-6.31 (m, 2H), 2.90 (tt, 2H, J=10.7, 3.7 Hz), 2.54-2.44 (m, 6H), 2.41 (d, 2H, J=11.1 Hz), 2.39-2.31 (m, 6H), 2.24-2.14 (m, 6H), 2.06-1.92 (m, 10H), 1.88-1.78 (m, 6H), 1.67-1.56 (m, 4H), 1.45-1.18 (m, 24H), 1.18-0.99 (m, 6H), 0.12 (d, 2H, J=10.9 Hz).

### Solubility of Complexes

General procedure: A measured amount of complex was added to a tared vial, followed by a stir bar. Dry isohexanes were added in small portions and the resulting mixture was stirred after each portion of isohexanes. If a clear solution had formed then the solubility was reported as a range, the lower bound of solubility calculated using the total solvent volume added to achieve a homogenous solution and the upper bound of solubility calculated using the total solvent volume measured prior to achieving a homogenous solution. If the mixture remained heterogeneous (visible solids or murky), the upper bound of solubility was and calculated using the total solvent volume added. If deviations to this procedure were utilized, the methodology is reported below. Toluene content is the equivalence of toluene associated with a molecule of complex.

Formulas used to calculate solubility are listed below. Cocrystallized solvent present in the complex is included in the mass and formula weight of the complexes. The density of isohexane used in the calculations was 0.672 g/ml. Solubility data on Complex 14 was obtained from copending U.S. Patent Application 63/338,169. Complex 14 cocrystallized with 1.4 equivalents of methylcyclohexane.

Solubility (in mM)=[10⁶]*[(grams of complex)/(formula wt. of complex in g/mol)]/[(total volume of solvent in mL)].

Solubility (in wt %)=[100]*[(grams of complex)/[(grams of complex)+(total volume of solvent in mL)*(density of solvent in g/mL)]].

TABLE 1
Solubility of complexes in isohexane

| | Solubility | Solubility | Toluene | Hexane | Solubility |
|---|---|---|---|---|---|
| | at RT | at 50° C. | Content | Content | at RT |
| Complex | (mM) | (mM) | (equiv.) | (equiv.) | (wt %) |
| 2 | <3.1 | ≥3.1 | 0 | 0.64 | <0.45 |
| 3 | <3.2 | ≥3.2 | 0 | 0 | <0.45 |
| 5 - | 1.7-2.2 | N/A | 0.2 | 0 | 0.24-0.31 |
| comparative | | | | | |
| to 7 | | | | | |
| 5a - | <1.9 | >1.9** | 0 | 0.61 | <0.27 |
| comparative | | | | | |
| to 7 | | | | | |
| 7 | 2.1-2.2 | N/A | 0 | 0.42 | 0.33-0.35 |
| 8r* - | <3.0 | <3.0 | 0 | 0.52 | <0.48 |
| comparative | | | | | |
| to 10 | | | | | |
| 10 | <3.0 | <3.0 | 0.4 | 0 | <0.49 |
| 11 - | <1.1 | N/A | 0.1 | 0 | <0.12 |
| comparative | | | | | |
| to 13 | | | | | |
| 13 | 69-138 | N/A | 0 | 0 | 9.9-17.9 |
| 14 - | 0.50 | N/A | 0 | 0 | 0.081 |
| comparative | | | | | |
| to 2 & 3 | | | | | |

*Complex 8 recrystallized;
RT = ambient room temperature;
**solubility attained by 30° C.

Complex 2. To a tared vial, (2-buten-1,4-diyl)zirconium[2′,2′″-(pyridine-2,6-diyl)bis(3-adamantan-1-yl)-5-(tert-butyl)-[1,1′-biphenyl]-2-olate)] (Complex 2) (0.0304 g, contains 0.64 equiv. hexane, 30.6 μmol) was added. A stir bar and dry isohexanes (10.0 mL) were added. The vial was sealed, and the mixture was stirred at room temperature for 30 minutes. Then, the contents of the vial were heated to 40° C., and the contents were stirred at this temperature for 30 minutes. Then, the contents of the vial were heated to 50° C. The contents of the vial dissolved completely. Then, the contents of the vial were allowed to cool to room temperature and stir overnight. By the next morning, the contents of the vial remained in solution.

Complex 3. To a tared vial, (2-methyl-2-buten-1,4-diyl)zirconium[2′,2′″-(pyridine-2,6-diyl)bis(3-adamantan-1-yl)-5-(tert-butyl)-[1,1′-biphenyl]-2-olate)] (Complex 3) (0.0152 g, 15.9 μmol) was added. A stir bar and dry isohexanes (5.0 mL) were added. The vial was sealed, and the mixture was stirred at room temperature overnight. Then, the contents of the vial were heated to 30° C. for 20 minutes. Then, the contents of the vial were heated in 5° C. increments for 20 minutes until all solids dissolved. All solids dissolved at 50° C. The solution was allowed to cool to room temperature and stir overnight. By the next morning, the contents of the vial remained in solution.

Complex 5. To a tared vial, dimethylzirconium[2′,2′″-(pyridine-2,6-diyl)bis(3-adamantan-1-yl)-5-(tert-pentyl)-[1,1′-biphenyl]-2-olate)] (Complex 5) (0.0167 g, 17.4 μmol, containing 0.2 equiv. toluene) was added. A stir bar and dry isohexanes (5.0 mL) were added. The vial was sealed, and the mixture was stirred at room temperature. Isohexanes was added in portions to the mixture. The complex was not fully dissolved at 8.0 mL isohexanes addition, but the complex dissolved upon stirring after a total addition of 10.0 mL isohexanes.

Complex 5a. Separately, a portion of complex 5 was extracted with n-hexane (15.0 mL) and filtered over Celite. The filtrate was concentrated in vacuo to give a fraction of complex 5 without toluene but containing n-hexane (0.61 equiv.). This sample (0.0148 g, 14.9 μmol) was added to a tared vial, and isohexanes was added in 0.5 mL increments, with stirring, until 2.0 mL isohexanes was added in total. This suspension was stirred for 2 hours. Then isohexanes was added in 0.5 mL increments until 5.0 mL. Then isohexanes was added in 0.5 mL increments until 8.0 mL. The resulting suspension was then heated to 30° C., at which point the complex completely dissolved. The mixture was then allowed to cool to room temperature, at which point solid precipitated.

Complex 7. To a tared vial, (2-methylbut-2-ene-1,4-diyl)zirconium[2′,2′″-(pyridine-2,6-diyl)bis(3-adamantan-1-yl)-5-(tert-pentyl)-[1,1′-biphenyl]-2-olate)] (0.0160 g, 15.7 μmol) was added. Isohexanes was added in 0.5 mL portions to 1.0 mL total. The resulting suspension was stirred for 3.5 hours. Then, isohexanes was added in portions up to a total of 5.0 mL, and the resulting suspension was stirred overnight. Isohexanes was added in 0.5 mL portions up to 6.0 mL, and the suspension was stirred for 50 minutes. Isohexanes was added to 6.5 mL total, and the suspension was stirred for 25 minutes. Isohexanes was added to 7.0 mL total, and the suspension was stirred for 15 minutes. Isohexanes was added to 7.5 mL total, at which point all solids dissolved.

Complex 8. Dimethylzirconium[2′,2′″-(pyridine-2,6-diyl)bis(3-adamantan-1-yl)-5-(tert-butyldimethylsilyl)-[1,1′-biphenyl]-2-olate)] (Complex 8) was mixed with hexane. The mixture was filtered through Celite and glass wool. The filtrate was allowed to stand at room temperature overnight to facilitate precipitation. Then, the resulting mixture was again filtered through Celite and glass wool. The filtrate was cooled to −35° C. for 3 days, resulting in the precipitation of white clusters. The clusters were isolated and concentrated under high vacuum for 5 hours to remove any residual toluene. The resulting solid was weighed into a tared vial (0.0129 g, 0.52 equiv. hexane, 12.0 μmol). A stir bar was added to the vial. While stirring, isohexanes was added in 0.5 mL increments (with 15 minutes of stirring between additions) until 2.5 mL was reached, at which point much of the material had dissolved. The mixture was stirred overnight. By the next morning, the mixture had become white and cloudy. Therefore, additional isohexanes was added in 0.5 mL increments until 4.0 mL total, at which point the mixture remained cloudy white. The vial, sealed, was heated to 70° C., at which point the mixture remained cloudy white.

Complex 10. To a tared vial, (2-methylbut-2-ene-1,4-diyl)zirconium[2′,2′″-(pyridine-2,6-diyl)bis(3-adamantan-1-yl)-5-(tert-butyldimethylsilyl)-[1,1′-biphenyl]-2-olate)] (Complex 10) (0.0160 g, contains 0.4 equiv. toluene, 15.0 μmol) and a stir bar were added. While stirring, isohexanes was added in 0.5 mL increments (with at least 15 minutes of stirring between additions) until 5.0 mL was reached. The mixture, a cloudy tan-brown suspension, was then heated to 30° C. The mixture was then heated by an additional 5° C. (allowing the mixture to stir for at least 15 minutes for each temperature changed) until the mixture reached 50° C., at which point the mixture remained a cloudy tan-brown suspension.

Complex 11. To a tared vial, dimethylzirconium[2′,2′″-(pyridine-2,6-diyl)bis(3-adamantan-1-yl)-5-(octyl)-[1,1′-biphenyl]-2-olate)] (0.0156 g, 15.2 μmol, containing 0.1 equiv. toluene) was added. Then, with stirring, isohexanes was added up to 5.0 mL. Isohexanes was added in portions until 14.0 mL, at which point the mixture remained a suspension.

Complex 13. To a tared vial, (2-methyl-2-buten-1,4-diyl)zirconium[2′,2′″-(pyridine-2,6-diyl)bis(3-adamantan-1-yl)-5-(octyl)-[1,1′-biphenyl]-2-olate)] (Complex 13) (0.0147 g, 13.8 μmol) was added. Then, dry isohexanes (0.1 mL) was added. Then, additional dry isohexanes (0.1 mL) was added. The complex completely dissolved.

### Polymerization Examples

Solutions of the pre-catalysts were made using toluene (ExxonMobil Chemical-anhydrous, stored under N₂) (98%) or isohexane (ExxonMobil Chemical-polymerization grade, and purified as described below). Pre-catalyst solutions were typically 0.25 mmol/L.

Solvents, polymerization grade toluene and/or isohexanes were supplied by ExxonMobil Chemical Co. and are purified by passing through a series of columns: two 500 cc Oxyclear cylinders in series from Labclear (Oakland, Calif.), followed by two 500 cc columns in series packed with dried 3 Å mole sieves (8-12 mesh; Aldrich Chemical Company), and two 500 cc columns in series packed with dried 5 Å mole sieves (8-12 mesh; Aldrich Chemical Company).

Polymerization grade propylene (C₃) was used and further purified by passing it through a series of columns: 2250 cc Oxiclear cylinder from Labclear followed by a 2250 cc column packed with 3 Å mole sieves (8-12 mesh; Aldrich Chemical Company), then two 500 cc columns in series packed with 5 Å mole sieves (8-12 mesh; Aldrich Chemical Company), then a 500 cc column packed with Selexsorb CD (BASF), and finally a 500 cc column packed with Selexsorb COS (BASF).

Activation of the pre-catalysts was either by dimethylanilinium tetrakisperfluorophenylborate (Boulder Scientific or Albemarle Corp; Act ID=A) or (hydrogenated tallow alkyl)methylammonium tetrakis(pentafluorophenyl)borate supplied as a 10 wt % solution in methylcyclohexane (Boulder Scientific; Act ID=B). Activators were typically used as a 0.25 mmol/L solution in toluene or isohexane.

Tri-n-octylaluminum (TnOAl or TNOA, Neat, AkzoNobel) was also used as a scavenger prior to introduction of the activator and pre-catalyst into the reactor. TNOA was typically used as a 5 mmol/L solution in toluene or isohexane.

### Reactor Description and Preparation:

Polymerizations were conducted in an inert atmosphere (N2) drybox using autoclaves equipped with an external heater for temperature control, glass inserts (internal volume of reactor of 22.5 mL), septum inlets, regulated supply of nitrogen and propylene, and equipped with disposable PEEK mechanical stirrers (800 RPM). The autoclaves were prepared by purging with dry nitrogen at 110° C. or 115° C. for 5 hours and then at 25° C. for 5 hours.

### Propylene Polymerization (PP):

The reactor was prepared as described above, then heated to 40° C., and then purged with propylene gas at atmospheric pressure. Toluene or isohexanes, liquid propylene (1.0 mL) and scavenger (TNOA, 0.5 μmol) were added via syringe. The reactor was then brought to process temperature (70° C. or 100° C.) while stirring at 800 RPM. The activator solution, followed by the pre-catalyst solution, were injected via syringe to the reactor at process conditions. Reactor temperature was monitored and typically maintained within +/−1° C. Polymerizations were halted by addition of approximately 50 psi compressed dry air gas mixture to the autoclaves for approximately 30 seconds. The polymerizations were quenched based on a predetermined pressure loss (maximum quench value) or for a maximum of 30 minutes. The reactors were cooled and vented. The polymers were isolated after the solvent was removed in-vacuo. The actual quench time(s) is reported as quench time(s). Yields reported include total weight of polymer and residual catalyst. Catalyst activity is reported as grams of polymer per mmol transition metal compound per hour of reaction time (g/mmol·hr). Propylene homopolymerization examples are reported in Table 2 with additional characterization in Table 3.

### Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn) and z average molecular weight (Mz)) and molecular weight distribution (MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Table 2 under the headings Mn, Mw, Mz and PDI as defined above.

Differential Scanning calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Tables 2 under the heading, Tm (° C.).

¹³C NMR spectroscopy was used to characterize some polypropylene polymer samples produced in experiments collected in Table 2. This data is collected in Table 3. Unless otherwise indicated the polymer samples for ¹³C NMR spectroscopy were dissolved in d₂-1,1,2,2-tetrachloroethane and the samples were recorded at 125° C. using a NMR spectrometer with a ¹³C NMR frequency of 150 MHz. Polymer resonance peaks are referenced to mmmm=21.8 ppm. Calculations involved in the characterization of polymers by NMR follow the work of F. A. Bovey in “Polymer Conformation and Configuration” Academic Press, New York 1969 and J. Randall in “Polymer Sequence Determination, Carbon-13 NMR Method”, Academic Press, New York, 1977.

The stereodefects measured as “stereo defects/10,000 monomer units” are calculated from the sum of the intensities of mmrr, mmrm+rrmr, and rmrm resonance peaks times 5000. The intensities used in the calculations are normalized to the total number of monomers in the sample. Methods for measuring 2,1 regio defects/10,000 monomers and 1,3 regio defects/10,000 monomers follow standard methods. Additional references include Grassi, A. et. al. Macromolecules, 1988, v. 21, pp. 617-622 and Busico et. al. Macromolecules, 1994, v. 27, pp. 7538-7543. The average meso run length=10000/[(stereo defects/10000 C)+(2,1-regio defects/10000 C)+(1,3-regio-defects/10000 C)].

Polymerization results are collected in Tables 2 and 3 below. “Ex #” stands for example number. Example numbers starting with a “C” are comparative examples. “Cat ID” identifies the pre-catalyst used in the experiment. Corresponding numbers identifying the pre-catalyst (also referred to as pre-catalyst, catalyst, complex or compound) are located in the synthetic experimental section. T (° C.) is the polymerization temperature which was typically maintained within +/−1° C. “Yield” is polymer yield, and is not corrected for catalyst residue. “Quench time(s)” is the actual duration of the polymerization run in seconds. For propylene homopolymerization runs, quench value indicates the maximum set pressure loss (conversion) of propylene (for PP runs) during the polymerization. Activity is reported at grams polymer per mmol of catalyst per hour.

Standard polymerization conditions include 0.015 μmol catalyst complex, 1.1 equivalence of activator, 0.5 μmol TNOA scavenger, 1.0 ml propylene, 4.1 ml total solvent, with quench value at 8 psi pressure loss, or a maximum reaction time of 30 minutes. Activator A is N,N-dimethylanilinium tetrakis(pentafluorophenyl)borate activator and activator B is (hydrogenated tallow alkyl)methylammonium tetrakis(pentafluorophenyl)borate. When activator A was used, both the pre-catalyst and activator solutions were in toluene. When activator B was used, both pre-catalyst and activator solutions were in isohexane. Small amounts of methylcyclohexane (MCH) result from activator B being supplied by the manufacturer as a 10 wt % solution in methylcyclohexane.

TABLE 2
Propylene Polymerizations

| | | | | | | | | | Activity (g | | | | | |
|---|---|---|---|---|---|---|---|---|---|---|---|---|---|---|
| | Cat | Act | MCH | Isohexane | Toluene | T | quench | yield | P/mmol | | | | | Tm |
| Ex# | ID | ID | (μL) | (μL) | (μL) | (C) | time (s) | (g) | cat · hr) | Mr | Mw | Mz | PDI | (° C.) |
| 1 | 2 | A | 0 | 3974 | 126 | 70 | 21 | 0.3546 | 4,052,571 | 73,421 | 420,433 | 1,709,810 | 5.73 | 147.1 |
| 2 | 2 | A | 0 | 3974 | 126 | 70 | 18 | 0.4148 | 5,530,667 | 76,949 | 543,195 | 2,005,088 | 7.06 | 149.0 |
| 3 | 2 | A | 0 | 3974 | 126 | 70 | 10 | 0.3918 | 9,403,200 | 103,909 | 528,615 | 1,814,923 | 5.09 | 147.3 |
| 4 | 2 | A | 0 | 3974 | 126 | 100 | 22 | 0.2721 | 2,968,364 | 57,565 | 199,104 | 800,436 | 3.46 | 146.8 |
| 5 | 2 | A | 0 | 3974 | 126 | 100 | 53 | 0.3146 | 1,424,604 | 48,050 | 159,009 | 561,241 | 3.31 | 145.9 |
| 6 | 2 | A | 0 | 3974 | 126 | 100 | 15 | 0.1387 | 2,219,200 | 31,651 | 124,242 | 646,364 | 3.93 | 143.8 |
| 7 | 2 | B | 0.23 | 4100 | 0 | 70 | 68 | 0.3437 | 1,213,059 | 189,604 | 636,876 | 2,608,479 | 3.36 | 149.2 |
| 8 | 2 | B | 0.23 | 4100 | 0 | 70 | 37 | 0.3521 | 2,283,892 | 169,687 | 591,822 | 2,111,419 | 3.49 | 149.1 |
| 9 | 2 | B | 0.23 | 4100 | 0 | 70 | 34 | 0.2551 | 1,800,706 | 187,836 | 584,384 | 1,840,753 | 3.11 | 149.3 |
| 10 | 2 | B | 0.23 | 4100 | 0 | 100 | 70 | 0.2953 | 1,012,457 | 77,036 | 219,976 | 752,190 | 2.86 | 147.8 |
| 11 | 2 | B | 0.23 | 4100 | 0 | 100 | 43 | 0.2519 | 1,405,953 | 81,737 | 215,037 | 743,476 | 2.63 | 147.6 |
| 12 | 3 | A | 0 | 3974 | 126 | 70 | 41 | 0.1035 | 605,854 | 118,488 | 606,580 | 2,220,344 | 5.12 | 148.3 |
| 13 | 3 | A | 0 | 3974 | 126 | 70 | 13 | 0.3794 | 7,004,308 | 110,226 | 604,370 | 2,483,762 | 5.48 | 149.6 |
| 14 | 3 | A | 0 | 3974 | 126 | 70 | 19 | 0.4079 | 5,152,421 | 86,789 | 532,614 | 1,925,351 | 6.14 | 147.9 |
| 15 | 3 | A | 0 | 3974 | 126 | 100 | 25 | 0.2984 | 2,864,640 | 50,824 | 163,529 | 552,242 | 3.22 | 146.4 |
| 16 | 3 | A | 0 | 3974 | 126 | 100 | 46 | 0.2921 | 1,524,000 | 72,159 | 203,093 | 672,818 | 2.81 | 147.1 |
| 17 | 3 | A | 0 | 3974 | 126 | 100 | 16 | 0.2497 | 3,745,500 | 42,432 | 179,178 | 679,650 | 4.22 | 146.6 |
| 18 | 3 | B | 0.23 | 4100 | 0 | 70 | 134 | 0.2555 | 457,612 | 506,417 | 949,074 | 2,115,878 | 1.87 | 148.5 |
| 19 | 3 | B | 0.23 | 4100 | 0 | 70 | 114 | 0.2636 | 554,947 | 441,398 | 895,314 | 2,032,040 | 2.03 | 149.5 |
| 20 | 3 | B | 0.23 | 4100 | 0 | 70 | 104 | 0.2988 | 689,538 | 450,188 | 939,372 | 2,544,973 | 2.09 | 151.4 |
| 21 | 3 | B | 0.23 | 4100 | 0 | 100 | 185 | 0.0877 | 113,773 | 237,387 | 427,282 | 875,164 | 1.80 | 148.9 |
| 22 | 3 | B | 0.23 | 4100 | 0 | 100 | 104 | 0.1480 | 341,538 | 189,114 | 371,150 | 851,671 | 1.96 | 149.8 |
| 23 | 3 | B | 0.23 | 4100 | 0 | 100 | 90 | 0.1313 | 350,133 | 180,747 | 368,536 | 878,127 | 2.04 | 149.3 |
| 24 | 4 | A | 0 | 3974 | 126 | 70 | 32 | 0.1732 | 1,299,000 | 164,735 | 461,067 | 1,439,037 | 2.80 | 149.7 |
| 25 | 4 | A | 0 | 3974 | 126 | 70 | 21 | 0.4016 | 4,589,714 | 78,372 | 438,481 | 1,607,689 | 5.59 | 148.3 |
| 26 | 4 | A | 0 | 3974 | 126 | 70 | 14 | 0.4113 | 7,050,857 | 123,867 | 592,381 | 2,233,661 | 4.78 | 148.9 |
| 27 | 4 | A | 0 | 3974 | 126 | 100 | 26 | 0.3056 | 2,820,923 | 42,205 | 155,669 | 779,579 | 3.69 | 147.3 |
| 28 | 4 | A | 0 | 3974 | 126 | 100 | 14 | 0.2662 | 4,563,429 | 47,526 | 164,284 | 587,203 | 3.46 | 147.6 |
| 29 | 4 | A | 0 | 3974 | 126 | 100 | 39 | 0.3272 | 2,013,538 | 20,528 | 112,357 | 429,549 | 5.47 | 147.1 |
| 30 | 4 | B | 0.23 | 4100 | 0 | 70 | 25 | 0.3439 | 3,301,440 | 151,288 | 556,614 | 1,915,863 | 3.68 | 150.0 |
| 31 | 4 | B | 0.23 | 4100 | 0 | 70 | 39 | 0.3818 | 2,349,538 | 134,665 | 578,896 | 2,336,705 | 4.30 | 148.7 |
| 32 | 4 | B | 0.23 | 4100 | 0 | 70 | 31 | 0.3274 | 2,534,710 | 149,329 | 557,910 | 2,104,820 | 3.74 | 149.0 |
| 33 | 4 | B | 0.23 | 4100 | 0 | 100 | 29 | 0.2415 | 1,998,621 | 45,372 | 169,686 | 627,762 | 3.74 | 148.5 |
| 34 | 4 | B | 0.23 | 4100 | 0 | 100 | 28 | 0.2476 | 2,122,286 | 67,050 | 186,955 | 653,230 | 2.79 | 147.8 |
| 35 | 4 | B | 0.23 | 4100 | 0 | 100 | 25 | 0.2446 | 2,348,160 | 57,721 | 194,419 | 827,701 | 3.37 | 148.1 |
| 36 | 7 | A | 0 | 3974 | 126 | 70 | 20 | 0.3585 | 4,302,000 | 78,095 | 443,067 | 1,905,322 | 5.67 | 146.7 |
| 37 | 7 | A | 0 | 3974 | 126 | 70 | 22 | 0.3255 | 3,550,909 | 92,640 | 497,970 | 2,068,664 | 5.38 | 147.1 |
| 38 | 7 | A | 0 | 3974 | 126 | 70 | 29 | 0.4004 | 3,313,655 | 110,017 | 490,749 | 1,708,357 | 4.46 | 147.8 |
| 39 | 7 | A | 0 | 3974 | 126 | 100 | 12 | 0.2319 | 4,638,000 | 51,316 | 204,866 | 1,240,958 | 3.99 | 145.8 |
| 40 | 7 | A | 0 | 3974 | 126 | 100 | 15 | 0.2610 | 4,176,000 | 39,790 | 189,266 | 998,961 | 4.76 | 145.9 |
| 41 | 7 | A | 0 | 3974 | 126 | 100 | 13 | 0.2397 | 4,425,231 | 40,975 | 177,573 | 718,107 | 4.33 | 146.3 |
| 42 | 7 | B | 0.23 | 4100 | 0 | 70 | 41 | 0.3576 | 2,093,268 | 104,535 | 586,285 | 3,237,039 | 5.61 | 148.4 |
| 43 | 7 | B | 0.23 | 4100 | 0 | 70 | 30 | 0.2266 | 1,812,800 | 142,564 | 562,236 | 1,975,212 | 3.94 | 149.2 |
| 44 | 7 | B | 0.23 | 4100 | 0 | 70 | 38 | 0.3586 | 2,264,842 | 147,301 | 565,512 | 1,954,365 | 3.84 | 148.7 |
| 45 | 7 | B | 0.23 | 4100 | 0 | 100 | 28 | 0.2017 | 1,728,857 | 84,657 | 262,672 | 1,005,099 | 3.10 | 147.2 |
| 46 | 7 | B | 0.23 | 4100 | 0 | 100 | 28 | 0.2151 | 1,843,714 | 80,028 | 253,149 | 1,147,333 | 3.16 | 147.4 |
| 47 | 7 | B | 0.23 | 4100 | 0 | 100 | 40 | 0.2734 | 1,640,400 | 94,328 | 233,727 | 753,017 | 2.48 | 147.2 |
| 48 | 10 | A | 0 | 3974 | 126 | 70 | 27 | 0.3580 | 3,182,222 | 101,753 | 500,013 | 2,089,867 | 4.91 | 147.8 |
| 49 | 10 | A | 0 | 3974 | 126 | 70 | 51 | 0.3943 | 1,855,529 | 115,767 | 485,302 | 2,019,302 | 4.19 | 147.3 |
| 50 | 10 | A | 0 | 3974 | 126 | 70 | 43 | 0.3847 | 2,147,163 | 125,947 | 517,643 | 1,869,021 | 4.11 | 147.3 |
| 51 | 10 | A | 0 | 3974 | 126 | 100 | 22 | 0.1769 | 1,929,818 | 98,431 | 247,338 | 802,160 | 2.51 | 146.8 |
| 52 | 10 | A | 0 | 3974 | 126 | 100 | 30 | 0.2045 | 1,636,000 | 84,641 | 214,139 | 711,132 | 2.53 | 146.1 |
| 53 | 10 | A | 0 | 3974 | 126 | 100 | 27 | 0.2194 | 1,950,222 | 94,976 | 228,193 | 649,660 | 2.40 | 147.0 |
| 54 | 10 | B | 0.23 | 4100 | 0 | 70 | 49 | 0.2687 | 1,316,082 | 232,096 | 620,372 | 1,922,678 | 2.67 | 148.8 |
| 55 | 10 | B | 0.23 | 4100 | 0 | 70 | 31 | 0.2561 | 1,982,710 | 230,363 | 649,383 | 2,217,063 | 2.82 | 149.0 |
| 56 | 10 | B | 0.23 | 4100 | 0 | 70 | 50 | 0.2480 | 1,190,400 | 227,283 | 659,319 | 2,284,484 | 2.90 | 148.4 |
| 57 | 10 | B | 0.23 | 4100 | 0 | 100 | 35 | 0.1364 | 935,314 | 149,388 | 323,665 | 938,351 | 2.17 | 147.3 |
| 58 | 10 | B | 0.23 | 4100 | 0 | 100 | 43 | 0.1589 | 886,884 | 156,073 | 341,043 | 1,158,608 | 2.19 | 147.6 |
| 59 | 10 | B | 0.23 | 4100 | 0 | 100 | 54 | 0.1614 | 717,333 | 123,294 | 314,948 | 922,317 | 2.55 | 147.4 |
| 60 | 13 | A | 0 | 3974 | 126 | 70 | 22 | 0.3224 | 3,517,091 | 72,439 | 441,421 | 2,462,104 | 6.09 | 147.1 |
| 61 | 13 | A | 0 | 3974 | 126 | 70 | 24 | 0.3498 | 3,498,000 | 41,010 | 401,622 | 1,946,986 | 9.79 | 145.8 |
| 62 | 13 | A | 0 | 3974 | 126 | 70 | 8 | 0.3608 | 10,824,000 | 85,868 | 471,279 | 1,633,474 | 5.49 | 148.6 |
| 63 | 13 | A | 0 | 3974 | 126 | 100 | 22 | 0.2714 | 2,960,727 | 39,234 | 182,862 | 1,704,537 | 4.66 | 145.8 |
| 64 | 13 | A | 0 | 3974 | 126 | 100 | 38 | 0.3230 | 2,040,000 | 24,286 | 133,295 | 913,087 | 5.49 | 144.1 |
| 65 | 13 | A | 0 | 3974 | 126 | 100 | 19 | 0.2961 | 3,740,211 | 30,711 | 166,327 | 811,634 | 5.42 | 146.1 |
| 66 | 13 | B | 0.23 | 4100 | 0 | 70 | 46 | 0.4022 | 2,098,435 | 135,198 | 524,185 | 2,024,367 | 3.88 | 148.0 |
| 67 | 13 | B | 0.23 | 4100 | 0 | 70 | 38 | 0.3950 | 2,494,737 | 102,034 | 521,882 | 2,399,053 | 5.11 | 148.6 |
| 68 | 13 | B | 0.23 | 4100 | 0 | 100 | 22 | 0.2121 | 2,313,818 | 73,617 | 220,423 | 771,732 | 2.99 | 146.7 |
| 69 | 13 | B | 0.23 | 4100 | 0 | 100 | 24 | 0.2312 | 2,312,000 | 65,538 | 235,917 | 1,174,063 | 3.60 | 147.1 |
| 70 | 13 | B | 0.23 | 4100 | 0 | 100 | 29 | 0.2342 | 1,938,207 | 65,056 | 210,032 | 802,646 | 3.23 | 146.9 |
| C1 | 5 | A | 0 | 3974 | 126 | 70 | 35 | 0.3834 | 2,629,029 | 92,224 | 446,891 | 1,525,682 | 4.85 | 148.2 |
| C2 | 5 | A | 0 | 3974 | 126 | 70 | 43 | 0.4061 | 2,266,605 | 100,589 | 466,684 | 1,712,037 | 4.64 | 147.8 |
| C3 | 5 | A | 0 | 3974 | 126 | 70 | 17 | 0.3921 | 5,535,529 | 58,022 | 457,032 | 1,578,777 | 7.88 | 148.3 |
| C4 | 5 | A | 0 | 3974 | 126 | 100 | 12 | 0.2365 | 4,730,000 | 48,048 | 157,132 | 534,867 | 3.27 | 146.8 |
| C5 | 5 | A | 0 | 3974 | 126 | 100 | 33 | 0.2645 | 1,923,636 | 33,985 | 150,017 | 664,237 | 4.41 | 146.3 |
| C6 | 5 | B | 0.23 | 4100 | 0 | 70 | 50 | 0.3788 | 1,818,240 | 125,944 | 482,480 | 1,627,421 | 3.83 | 148.5 |
| C7 | 5 | B | 0.23 | 4100 | 0 | 70 | 21 | 0.3547 | 4,053,714 | 164,396 | 544,043 | 1,640,001 | 3.31 | 149.7 |
| C8 | 5 | B | 0.23 | 4100 | 0 | 70 | 18 | 0.3233 | 4,310,667 | 134,091 | 509,198 | 1,791,018 | 3.80 | 149.2 |
| C9 | 5 | B | 0.23 | 4100 | 0 | 100 | 20 | 0.2281 | 2,737,200 | 66,724 | 190,537 | 632,425 | 2.86 | 147.8 |
| C10 | 5 | B | 0.23 | 4100 | 0 | 100 | 22 | 0.2419 | 2,638,909 | 53,556 | 186,913 | 681,433 | 3.49 | 147.3 |
| C11 | 5 | B | 0.23 | 4100 | 0 | 100 | 29 | 0.2829 | 2,341,241 | 53,183 | 189,716 | 733,572 | 3.57 | 147.5 |
| C12 | 8 | A | 0 | 3974 | 126 | 70 | 49 | 0.3277 | 1,605,061 | 199,705 | 480,415 | 1,309,951 | 2.41 | 148.6 |
| C13 | 8 | A | 0 | 3974 | 126 | 70 | 19 | 0.3763 | 4,753,263 | 88,071 | 410,310 | 1,273,292 | 4.66 | 146.0 |
| C14 | 8 | A | 0 | 3974 | 126 | 70 | 12 | 0.3942 | 7,884,000 | 142,514 | 507,081 | 1,687,349 | 3.56 | 146.8 |
| C15 | 8 | A | 0 | 3974 | 126 | 100 | 27 | 0.2734 | 2,430,222 | 32,705 | 148,534 | 490,893 | 4.54 | 143.6 |
| C16 | 8 | A | 0 | 3974 | 126 | 100 | 20 | 0.3100 | 3,720,000 | 40,569 | 154,778 | 557,201 | 3.82 | 145.0 |
| C17 | 8 | A | 0 | 3974 | 126 | 100 | 23 | 0.2991 | 3,121,043 | 44,934 | 150,040 | 494,063 | 3.34 | 143.9 |
| C18 | 8 | B | 0.23 | 4100 | 0 | 70 | 55 | 0.3585 | 1,564,364 | 202,016 | 521,245 | 1,457,630 | 2.58 | 147.3 |
| C19 | 8 | B | 0.23 | 4100 | 0 | 70 | 34 | 0.3044 | 2,148,706 | 176,615 | 523,744 | 1,647,575 | 2.97 | 147.7 |
| C20 | 8 | B | 0.23 | 4100 | 0 | 70 | 29 | 0.3639 | 3,011,586 | 185,056 | 536,480 | 1,609,807 | 2.90 | 148.1 |
| C21 | 8 | B | 0.23 | 4100 | 0 | 100 | 29 | 0.2483 | 2,054,897 | 92,604 | 239,867 | 726,886 | 2.59 | 146.1 |
| C22 | 8 | B | 0.23 | 4100 | 0 | 100 | 20 | 0.2268 | 2,721,600 | 84,511 | 221,351 | 689,069 | 2.62 | 145.6 |
| C23 | 8 | B | 0.23 | 4100 | 0 | 100 | 25 | 0.2851 | 2,736,960 | 87,978 | 215,651 | 644,793 | 2.45 | 145.4 |
| C24 | 11 | A | 0 | 3974 | 126 | 70 | 17 | 0.3928 | 5,545,412 | 72,094 | 417,841 | 1,697,067 | 5.80 | 147.6 |
| C25 | 11 | A | 0 | 3974 | 126 | 70 | 22 | 0.4057 | 4,425,818 | 80,595 | 457,122 | 1,845,106 | 5.67 | 146.4 |
| C26 | 11 | A | 0 | 3974 | 126 | 70 | 16 | 0.4000 | 6,000,000 | 77,144 | 470,453 | 2,057,935 | 6.10 | 146.9 |
| C27 | 11 | A | 0 | 3974 | 126 | 100 | 32 | 0.3280 | 2,460,000 | 35,585 | 141,392 | 771,337 | 3.97 | 144.7 |
| C28 | 11 | A | 0 | 3974 | 126 | 100 | 46 | 0.2989 | 1,559,478 | 36,410 | 138,767 | 533,032 | 3.81 | 145.0 |
| C29 | 11 | A | 0 | 3974 | 126 | 100 | 19 | 0.2797 | 3,533,053 | 43,471 | 179,059 | 735,535 | 4.12 | 146.1 |
| C30 | 11 | B | 0.23 | 4100 | 0 | 70 | 38 | 0.3440 | 2,172,632 | 132,558 | 520,224 | 1,798,984 | 3.92 | 148.5 |
| C31 | 11 | B | 0.23 | 4100 | 0 | 70 | 45 | 0.3942 | 2,102,400 | 142,100 | 518,473 | 1,883,630 | 3.65 | 147.6 |
| C32 | 11 | B | 0.23 | 4100 | 0 | 70 | 21 | 0.2160 | 2,468,571 | 153,022 | 578,532 | 2,280,133 | 3.78 | 149.0 |
| C33 | 11 | B | 0.23 | 4100 | 0 | 100 | 19 | 0.1738 | 2,195,368 | 70,769 | 217,532 | 1,104,195 | 3.07 | 146.9 |
| C34 | 11 | B | 0.23 | 4100 | 0 | 100 | 19 | 0.2003 | 2,530,105 | 72,655 | 216,722 | 877,053 | 2.98 | 146.9 |
| C35 | 11 | B | 0.23 | 4100 | 0 | 100 | 25 | 0.1916 | 1,839,360 | 67,178 | 199,201 | 830,008 | 2.97 | 147.7 |
| C36 | 14 | A | 0 | 3974 | 126 | 70 | 17 | 0.3777 | 5,332,235 | 51,771 | 409,655 | 1,643,708 | 7.91 | 147.1 |
| C37 | 14 | A | 0 | 3974 | 126 | 70 | 22 | 0.4310 | 4,701,818 | 73,251 | 422,884 | 1,794,768 | 5.77 | 147.1 |
| C38 | 14 | A | 0 | 3974 | 126 | 70 | 10 | 0.4143 | 9,943,200 | 79,137 | 427,915 | 1,704,507 | 5.41 | 148.3 |
| C39 | 14 | A | 0 | 3974 | 126 | 100 | 19 | 0.2842 | 3,589,895 | 41,269 | 157,755 | 608,816 | 3.82 | 147.6 |
| C40 | 14 | A | 0 | 3974 | 126 | 100 | 21 | 0.3363 | 3,843,429 | 20,519 | 118,735 | 547,511 | 5.79 | 145.6 |
| C41 | 14 | A | 0 | 3974 | 126 | 100 | 8 | 0.2458 | 7,374,000 | 31,384 | 149,968 | 649,731 | 4.78 | 146.6 |
| C42 | 14 | B | 0.23 | 4100 | 0 | 70 | 41 | 0.3535 | 2,069,268 | 142,243 | 528,329 | 1,786,121 | 3.71 | 148.8 |
| C43 | 14 | B | 0.23 | 4100 | 0 | 70 | 20 | 0.3501 | 4,201,200 | 146,842 | 583,343 | 2,112,818 | 3.97 | 149.3 |
| C44 | 14 | B | 0.23 | 4100 | 0 | 70 | 22 | 0.2818 | 3,074,182 | 153,727 | 515,347 | 1,774,716 | 3.35 | 148.6 |
| C45 | 14 | B | 0.23 | 4100 | 0 | 100 | 24 | 0.2345 | 2,345,000 | 63,491 | 180,083 | 621,548 | 2.84 | 148.0 |
| C46 | 14 | B | 0.23 | 4100 | 0 | 100 | 22 | 0.2459 | 2,682,545 | 54,833 | 161,679 | 531,840 | 2.95 | 147.3 |
| C47 | 14 | B | 0.23 | 4100 | 0 | 100 | 31 | 0.2874 | 2,225,032 | 47,288 | 169,722 | 733,298 | 3.59 | 148.0 |

TABLE 3
¹³C NMR characterization of select polypropylene examples.
All defects are reported as defects per 10,000 monomer units. No 2,1-regio (te) defects and 1,3-regio defects were observed.

| | | | | | | | | | | | | | | | 2,1- | 2,1- |
|---|---|---|---|---|---|---|---|---|---|---|---|---|---|---|---|---|
| | | | | | | | | | | | | | | | regio | regio |
| | Cat | Act | | | | | | | mmrm + | | | | | stereo | (ee) | (et) |
| Ex# | ID | ID | m | r | mmmm | mmmr | rmmr | mmrr | rmrr | rmrm | rrrr | mrrr | mrrm | defects | defects | defects |
| 3 | 2 | A | 0.987 | 0.013 | 0.965 | 0.008 | 0.006 | 0.009 | 0.005 | 0.003 | 0.000 | 0.000 | 0.004 | 84.0 | 58.7 | 8.9 |
| 5 | 2 | A | 0.981 | 0.019 | 0.955 | 0.009 | 0.006 | 0.011 | 0.007 | 0.003 | 0.002 | 0.002 | 0.005 | 100.7 | 66.4 | 9.2 |
| 8 | 2 | B | 0.986 | 0.014 | 0.963 | 0.008 | 0.007 | 0.009 | 0.006 | 0.002 | 0.001 | 0.001 | 0.004 | 81.3 | 59.7 | 8.6 |
| 10 | 2 | B | 0.978 | 0.022 | 0.952 | 0.009 | 0.007 | 0.011 | 0.007 | 0.003 | 0.002 | 0.002 | 0.007 | 102.8 | 63.6 | 10.9 |
| 13 | 3 | A | 0.988 | 0.012 | 0.967 | 0.009 | 0.005 | 0.008 | 0.004 | 0.001 | 0.000 | 0.001 | 0.004 | 69.2 | 60.9 | 8.2 |
| 16 | 3 | A | 0.982 | 0.018 | 0.955 | 0.013 | 0.003 | 0.009 | 0.009 | 0.003 | 0.001 | 0.001 | 0.005 | 105.3 | 63.3 | 9.5 |
| 20 | 3 | B | 0.987 | 0.013 | 0.964 | 0.007 | 0.007 | 0.009 | 0.006 | 0.002 | 0.001 | 0.001 | 0.004 | 81.2 | 53.2 | 6.3 |
| 21, 23 | 3 | B | 0.985 | 0.015 | 0.960 | 0.008 | 0.009 | 0.010 | 0.006 | 0.001 | 0.000 | 0.001 | 0.004 | 87.5 | 53.8 | 8.6 |
| 26 | 4 | A | 0.986 | 0.014 | 0.965 | 0.007 | 0.005 | 0.010 | 0.005 | 0.002 | 0.001 | 0.001 | 0.005 | 81.2 | 58.9 | 8.7 |
| 28 | 4 | A | 0.983 | 0.017 | 0.960 | 0.008 | 0.005 | 0.011 | 0.006 | 0.003 | 0.001 | 0.002 | 0.005 | 97.7 | 64.6 | 11.7 |
| 32 | 4 | B | 0.987 | 0.013 | 0.968 | 0.007 | 0.004 | 0.009 | 0.004 | 0.001 | 0.000 | 0.001 | 0.004 | 72.2 | 60.7 | 8.1 |
| 35 | 4 | B | 0.982 | 0.018 | 0.958 | 0.009 | 0.006 | 0.011 | 0.006 | 0.003 | 0.001 | 0.001 | 0.006 | 96.3 | 63.9 | 9.1 |
| 37 | 7 | A | 0.986 | 0.014 | 0.961 | 0.009 | 0.008 | 0.008 | 0.006 | 0.001 | 0.000 | 0.002 | 0.004 | 73.8 | 64.4 | 8.0 |
| 40 | 7 | A | 0.978 | 0.022 | 0.944 | 0.012 | 0.010 | 0.010 | 0.011 | 0.003 | 0.002 | 0.002 | 0.006 | 115.7 | 73.3 | 12.2 |
| 42 | 7 | B | 0.979 | 0.021 | 0.949 | 0.010 | 0.010 | 0.009 | 0.010 | 0.003 | 0.001 | 0.003 | 0.006 | 109.3 | 60.8 | 7.8 |
| 46 | 7 | B | 0.970 | 0.030 | 0.932 | 0.011 | 0.011 | 0.012 | 0.015 | 0.005 | 0.001 | 0.004 | 0.008 | 158.7 | 62.6 | 8.3 |
| 49 | 10 | A | 0.982 | 0.018 | 0.957 | 0.010 | 0.006 | 0.009 | 0.006 | 0.002 | 0.001 | 0.002 | 0.006 | 80.5 | 71.0 | 11.8 |
| 53 | 10 | A | 0.965 | 0.035 | 0.921 | 0.013 | 0.014 | 0.013 | 0.017 | 0.006 | 0.003 | 0.004 | 0.009 | 173.4 | 81.5 | 0.0 |
| 55 | 10 | B | 0.980 | 0.020 | 0.950 | 0.010 | 0.009 | 0.010 | 0.009 | 0.002 | 0.001 | 0.002 | 0.006 | 105.2 | 59.5 | 8.4 |
| 58 | 10 | B | 0.971 | 0.029 | 0.934 | 0.011 | 0.010 | 0.013 | 0.013 | 0.004 | 0.002 | 0.003 | 0.009 | 151.7 | 61.5 | 8.4 |
| 61 | 13 | A | 0.982 | 0.018 | 0.956 | 0.009 | 0.008 | 0.007 | 0.008 | 0.002 | 0.001 | 0.002 | 0.006 | 88.5 | 68.1 | 9.3 |
| 65 | 13 | A | 0.976 | 0.024 | 0.941 | 0.012 | 0.011 | 0.009 | 0.011 | 0.005 | 0.002 | 0.003 | 0.006 | 122.7 | 74.7 | 10.5 |
| 67 | 13 | B | 0.980 | 0.020 | 0.952 | 0.009 | 0.009 | 0.009 | 0.009 | 0.003 | 0.001 | 0.003 | 0.006 | 101.8 | 61.9 | 8.1 |
| 69 | 13 | B | 0.967 | 0.033 | 0.925 | 0.012 | 0.012 | 0.013 | 0.017 | 0.007 | 0.003 | 0.004 | 0.007 | 183.1 | 61.0 | 6.3 |
| C1 | 5 | A | 0.983 | 0.017 | 0.949 | 0.009 | 0.013 | 0.013 | 0.009 | 0.004 | 0.001 | 0.000 | 0.004 | 123.8 | 49.1 | 0.0 |
| C4 | 5 | A | 0.978 | 0.022 | 0.950 | 0.009 | 0.006 | 0.014 | 0.006 | 0.004 | 0.002 | 0.002 | 0.007 | 115.8 | 61.7 | 10.6 |
| C7 | 5 | B | 0.987 | 0.013 | 0.969 | 0.007 | 0.004 | 0.009 | 0.004 | 0.002 | 0.001 | 0.001 | 0.004 | 69.7 | 59.2 | 8.4 |
| C10 | 5 | B | 0.983 | 0.017 | 0.959 | 0.009 | 0.005 | 0.011 | 0.005 | 0.003 | 0.001 | 0.001 | 0.005 | 94.6 | 63.8 | 9.0 |
| C14 | 8 | A | 0.980 | 0.020 | 0.951 | 0.011 | 0.009 | 0.010 | 0.006 | 0.002 | 0.001 | 0.004 | 0.006 | 86.1 | 67.4 | 8.5 |
| C16 | 8 | A | 0.973 | 0.027 | 0.934 | 0.014 | 0.012 | 0.011 | 0.009 | 0.004 | 0.002 | 0.005 | 0.008 | 117.3 | 78.4 | 18.1 |
| C20 | 8 | B | 0.984 | 0.016 | 0.960 | 0.009 | 0.007 | 0.007 | 0.006 | 0.001 | 0.001 | 0.003 | 0.005 | 70.2 | 71.7 | 11.4 |
| C23 | 8 | B | 0.984 | 0.016 | 0.959 | 0.011 | 0.006 | 0.008 | 0.006 | 0.001 | 0.000 | 0.002 | 0.005 | 78.1 | 79.3 | 13.5 |
| C25 | 11 | A | 0.982 | 0.018 | 0.954 | 0.009 | 0.009 | 0.008 | 0.008 | 0.002 | 0.001 | 0.003 | 0.005 | 91.6 | 59.7 | 7.8 |
| C29 | 11 | A | 0.973 | 0.027 | 0.933 | 0.012 | 0.011 | 0.013 | 0.015 | 0.005 | 0.001 | 0.004 | 0.005 | 162.8 | 64.7 | 8.9 |
| C30 | 11 | B | 0.976 | 0.024 | 0.947 | 0.009 | 0.007 | 0.009 | 0.011 | 0.003 | 0.002 | 0.003 | 0.007 | 115.8 | 63.3 | 7.5 |
| C34 | 11 | B | 0.962 | 0.038 | 0.917 | 0.013 | 0.011 | 0.013 | 0.022 | 0.006 | 0.002 | 0.006 | 0.008 | 207.3 | 61.7 | 0.0 |
| C38 | 14 | A | 0.980 | 0.020 | 0.957 | 0.008 | 0.005 | 0.011 | 0.007 | 0.003 | 0.001 | 0.002 | 0.006 | 99.4 | 64.7 | 8.9 |
| C41 | 14 | A | 0.970 | 0.030 | 0.935 | 0.011 | 0.009 | 0.014 | 0.011 | 0.006 | 0.002 | 0.003 | 0.009 | 153.5 | 63.0 | 10.8 |
| C43 | 14 | B | 0.988 | 0.012 | 0.970 | 0.007 | 0.004 | 0.009 | 0.004 | 0.002 | 0.000 | 0.001 | 0.004 | 71.6 | 59.9 | 8.0 |
| C46 | 14 | B | 0.982 | 0.018 | 0.957 | 0.009 | 0.006 | 0.011 | 0.006 | 0.003 | 0.001 | 0.001 | 0.006 | 96.2 | 65.9 | 9.0 |

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. All numerical values are “about” or “approximately” the indicated value, and take into account experimental error and variations that would be expected by a person having ordinary skill in the art. Any of the values in the tables can provide the end points for ranges that define their respective measurement or property, with an additional +/−10%.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A catalyst compound represented by Formula (I): 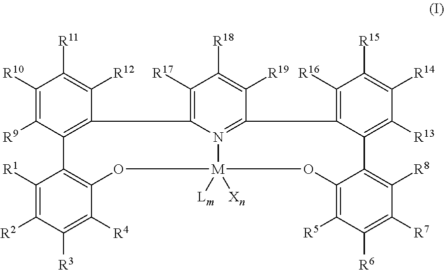
wherein:
M is a group 3, 4, or 5 metal;
each of R¹, R², R³, R⁴, R⁵, R⁶, R⁷, and R⁸ is independently hydrogen, C₁-C₄₀ hydrocarbyl, C₁-C₄₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, R¹², R¹³, R¹⁴, R¹⁵, and R¹⁶ is independently hydrogen, C₁-C₄₀ hydrocarbyl, C₁-C₄₀ substituted hydrocarbyl, a heteroatom or a heteroatom-containing group, or any two or more adjacent R⁹, R¹⁰, R¹¹, R¹², R¹³, R¹⁴, R¹⁵, and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₄₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
L is a Lewis base;
each X is independently a hydrocarbyl ligand or a substituted hydrocarbyl ligand wherein at least one X is a non-aromatic hydrocarbyl ligand having nine carbon atoms or more, or is a substituted hydrocarbyl ligand having at least five carbon atoms or more, or when n is 2, both X together may be hydrocarbyl or substituted hydrocarbyl that comprise four carbon atoms or more and form a 5-membered cyclic ring structure with M;
n is 1, 2, or 3;
m is 0, 1, or 2;
n+m is not greater than 4;
any two L groups may be joined together to form a bidentate Lewis base; and
an X group may be joined to an L group to form a monoanionic bidentate group.

2. The catalyst compound of claim 1, wherein n is 2, m is 0 or 1 (preferably 0), both X are represented by one of Formulas Ia, Ib, Ic, or Id, and R²⁰, R^{20′}, R²¹, R^{21′}, R²², R^{22′}, R²³, R^{23′} are independently hydrogen or C₁-C₂₀ hydrocarbyl, where the dashed lines represent bonds to the metal atom M,

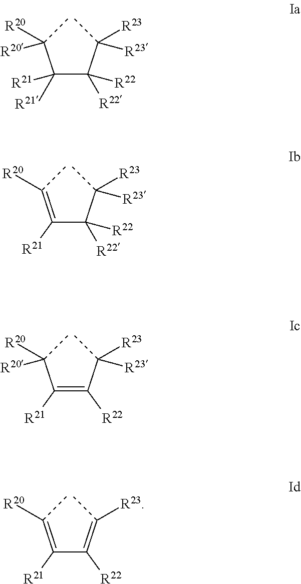

3. The catalyst compound of claim 1, wherein n is 2, at least one X is a C₉-C₄₀ non-aromatic hydrocarbyl ligand, preferably a C₉-C₂₀ non-aromatic hydrocarbyl ligand, or more preferably a C₁₀-C₂₀ non-aromatic hydrocarbyl ligand, or more preferably a C₁₂-C₂₀ non-aromatic hydrocarbyl ligand, and the other X is a C₁-C₄₀ hydrocarbyl ligand or substituted hydrocarbyl ligand, preferably a C₁-C₂₀ hydrocarbyl ligand or substituted hydrocarbyl ligand.

4. The catalyst compound of claim 1, wherein at least one X is a C₅-C₄₀ substituted hydrocarbyl ligand, preferably a C₅-C₃₀ substituted hydrocarbyl ligand, preferably a C₇-C₃₀ substituted hydrocarbyl ligand, more preferably a C₁₀-C₃₀ substituted hydrocarbyl ligand, or more preferably a C₁₂-C₃₀ substituted hydrocarbyl ligand.

5. The catalyst compound of claim 4, wherein the substituted hydrocarbyl ligands comprise heteroatom-containing groups selected from SiR³⁰₃, GeR³⁰₃, OR³⁰, SR³⁰, NR³⁰₂ where each R³⁰ is independently a C₁-C₁₀ hydrocarbyl, preferably selected from C₁-C₁₀ alkyl, C₇-C₁₀ alkylaryl, or C₇-C₁₀ arylalkyl.

6. The catalyst compound of claim 1, wherein m is 0, n is 2, and both X together are a C₄-C₄₀ hydrocarbyl or substituted hydrocarbyl that forms a 5-membered cyclic ring structure with M.

7. The catalyst compound of claim 2, wherein m is 0, n is 2, and both X are represented by Formula Ic, R²⁰, R^{20′}, R²¹, R²², R²³, R^{23′} are each independently hydrogen or C₁-C₂₀ hydrocarbyl.

8. The catalyst compound of claim 2, wherein m is 0, n is 2, and both X are represented by Formula Ic, R²⁰, R^{20′}, R²³, R^{23′} are each independently hydrogen, and each R²¹ and R²² are independently hydrogen or hydrocarbyl or one of R²¹ and R²² can be hydrogen with the other being hydrogen or hydrocarbyl, preferably hydrogen or a C₁-C₂₀ hydrocarbyl, more preferably hydrogen or a C₁-C₁₀ hydrocarbyl, more preferably hydrogen, methyl or 4-methylpent-3-enyl.

9. The catalyst compound of claim 2, wherein R⁴ and R⁵ are adamantanyl, R² and R⁷ are C₄-C₄₀, preferably a C₄-C₈, hydrocarbyl, more preferably tert-butyl hydrocarbyl, m is 0, n is 2, and both X are represented by Formula Ic, preferably with R²⁰, R^{20′}, R²³, R^{23′} being hydrogen and each R²¹ and R²² being hydrogen or hydrocarbyl, preferably one of R²¹ and R²² being hydrogen with the other being be hydrocarbyl.

10. The catalyst compound of any preceding claim, wherein one of R²¹ and R²² can be hydrogen with the other being C₁-C₂₀ hydrocarbyl, preferably C₁-C₁₀ hydrocarbyl.

11. The catalyst compound of claim 1, wherein the catalyst compound is one of the following: 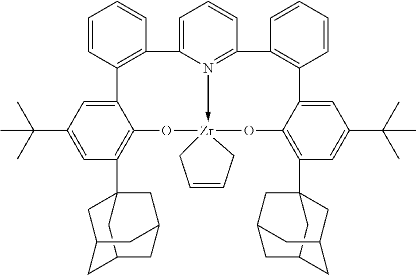
Complex 2 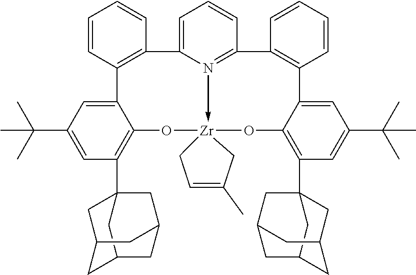
Complex 3 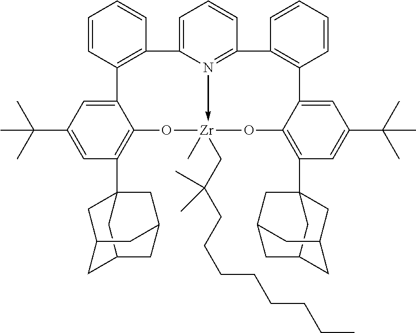
Complex 4 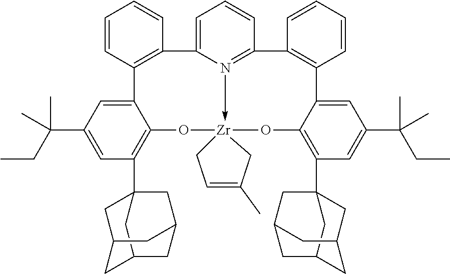
Complex 7 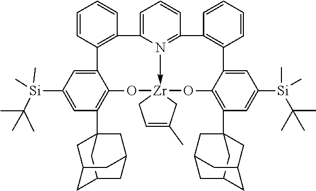
Complex 10 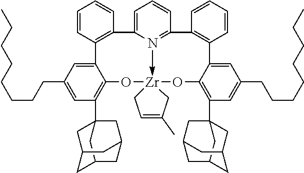
Complex 13 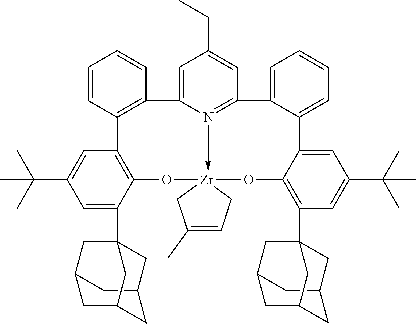
Complex 17 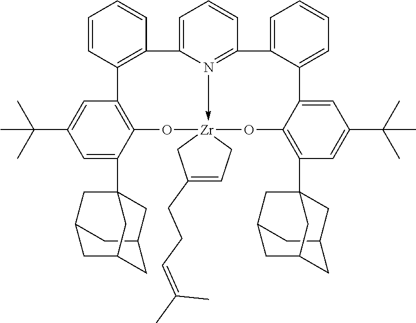
Complex 18 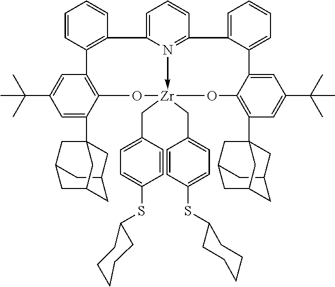
Complex 20

12. A catalyst system comprising an activator, preferably a non-aromatic hydrocarbon, and optionally a support material, and the catalyst compound of any preceding claim.

13. A homogeneous solution, comprising:
an aliphatic hydrocarbon solvent; and
at least one catalyst compound of any one of claims 1-11, with a concentration of the at least one catalyst compound being 0.20 wt % or greater (alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater).

14. The homogeneous solution of claim 13, wherein the aliphatic hydrocarbon solvent is isohexane, cyclohexane, methylcyclohexane, pentane, isopentane, heptane, an isoparaffin solvent, a non-aromatic cyclic solvent, or combinations thereof.

15. A process for the production of a propylene or ethylene based polymer or copolymer, comprising: polymerizing propylene and/or ethylene and an optional comonomer by contacting the propylene and/or ethylene and an optional comonomer with a catalyst system of claim 12, in one or more continuous stirred tank reactors or loop reactors, in series or in parallel, at a reactor pressure of from 0.05 MPa to 1,500 MPa and a reactor temperature of from 30° C. to 230° C. to form the propylene or ethylene based polymer or copolymer.

16. The process of claim 15, wherein the catalyst system and the activator are fed into the reactor(s) separately.

17. The process of claim 15, wherein the catalyst system and the activator are pre-mixed prior to being fed into the reactor(s).
